(19) United States
(12) Patent Application Publication
(10) Pub. No.: US 2026/0140618 A1
(43) Pub. Date: May 21, 2026

(54) ELECTRONIC DEVICE AND METHOD FOR STORING IMAGE CORRESPONDING TO SCREEN ON BASIS OF TOUCH INPUT

(71) Applicant: Samsung Electronics Co., Ltd., Suwon-si (KR)

(72) Inventors: Jongil JEONG, Suwon-si (KR); Hyunmuk KIM, Suwon-si (KR); Hyosang BANG, Suwon-si (KR); Jinwook CHOI, Suwon-si (KR)

(21) Appl. No.: 19/447,615

(22) Filed: Jan. 13, 2026

Related U.S. Application Data
(63) Continuation of application No. PCT/KR2024/012145, filed on Aug. 14, 2024.

(30) Foreign Application Priority Data
Oct. 6, 2023 (KR) 10-2023-0133812
Nov. 10, 2023 (KR) 10-2023-0155759

(51) Int. Cl. G06F 3/0488; G06F 1/16; G06F 3/01; G06F 3/0486; G06F 3/14

(52) U.S. Cl. CPC G06F 3/0488; G06F 1/1649; G06F 1/1652; G06F 3/017; G06F 3/0486; G06F 3/1423

(57) ABSTRACT

An electronic device is provided. The electronic device includes a first housing, a second housing rotatably coupled to the first housing, a third housing rotatably coupled to the second housing, a flexible display including a first displaying area positioned on the first housing, a second displaying area positioned on the second housing, and a third displaying area positioned on the third housing, a first sensor configured to detect an angle between the first housing and the second housing, a second sensor configured to detect an angle between the second housing and the third housing, memory, comprising one or more storage media, storing instructions, and one or more processors comprising processing circuitry communicatively coupled to the flexible display, the first sensor, the second sensor, and the memory, wherein the instructions, when executed by the one or more processors individually or collectively, cause the electronic device to, while displaying a screen on the flexible display, detect a touch input based on an external object contacted on a border area between two displaying areas among the first displaying area, the second displaying area, and the third displaying area, and in response to the touch input based on the external object being moved along a direction in which the border area extends, store, in the memory, an image corresponding to at least a portion of the screen.

### CROSS-REFERENCE TO RELATED APPLICATION(S)

This application is a continuation application, claiming priority under 35 U.S.C. § 365(c), of an International application No. PCT/KR 2024/012145, filed on Aug. 14, 2024, which is based on and claims the benefit of a Korean patent application number 10-2023-0133812, filed on Oct. 6, 2023, in the Ministry of Intellectual Property, and of a Korean patent application number 10-2023-0155759, filed on Nov. 10, 2023, in the Ministry of Intellectual Property, the disclosure of each of which is incorporated by reference herein in its entirety.

### BACKGROUND

### 1. Field

The disclosure relates to an electronic device for storing an image corresponding to a screen based on a touch input and a method thereof.

### 2. Description of Related Art

Shapes and/or sizes of an electronic device are diversifying. In order to enhance mobility, the electronic device with a reduced size and/or a reduced volume is being designed. The electronic device may include a display for visualizing information. As the number of functions supported by the electronic device increases, a size of the display may increase to visualize more information to the user and/or to support execution of the functions. For example, the size of the display may be designed to be maintained or increased while reducing the size and/or the volume of the electronic device.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device for storing an image corresponding to a screen based on a touch input and a method thereof.

Additional aspects will be set forth in part in the description which follows and, in part, will be apparent from the description, or may be learned by practice of the presented embodiments.

In accordance with an aspect of the disclosure, an electronic device is provided. The electronic device includes a first housing, a second housing rotatably coupled to the first housing, a third housing rotatably coupled to the second housing, a flexible display including a first displaying area positioned on the first housing, a second displaying area positioned on the second housing, and a third displaying area positioned on the third housing, a first sensor configured to detect an angle between the first housing and the second housing, a second sensor configured to detect an angle between the second housing and the third housing, memory, including one or more storage media, storing instructions, and one or more processors including processing circuitry communicatively coupled to the flexible display, the first sensor, the second sensor, and the memory, wherein the instructions, when executed by the one or more processors individually or collectively, cause the electronic device to, while displaying a screen on the flexible display, detect a touch input based on an external object contacted on a border area between two displaying areas among the first displaying area, the second displaying area, and the third displaying area, and in response to the touch input based on the external object being moved along a direction in which the border area extends, store, in the memory, an image corresponding to at least a portion of the screen.

In accordance with another aspect of the disclosure, a method performed by an electronic device including a first housing, a second housing rotatably coupled to the first housing, a third housing rotatably coupled to the second housing, and a flexible display including a first displaying area positioned on the first housing, a second displaying area positioned on the second housing, and a third displaying area positioned on the third housing is provided. The method includes, while displaying a screen on the flexible display, detecting, by the electronic device, a touch input based on an external object contacted on a border area between two displaying areas among the first displaying area, the second displaying area, and the third displaying area, and in response to the touch input based on the external object being moved along a direction in which the border area extends, storing, by the electronic device in memory of the electronic device, an image corresponding to at least a portion of the screen.

In accordance with another aspect of the disclosure, an electronic device is provided. The electronic device includes a first housing, a second housing rotatably coupled to the first housing, a third housing rotatably coupled to the second housing, a flexible display including a first displaying area positioned on the first housing, a second displaying area positioned on the second housing, and a third displaying area positioned on the third housing, a first sensor configured to detect an angle between the first housing and the second housing, a second sensor configured to detect an angle between the second housing and the third housing, memory, including one or more storage media, storing instructions, and one or more processors including processing circuitry communicatively coupled to the flexible display, the first sensor, the second sensor, and the memory, wherein the instructions, when executed by the one or more processors individually or collectively, cause the electronic device to, while displaying a screen on the flexible display, detect a touch input based on an external object contacted on the flexible display, and based on a path of the external object contacted according to a preset form that is moved on the flexible display, store, in the memory, an image corresponding to at least one displaying area, among the first displaying area, the second displaying area, and the third displaying area, including the path.

In accordance with another aspect of the disclosure, a method performed by an electronic device including a first housing, a second housing rotatably coupled to the first housing, a third housing rotatably coupled to the second housing, and a flexible display including a first displaying area positioned on the first housing, a second displaying area positioned on the second housing, and a third displaying area positioned on the third housing is provided. The method includes, in a state that an edge of the third housing is contacted on the first displaying area, displaying, by the electronic device, a first screen on a portion different from another portion occluded by the third housing, among portions of the first displaying area distinguished by the edge, and displaying, by the electronic device, a second screen on a cover display positioned on a second surface opposite to a first surface of the third housing where the third displaying area is positioned, detecting, by the electronic device, a touch input based on an external object contact on a portion of the first displaying area where the edge is contacted, and in response to the touch input based on the external object being moved along a direction of the edge, storing, by the electronic device, an image including at least one of the first screen or the second screen.

In accordance with another aspect of the disclosure, an electronic device is provided. The electronic device includes a first housing, a second housing rotatably coupled to the first housing, a third housing rotatably coupled to the second housing, a flexible display including a first displaying area positioned on the first housing, a second displaying area positioned on the second housing, and a third displaying area positioned on the third housing, a cover display positioned on a second surface opposite to a first surface of the third housing where the third displaying area is positioned, a first sensor configured to detect an angle between the first housing and the second housing, a second sensor configured to detect an angle between the second housing and the third housing, memory, including one or more storage media, storing instructions, and one or more processors including the processing circuitry communicatively coupled to the flexible display, the first sensor, the second sensor, and the memory, wherein the instructions, when executed by the one or more processors individually or collectively, cause the electronic device to, in a state that an edge of the third housing is contacted on the first displaying area, display a first screen on a portion different from another portion occluded by the third housing, among portions of the first displaying area distinguished by the edge, and display a second screen on the cover display, detect a touch input based on an external object contact on a portion of the first displaying area where the edge is contacted, and in response to the touch input based on the external object being moved along a direction of the edge, store an image including at least one of the first screen or the second screen.

In accordance with another aspect of the disclosure, a method performed by an electronic device including a first housing, a second housing rotatably coupled to the first housing, a third housing rotatably coupled to the second housing, and a flexible display including a first displaying area positioned on the first housing, a second displaying area positioned on the second housing, and a third displaying area positioned on the third housing is provided. The method includes, in a state that an edge of the third housing is contacted on the first displaying area, displaying, by the electronic device, a first screen on a portion different from another portion contacted by the third housing, among portions of the first displaying area distinguished by the edge, and displaying, by the electronic device, a second screen on a cover display positioned on a second surface opposite to a first surface of the third housing where the third displaying area is positioned, detecting, by the electronic device, a touch input based on an external object contact on a portion of the first displaying area where the edge is contacted, and in response to the touch input based on the external object being moved along a direction of the edge, storing, by the electronic device, an image including at least one of the first screen or the second screen.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include, while displaying a screen on a flexible display of the electronic device, detecting, by the electronic device, a touch input based on an external object contacted on a border area between two displaying areas among a first displaying area, a second displaying area, and a third displaying area, and in response to the touch input based on the external object being moved along a direction in which the border area extends, storing, by the electronic device in memory of the electronic device, an image corresponding to at least a portion of the screen.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1A and 1B illustrate an embodiment of a deformable electronic device according to various embodiments of the disclosure;

FIGS. 2A and 2B illustrate an example of a block diagram of an electronic device according to various embodiments of the disclosure;

FIG. 3 illustrates a flowchart of an electronic device according to an embodiment of the disclosure;

FIG. 4 illustrates an operation of an electronic device receiving a preset touch input for capturing a screen displayed on a display according to an embodiment of the disclosure;

FIG. 5 illustrates an example of an operation of an electronic device obtaining information related to an angle between housings according to an embodiment of the disclosure;

FIGS. 6A, 6B, and 6C illustrate an operation of an electronic device storing an image related to a screen displayed on one or more displays based on a preset touch input according to various embodiments of the disclosure;

FIG. 7 illustrates a flowchart of an electronic device according to an embodiment of the disclosure;

FIGS. 8A, 8B, 8C, 8D, 8E, 8F, and 8G illustrate states of an electronic device receiving a preset touch input according to various embodiments of the disclosure;

FIG. 9 illustrates a flowchart of an electronic device according to an embodiment of the disclosure;

FIG. 10 illustrates an operation of an electronic device based on a touch input on an area of a display formed on a folding axis according to an embodiment of the disclosure;

FIGS. 11A and 11B illustrate an operation of an electronic device based on a touch input on an area of a display formed on a folding axis according to various embodiments of the disclosure;

FIGS. 12A and 12B illustrate an operation of an electronic device storing an image corresponding to at least one of screens respectively displayed on a plurality of displays according to various embodiments of the disclosure;

FIG. 13 illustrates a flowchart of an electronic device according to an embodiment of the disclosure;

FIGS. 14A, 14B, 14C, and 14D illustrate states of an electronic device receiving a preset touch input for capturing a screen according to various embodiments of the disclosure;

FIG. 15 illustrates a flowchart of an electronic device according to an embodiment of the disclosure; and

FIG. 16 is a block diagram of an electronic device in a network environment according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi™) chip, a Bluetooth™ chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

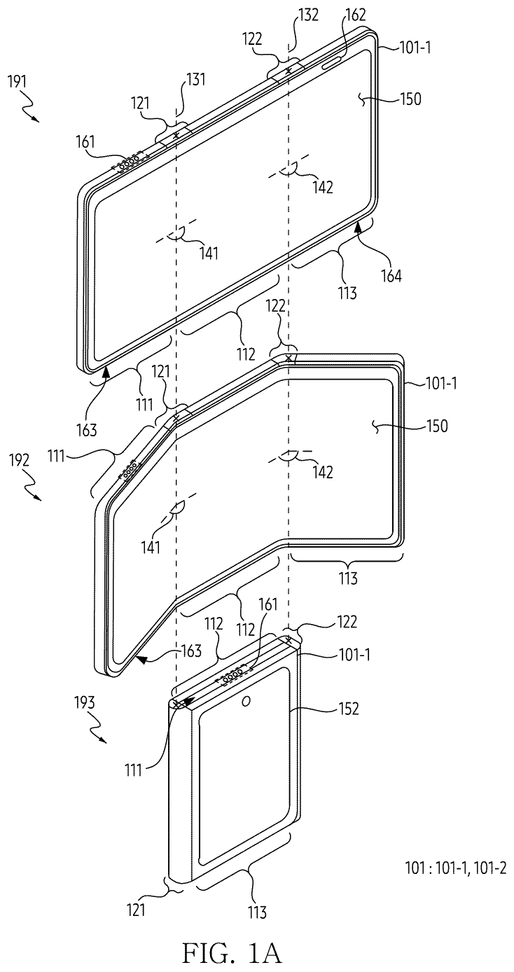

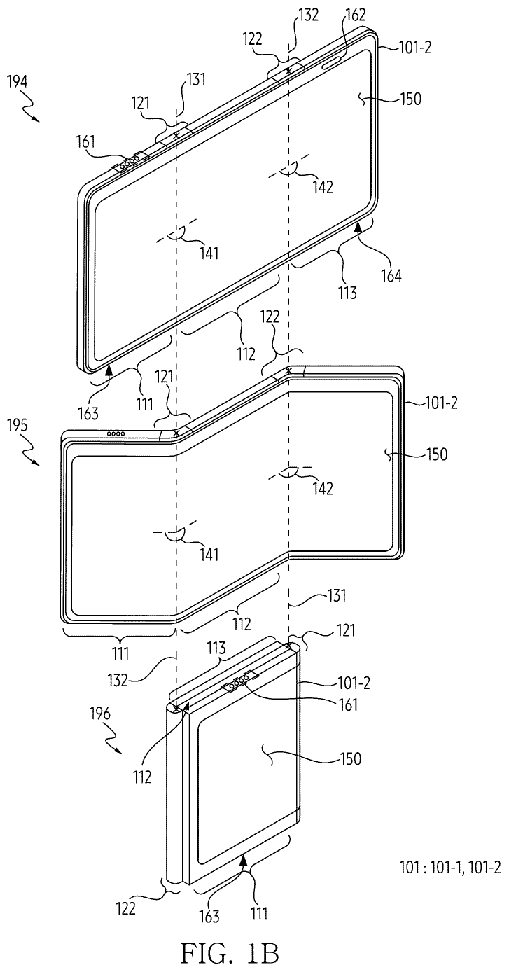

FIGS. 1A and 1B illustrate an embodiment of a deformable electronic device according to various embodiments of the disclosure.

In terms of being owned by a user, an electronic device 101 may be referred to as a terminal (or a user terminal). The terminal may include, for example, a personal computer (PC) such as a laptop or a desktop. The terminal may include, for example, a smartphone, a smartpad, and/or a tablet PC. The terminal may include a smart accessory such as a smartwatch and/or a head-mounted device (HMD).

Referring to FIGS. 1A and/or 1B, an electronic device 101 according to an embodiment may include a deformable multi-foldable housing. Based on deformability, the multi-foldable housing may be distinguished into a plurality of parts (or couplings and/or portions). For example, the multi-foldable housing of the electronic device 101 of FIG. 1A and/or FIG. 1B may include a first housing 111, a second housing 112, and a first hinge assembly 121 for rotatably coupling the first housing 111 and the second housing 112. By the first hinge assembly 121, a relative position, a posture (or a position), an angle, a shape, and/or a distance between the first housing 111 and the second housing 112, which are rigid bodies, may be changed by external force.

Referring to FIGS. 1A and/or 1B, the multi-foldable housing of the electronic device 101 may include the second housing 112, a third housing 113, and a second hinge assembly 122 for rotatably coupling the second housing 112 and the third housing 113. By the second hinge assembly 122, a relative position, a posture, an angle, a shape, and/or a distance between the second housing 112 and the third housing 113 may be changed by external force. Based on the first hinge assembly 121 and the second hinge assembly 122, the electronic device 101 may have a structure that may be folded more than once. In an embodiment, a housing such as the first housing 111, the second housing 112, and the third housing 113 may be referred to as a housing assembly (or a housing coupling, a housing part, and/or a housing module), a sub-housing, a flat housing, and/or a rigid housing. In an embodiment, a hinge assembly including the first hinge assembly 121 and the second hinge assembly 122 may be referred to as a hinge housing, a joint housing, and/or a flexible housing.

Referring to FIGS. 1A and/or 1B, a first folding axis 131 may be a rotation axis of the first housing 111 and the second housing 112 connected through the first hinge assembly 121, and may be formed in the first hinge assembly 121. As the first housing 111 and/or the second housing 112 is rotated with respect to the first folding axis 131, a first angle 141 between the first housing 111, the first hinge assembly 121, and the second housing 112 may be changed. A second folding axis 132 may be a rotation axis of the second housing 112 and the third housing 113 connected through the second hinge assembly 122, and may be formed in the second hinge assembly 122. As the second housing 112 and/or the third housing 113 is rotated with respect to the second folding axis 132, a second angle 142 between the second housing 112, the second hinge assembly 122, and the third housing 113 may change. In terms of including a plurality of deformable folding axes such as the first folding axis 131 and the second folding axis 132, the electronic device 101 may be referred to as a multi-foldable electronic device.

Referring to FIGS. 1A and/or 1B, according to an embodiment, the electronic device 101 may include a flexible display 150 positioned on a surface (e.g., a front surface of the electronic device 101) of the first housing 111, the second housing 112, and the third housing 113. For example, the flexible display 150 may be extended from the first housing 111, across the second housing 112, to the third housing 113. The flexible display 150 may form at least a portion of front surfaces of the first housing 111, the second housing 112, and the third housing 113. For example, the flexible display 150 may be positioned from the first housing 111, across the first hinge assembly 121, the second housing 112, and the second hinge assembly 122, to the third housing 113.

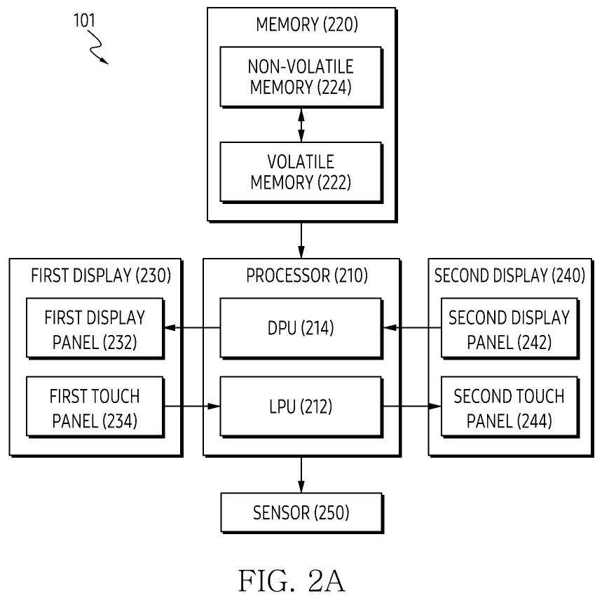

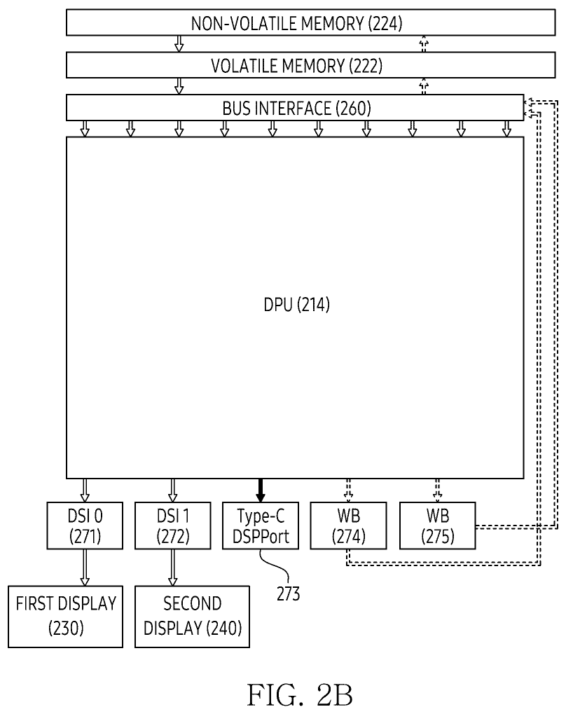

In an embodiment, the first angle 141 may correspond to an angle between a first surface of the first housing 111 and a second surface of the second housing 112 on which the flexible display 150, which may be folded by the first folding axis 131 of the first hinge assembly 121, is positioned. Hereinafter, the second angle 142 may correspond to an angle between the second surface of the second housing 112 and a third surface of the third housing 113, on which the flexible display 150, which may be folded by the second folding axis 132 of the second hinge assembly 122, is positioned. In an embodiment, the flexible display 150 may be referred to as a display, a deformable display, and/or a deformable panel. A hardware configuration of the electronic device 101 for controlling the flexible display 150 will be described with reference to FIGS. 2A and/or 2B.

Referring to FIGS. 1A and/or 1B, the electronic device 101 according to an embodiment may include a first speaker 161 and/or a third speaker 163 positioned in the first housing 111. The electronic device 101 may include a second speaker 162 and/or a fourth speaker 164 positioned in the third housing 113. The third speaker 163 may be positioned at a second edge of the first housing 111 opposite to a first edge of the first housing 111 where the first speaker 161 is positioned. The fourth speaker 164 may be positioned at a second edge of the third housing 113 opposite to a first edge of the third housing 113 where the second speaker 162 is positioned. Although the second speaker 162 positioned on a surface of the third housing 113 where the flexible display 150 is positioned, and the first speaker 161, the third speaker 163, and the fourth speaker 164 positioned on a side surface connected to the front surface of the electronic device 101 are exemplarily illustrated, positions of speakers (e.g., the first speaker 161 to the fourth speaker 164) included in the electronic device 101 are not limited to positions illustrated in FIGS. 1A and/or 1B.

In an embodiment, a posture and/or a shape of the electronic device 101 and/or the flexible display 150 may be distinguished by the first angle 141 and/or the second angle 142. Referring to FIG. 1A and/or FIG. 1B, different forms of the electronic device 101 supporting deformability based on a plurality of folding axes (e.g., the first folding axis 131 and/or the second folding axis 132) are illustrated.

Referring to FIG. 1A, a first electronic device 101-1 including the flexible display 150 that is visually fully occluded by the first housing 111 to the third housing 113 folded along the first folding axis 131 and the second folding axis 132 is illustrated. Referring to FIG. 1A, different states (e.g., a first state 191, a second state 192, and/or a third state 193) of the first electronic device 101-1 distinguished by the first angle 141 and the second angle 142 are illustrated. The first state 191 of the first electronic device 101-1 in which the first angle 141 and the second angle 142 are substantially a straight angle (e.g., approximately 180°) may be referred to as a fully unfolded state, an opened state, a fully-opened state, an unfold state, a flat state, an outspread state, and/or a planar state.

Referring to FIG. 1A, in the first state 191, the flexible display 150 positioned from the first housing 111, across the second housing 112, to the third housing 113 may have a substantially flat shape. In the first state 191, a single plane may be formed on the front surface of the electronic device 101 on which the flexible display 150 is positioned. In the first state 191, directions of the front surfaces of the first housing 111, the second housing 112, and the third housing 113 may be parallel to each other and/or coincident with each other.

Referring to FIG. 1A, the second state 192 of the first electronic device 101-1 in which at least one of the first angle 141 and/or the second angle 142 is an angle less than the straight angle is illustrated. Such as the second state 192, a state of the first electronic device 101-1 in which the first angle 141 and/or the second angle 142 is less than the straight angle may be referred to as an in-fold state, a sub-unfolded state (or a sub-fold state), an intermediate state, and/or a concave state. The sub-fold state may include a state in which both the first angle 141 and the second angle 142 are less than the straight angle and greater than 0°. In the sub-fold state, displaying areas of the flexible display 150 respectively positioned on the first housing 111 to the third housing 113 may face different directions. Referring to the second state 192, the flexible display 150 bent by the first hinge assembly 121 and the second hinge assembly 122 may include three flat portions distinguished by the first folding axis 131 and the second folding axis 132. For example, flat portions of the flexible display 150 distinguished by the second hinge assembly 122 may face different directions that are not parallel.

Referring to FIG. 1A, the third state 193 of the first electronic device 101-1 in which both the first angle 141 and the second angle 142 are substantially 0° may be referred to as a fully folded state, a fold state, a closed state, and/or a fully-closed state. In the third state 193, the flexible display 150 may be visually fully occluded by the first housing 111 to the third housing 113. For example, in the fold state, a size at which the flexible display 150 of the first electronic device 101-1 is exposed to the outside may be substantially zero. Referring to FIG. 1A, the third state 193 in which each of the front surface and a rear surface of the third housing 113 on which a portion of the flexible display 150 is positioned are occluded by the first housing 111 and the second housing 112 is illustrated, but an embodiment is not limited thereto.

The first electronic device 101-1 including the flexible display 150 that is visually fully occluded in the fold state may include a cover display 152 positioned on a rear surface opposite to the front surface on which the flexible display 150 is positioned. Referring to FIG. 1A, according to an embodiment, the first electronic device 101-1 may include the cover display 152 positioned on a second surface of the third housing 113 (e.g., the rear surface of the third housing 113) opposite to a first surface of the third housing 113 (e.g., the front surface of the third housing 113) on which the portion of the flexible display 150 is positioned. An embodiment is not limited thereto, and the cover display 152 may be positioned on a rear surface of the second housing 112 opposite to the front surface of the second housing 112 on which a portion of the flexible display 150 is positioned.

Referring to FIG. 1A, the first electronic device 101-1 including the flexible display 150 configured to be folded along the first folding axis 131 and the second folding axis 132 at an angle less than or equal to the straight angle may be referred to as a G-shaped foldable electronic device. Referring to FIG. 1B, different forms of a second electronic device 101-2 including the flexible display 150 configured to be folded along at least one of the first folding axis 131 or the second folding axis 132 at an angle greater than the straight angle are illustrated. The second electronic device 101-2 may be referred to as an S (or Z)-shaped foldable electronic device.

Referring to FIG. 1B, different states (e.g., a fourth state 194 to a sixth state 196) of a second electronic device 101-2 distinguished by the first angle 141 and the second angle 142 are illustrated. The fourth state 194 of the second electronic device 101-2 may correspond to the first state 191 of the first electronic device 101-1 of FIG. 1A. In the fourth state 194 corresponding to the unfold state, a flat plane may be formed by the flexible display 150.

Referring to FIG. 1B, a fifth state 195 of the second electronic device 101-2 in which the first angle 141 is greater than the straight angle and the second angle 142 is substantially the straight angle is illustrated. A state of the second electronic device 101-2 in which the first angle 141 and/or the second angle 142 is greater than the straight angle and is less than 360° may be referred to as an out-fold state, an intermediate state, a sub-fold state, and/or a convex state. Although only the first angle 141 among the first angle 141 and the second angle 142 is illustrated to be greater than the straight angle, an embodiment is not limited thereto. In a convex state including the fifth state 195, a plurality of planes formed by the flexible display 150 folded by the first hinge assembly 121 and/or the second hinge assembly 122 may face different directions.

Referring to FIG. 1B, the sixth state 196 of the second electronic device 101-2 in which the first angle 141 is substantially 360° and the second angle 142 is substantially 0° may be referred to as a fully folded state, a fold state, and/or a closed state. In the sixth state 196, among portions of the flexible display 150 positioned in each of the first housing 111 to the third housing 113, only a portion of the flexible display 150 positioned on the first housing 111 may be exposed to the outside.

According to an embodiment, the electronic device 101 may identify a state (e.g., one state among the unfold state, the fold state, the in-fold state, and/or the out-fold state) of the electronic device 101 indicated by the first angle 141 and the second angle 142, based on a sensor (e.g., a sensor 250 of FIG. 2A). The sensor may include at least one of a 6-degree-of-freedom (dof) sensor, an inertial measurement unit (IMU), and/or a Hall sensor for detecting the first angle 141 and/or the second angle 142. Based on switching between the states described with reference to FIGS. 1A and 1B, the electronic device 101 may display a screen on the flexible display 150 and/or the cover display 152.

According to an embodiment, the electronic device 101 may perform screen capture based on a posture (and/or a position) and/or a shape of the first housing 111, the second housing 112, and the third housing 113. Hereinafter, the screen capture may refer to an operation of storing an image corresponding to a screen displayed on the flexible display 150 and/or the cover display 152. The screen capture may be referred to as a screen dump and/or a screen cast. The image stored by the screen capture may be referred to as a screen shot. In an embodiment including one or more foldable folding axes (e.g., the first folding axis 131 and/or the second folding axis 132) such as FIGS. 1A and/or 1B, the electronic device 101 may display a screen on at least a portion of the flexible display 150 and/or the cover display 152 based on the one or more folding axes. A hardware configuration of the electronic device 101 for displaying the screen on at least a portion of the flexible display 150 and/or the cover display 152 will be described with reference to FIGS. 2A and/or 2B.

According to an embodiment, while displaying a screen on the flexible display 150 and/or the cover display 152, the electronic device 101 may store an image corresponding to the screen based on a touch input on the flexible display 150 and/or the cover display 152. Hereinafter, a preset touch input may refer to a touch input that triggers obtaining and/or storing of the image.

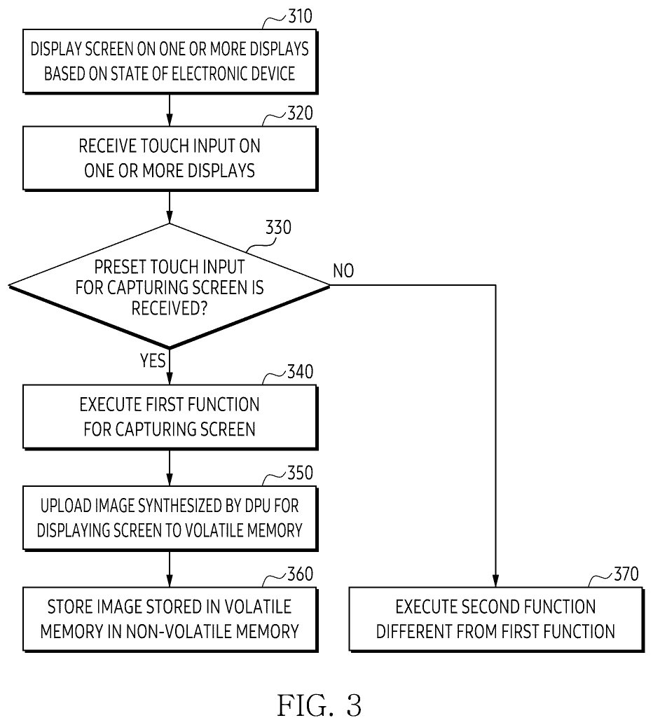

In an embodiment in which a button positioned on a portion of the first housing 111 to the third housing 113 (e.g., a side surface between the front surface and/or the rear surface of the multi-foldable housing in which the flexible display 150 and/or the cover display 152 is positioned) is mapped to a function for the screen capture, accessibility of the button may be dependent on the posture of the first housing 111 to the third housing 113. For example, the button may be occluded by the posture of the first housing 111 to the third housing 113. Alternatively, according to the posture of the first housing 111 to the third housing 113, a user who wants to press the button may repeatedly check a position of the button. According to an embodiment, the electronic device 101 may execute the function for the screen capture in response to the preset touch input performed on the flexible display 150 and/or the cover display 152, independently of the button. The electronic device 101 that reacts to the preset touch input may store the image corresponding to the screen displayed on the flexible display 150 and/or the cover display 152 without an additional action of the user for checking the position of the button. An operation of the electronic device 101 based on the preset touch input will be described with reference to FIG. 3.

According to an embodiment, the electronic device 101 may select or determine at least one display, among the flexible display 150 and/or the cover display 152, on which a screen is to be displayed based on the posture and/or the shape of the first housing 111 to the third housing 113. The electronic device 101 may display the screen on at least a portion of the determined at least one display based on the posture and/or the shape. While executing a plurality of software applications based on multitasking, the electronic device 101 may display screens (e.g., a window and/or an activity) provided from the plurality of software applications on each of different portions of the display (e.g., the flexible display 150 and/or the cover display 152). On the flexible display 150, the electronic device 101 may display the screens on each of the flat portions distinguished by the first folding axis 131 and/or the second folding axis 132.

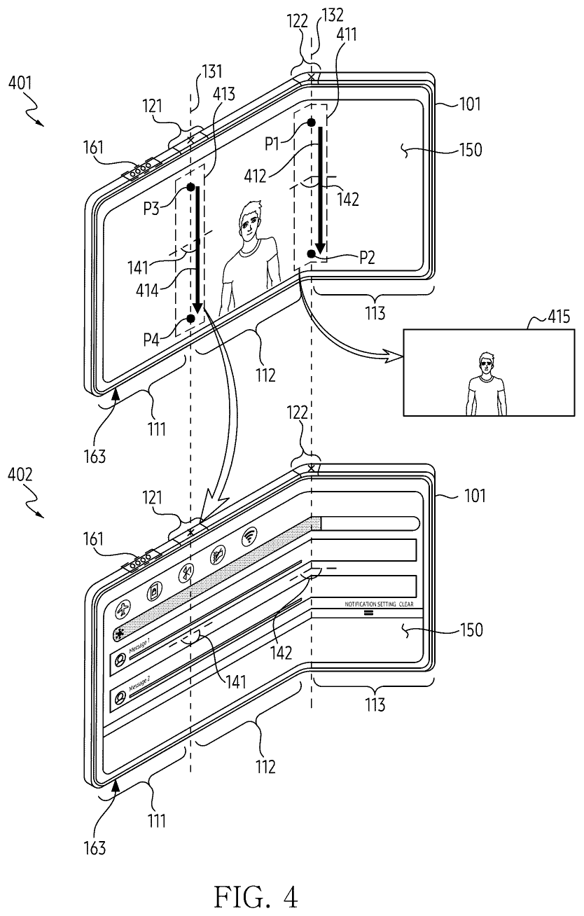

The electronic device 101 according to an embodiment may store an image corresponding to one portion among the flat portions of the flexible display 150 distinguished by the first folding axis 131 and/or the second folding axis 132 based on the preset touch input. According to an embodiment, while displaying screens on each of the flexible display 150 and the cover display 152, the electronic device 101 may obtain and/or store an image including all of the screens in response to the preset touch input. An operation of the electronic device 101 which determines at least a portion of a screen to be stored based on an image in response to the preset touch input while displaying the screen on at least a portion of the flexible display 150 and/or the cover display 152 selected based on the posture and/or the shape of the first housing 111 to the third housing 113 will be described with reference to FIGS. 4, 5, 6A to 6C, 7, 8A to 8G, 9, 10, 11A, 11B, 12A, 12B, 13, 14A to 14D, and 15.

As described above, the electronic device 101 may perform an operation related to the screen capture based on a physical characteristic of the electronic device 101 (e.g., the posture and/or the shape of the electronic device 101 distinguished by the first housing 111 to the third housing 113). The operation may be initiated based on a preset touch input based on a drag gesture. Based on at least one of the preset touch input, a posture of the flexible display 150 folded by the first folding axis 131 and/or the second folding axis 132, at least a portion of the flexible display 150 exposed to the outside based on the posture, and/or the cover display 152 activated based on the posture, the electronic device 101 may perform the screen capture on at least a portion of the screen displayed through the flexible display 150 and/or the cover display 152. The electronic device 101 supporting the screen capture based on the preset touch input may perform the screen capture more quickly in response to the preset touch input.

Hereinafter, a hardware configuration of the electronic device 101 for performing the screen capture described with reference to FIGS. 1A and/or 1B will be described with reference to FIGS. 2A and/or 2B.

FIGS. 2A and/or 2B illustrate an example of a block diagram of an electronic device according to various embodiments of the disclosure.

The electronic device 101 of FIGS. 1A and/or 1B may include hardware of the electronic device 101 described with reference to FIGS. 2A and/or 2B.

Referring to FIGS. 2A and/or 2B, according to an embodiment, an electronic device 101 may include at least one of a processor 210, memory 220, one or more displays (e.g., a first display 230, and/or a second display 240), or a sensor 250. The processor 210, the memory 220, the one or more displays, and the sensor 250 may be electronically and/or operably coupled with each other by an electronical component, such as a communication bus. An embodiment of the electronic device 101 including two displays, such as the first display 230 and the second display 240, is illustrated, but an embodiment is not limited thereto.

In an embodiment, hardware components of the electronic device 101 being operably coupled may mean that a direct connection or an indirect connection between the hardware components is established by wire or wirelessly so that a second hardware component is controlled by a first hardware component among the hardware components. Although illustrated based on different blocks, an embodiment is not limited thereto, and a portion (e.g., at least a portion of the processor 210 and the memory 220) of hardware of FIG. 2A may be included in a single integrated circuit such as a system on a chip (SoC). The hardware components of the electronic device 101 distinguished into the blocks may be located or included in at least one of the first housing 111, the second housing 112, or the third housing 113 described with reference to FIGS. 1A and/or 1B. A type and/or the number of hardware components included in the electronic device 101 is not limited to those illustrated in FIG. 2A. For example, the electronic device 101 may include only a portion of the hardware components illustrated based on the blocks of FIG. 2A.

According to an embodiment, the processor 210 of the electronic device 101 may include hardware and/or circuitry for processing data based on one or more instructions. The hardware and/or the circuitry for processing data may include, for example, an arithmetic and logic unit (ALU), a floating point unit (FPU), a field programmable gate array (FPGA), a central processing unit (CPU), and/or an application processor (AP). The number of processors 210 may be one or more. For example, the processor 210 may have a structure of a multi-core processor such as a dual core, a quad core, a hexa core, or an octa core.

Referring to FIG. 2A, as a non-limiting example, the processor 210 including a logical processor unit (LPU) 212 and/or a display processor unit (DPU) 214 is exemplarily illustrated. The LPU 212 may include circuitry (e.g., the ALU and/or the FPU) in the processor 210 for performing a computation (or an operation) instructed by instructions. A register and/or circuitry (e.g., level 1 (L1 ), level 2 (L2 ), and/or level 3 (L3) cache memory) for storing data inputted to or outputted from the LPU 212 may be included in the processor 210. The DPU 214 may include circuitry for performing a computation to generate a screen to be displayed on the one or more displays (e.g., the first display 230 and/or the second display 240) included in the electronic device 101. For example, the DPU 214 may generate the screen to be at least temporarily displayed on the one or more displays by synthesizing different image frames distinguished as layers. The layers may be provided from a software application executed by the LPU 212.

In an embodiment, the DPU 214 may be circuitry connected to a port and/or a node connected to a display in the processor 210. The DPU 214 may additionally perform color correction on the generated screen. In an embodiment, the electronic device 101 may further include circuitry designed to perform a calculation for three-dimensional rendering and/or light source processing, such as a graphics processing unit (GPU). In the embodiment, a layer and/or a graphical object generated by the GPU may be synthesized with another layer by the DPU 214. The DPU 214 may provide a combination of the layer generated by the GPU and the other layer to the display. The screen generated by the DPU 214 may be transmitted or provided without encoding to the one or more displays. Based on the DPU 214, rendering on a graphic object to be displayed on the one or more displays may be performed. Information on the screen, which may be generated by the DPU 214 and displayed by the one or more displays, may be stored in a buffer in the processor 210.

According to an embodiment, the memory 220 of the electronic device 101 may include a hardware component for storing data and/or an instruction inputted to and/or outputted from the processor 210. The memory 220 may include, for example, volatile memory 222, such as random-access memory (RAM), and/or non-volatile memory 224, such as read-only memory (ROM). The volatile memory 222 may include, for example, at least one of dynamic RAM (DRAM), static RAM (SRAM), Cache RAM, or pseudo SRAM (PSRAM). The non-volatile memory 224 may include, for example, at least one of programmable ROM (PROM), erasable PROM (EPROM), electrically erasable PROM (EEPROM), flash memory, a hard disk, a compact disc, a solid-state drive (SSD), or embedded multi-media card (eMMC).

Referring to FIG. 2A, a display including the first display 230 and/or the second display 240 may output visualized information (e.g., screens of FIGS. 4, 6A to 6C, 8A to 8G, 10, 11A, 11B, 12A, 12B, and/or 14A to 14D) to a user. The number of displays included in the electronic device 101 is not limited to an embodiment of FIG. 2A. The flexible display 150 of FIGS. 1A and/or 1B may correspond to the first display 230, and the cover display 152 of FIG. 1A may correspond to the second display 240. For example, the display may output visualized information to the user by being controlled by circuitry in the processor 210, such as the DPU 214, and/or circuitry (or a controller) such as the graphics processing unit (GPU).

In an embodiment, the display may include a liquid crystal display (LCD), a plasma display panel (PDP), and/or one or more light emitting diodes (LEDs). The LED may include an organic LED (OLED). The display may include electronic paper. The display may have an at least partially bent shape and/or a deformable shape, as described above with reference to FIGS. 1A and/or 1B. Hereinafter, an active area (or an active region) and/or a displaying area (or a displaying region) of the display may correspond to at least a portion of the display that includes one or more enabled (or activated) pixels. The display may include a display panel (e.g., a first display panel 232 in the first display 230 and/or a second display panel 242 in the second display 240) including one or more pixels. The screen generated by the DPU 214 may be displayed through the display panel.

In an embodiment, the display may include a sensor (e.g., a touch panel and/or a touch sensor panel (TSP)) for detecting an external object (e.g., a finger of the user or a pen) contacted on or floating on the display panel. Referring to FIG. 2A, the first display 230 may include a first touch panel 234 for detecting an external object on the first display panel 232. Similarly, the second display 240 may include a second touch panel 244 for detecting an external object contacted on or floating on the second display panel 242. Based on the first touch panel 234, the LPU 212 of the processor 210 may detect an external object contacted on the first display panel 232 or floating on the first display panel 232. In response to detecting the external object, the electronic device 101 may execute a function related to a specific visual object corresponding to a position of the external object on the first display panel 232 among visual objects being displayed on the first display panel 232. Similarly, the LPU 212 may identify or receive a touch input related to a visual object displayed on the second display panel 242, based on information (e.g., sensor data) of the second touch panel 244.

According to an embodiment, the sensor 250 of the electronic device 101 may generate electronic information that may be processed by the processor 210 (or the LPU 212) and/or stored in the memory 220 from non-electronic information related to the electronic device 101. For example, the sensor 250 may include a global positioning system (GPS) sensor for detecting a geographic location of the electronic device 101. In addition to the GPS method, the sensor 250 may generate information indicating the geographic location of the electronic device 101, for example, based on global navigation satellite system (GNSS) such as Galileo and Beidou (compass). The information may be stored in the memory 220, processed by the processor 210, and/or transmitted to another electronic device distinguished from the electronic device 101 through communication circuitry. The sensor 250 is not limited to the above description, and may include an image sensor, an illumination sensor, a proximity sensor, a grip sensor, a fingerprint sensor, and/or a time-of-flight (ToF) sensor for detecting electromagnetic waves including light.

In an embodiment, the processor 210 of the electronic device 101 may identify a posture, a shape, and/or a direction of the electronic device 101 by using the sensor 250. The processor 210 (e.g., the DPU 214) may selectively activate at least one of the first display 230 and/or the second display 240 based on the posture and/or the shape of the electronic device 101 identified using the sensor 250. An operation in which the processor 210 (e.g., the DPU 214) selectively activates at least one of the first display 230 and/or the second display 240 may include an operation of activating at least one of pixels of the display.

In an embodiment, the sensor 250 configured to identify the posture, the shape, and/or the direction of the electronic device 101 may include a Hall sensor, a 6-degree of freedom (6 DoF) sensor, and/or an inertial measurement unit (IMU). The Hall sensor may include a magnet and a magnetic field sensor that measures a change in a magnetic field formed by the magnet. The magnet and the magnetic field sensor may be positioned on different parts (or portions) of the housing of the electronic device 101. Based on the change in the magnetic field measured by the magnetic field sensor, the Hall sensor may output sensor data indicating a distance between the portions.

For example, in an embodiment in which the electronic device 101 includes a deformable housing, the processor 210 of the electronic device 101 may identify a shape of the housing or identify a parameter (e.g., the first angle 141 and/or the second angle 142 of FIG. 1) related to the shape, by using the Hall sensor including the magnet and the magnetic field sensor positioned in different parts of the housing (e.g., the first housing 111, the second housing 112, and/or the third housing 113 of FIGS. 1A and/or 1B). For example, the Hall sensor may output sensor data indicating the distance and/or the shape of the housing.

According to an embodiment, the IMU may include an accelerometer, a gyro sensor, a geomagnetic sensor, or any combination thereof. The accelerometer may output an electric signal indicating gravitational acceleration and/or acceleration of each of a plurality of axes (e.g., an x-axis, a y-axis, and a z-axis) perpendicular to each other. The gyro sensor may output an electric signal indicating an angular velocity (e.g., an angular velocity based on a roll, a pitch, and/or a yaw) of each of the plurality of axes. An IMU capable of measuring a motion in six directions (e.g., linear directions of the x-axis, the y-axis, and the z-axis, and/or rotational directions of the roll, the pitch, and the yaw) based on the accelerometer and/or the gyro sensor may be referred to as a 6-degree of freedom sensor. The geomagnetic sensor may output an electric signal indicating magnitude of a magnetic field formed in the electronic device 101 along each of the plurality of axes (e.g., the x-axis, the y-axis, and/or the z-axis). The processor 210 and/or the LPU 212 may repeatedly obtain data indicating the acceleration, the angular velocity, and/or the magnitude of the magnetic field from the IMU based on a preset cycle (e.g., 1 millisecond). By using the Hall sensor and/or the IMU, the processor 210 may identify parameters (e.g., the first angle 141 and/or the second angle 142 of FIGS. 1A and/or 1B) related to the shape of the electronic device 101. Based on the parameters, the processor 210 may identify a current shape of the electronic device 101 among preset shapes (e.g., an unfold state, a fold state, and/or a sub-fold state of FIGS. 1A and/or 1B) for distinguishing the shape of the electronic device 101. For example, the processor 210 of the electronic device 101 may identify the first angle 141 between the first housing 111 and the second housing 112 and/or the second angle 142 between the second housing 112 and the third housing 113 of FIGS. 1A and/or 1B by using the sensor 250.

Although not illustrated, according to an embodiment, the electronic device 101 may include an output means for outputting information in a form other than a visualized form. For example, the electronic device 101 may include a motor (or a haptic actuator) for providing haptic feedback based on vibration. For example, the electronic device 101 may include one or more speakers (e.g., the first speaker 161, the second speaker 162, the third speaker 163, and the fourth speaker 164 of FIGS. 1A and/or 1B) for outputting an audio signal.

According to an embodiment, one or more instructions (or commands) indicating a computation and/or an operation to be performed by the processor 210 (e.g., the LPU 212 and/or the DPU 214) on data may be stored in the memory 220 of the electronic device 101. A set of one or more instructions may be referred to as firmware, an operating system, a process, a routine, a subroutine, and/or a software application (hereinafter, an application). For example, when a set of a plurality of instructions distributed in a form of an operating system, firmware, a driver, and/or an application is executed, the electronic device 101, the processor 210, and/or the LPU 212 may perform at least one of operations of FIGS. 3, 7, 9, 13, and/or 15. Hereinafter, an application being installed in the electronic device 101 may mean that one or more instructions provided in a form of the application are stored in the memory 220 (e.g., the non-volatile memory 224) of the electronic device 101, and that the one or more applications are stored in a format (e.g., a file having an extension preset by an operating system of the electronic device 101) executable by the processor 210 of the electronic device 101.

In an embodiment, while displaying a screen on the first display 230 and/or the second display 240 using the DPU 214, the LPU 212 may identify a preset touch input using the first touch panel 234 and/or the second touch panel 244. In response to the preset touch input, information (e.g., information for displaying a screen) transmitted from the DPU 214 to one or more displays (e.g., the first display 230 and/or the second display 240) may be stored in the memory 220 (e.g., the volatile memory 222 and/or the non-volatile memory 224). The information stored in the memory 220 may be encoded based on a standard such as a joint photographic experts group (JPEG). The processor 210 may store the information in a form of a file in the non-volatile memory 224. By storing the information, the processor 210 may perform screen capture on a screen displayed on the first display 230 and/or the second display 240 activated based on the posture and/or the shape of the electronic device 101 detected by the sensor 250.

Referring to FIG. 2B, a connection relationship between the DPU 214 of the processor 210 and other circuitry (e.g., the non-volatile memory 224, the volatile memory 222, the first display 230, and/or the second display 240) is illustrated. The DPU 214 may be electrically connected to the volatile memory 222 through a bus interface 260. From the volatile memory 222, the DPU 214 may receive one or more graphical information to be included in a screen to be displayed on a display, such as layers. The graphical information may include an image file (e.g., a file having a file extension of jpg and/or jpeg) and/or a video file (e.g., a file having a file extension of mpg) stored in the non-volatile memory 224, and the DPU 214 may generate a screen to be displayed on the display by synthesizing a plurality of layers received from the volatile memory 222.

In an embodiment, while synthesizing the layers, the DPU 214 may perform white balance correction, compression of a screen such as video electronics standards association (VESA) display compression (VDC), and/or sharpening. A screen including the layers synthesized by the DPU 214 may be generated. The DPU 214 may output the generated screen through a display stream interface (DSI) 0 271 and/or a DSI 1 272. The DSI 0 271 and/or the DSI 1 272 may include one or more pins of the processor 210 of FIG. 2A. In an embodiment in which the first display 230 is connected to the processor and/or the DPU 214 through the DSI 0 271, and the second display 240 is connected to the processor and/or the DPU 214 through the DSI 1 272, the screen may be outputted through at least one DSI, among the DSI 0 271 and the DSI 1 272, determined (or selected) by the DPU 214 and/or the processor.

In an embodiment, in order to support an extension of a display based on a wired communication protocol of a universal serial bus (USB)-C, the DPU 214 may be electrically connected to a USB-C display port 273. The USB-C display port 273 may be extended to a port (e.g., a USB-C port) formed on a portion of the housing of the electronic device, or may be electrically connected to the port. In an embodiment in which a third display connected through the USB-C display port 273 is detected, the DPU 214 may transmit information for displaying a screen corresponding to the third display to the third display through the USB-C display port 273.

In an embodiment, the DPU 214 may include not only an interface (e.g., the DSI 0 271, the DSI 1 272, and/or the USB-C display port 273) for providing a screen to a display connected to the DPU 214, but also an interface (e.g., write back (WB) ports 274 and 275) for storing the screen in the memory of the electronic device, such as the volatile memory 222. In an embodiment in which two displays (e.g., the first display 230 and the second display 240) are connected through the DSI 0 271 and the DSI 1 272, the DPU 214 may be connected to the WB ports 274 and 275 for outputting screens provided to each of the displays.

In an embodiment, the WB port 274 may be formed for storing a screen provided from the DPU 214, through the DSI 0 271, to the first display 230. The WB port 275 may be formed for storing a screen provided from the DPU 214, through the DSI 1 272, to the second display 240. For example, the processor that receives the preset touch input for capturing a screen may obtain information corresponding to a screen provided to at least one display by using at least one of the WB ports 274 and 275. The obtained information may be transmitted to the memory (e.g., the volatile memory 222) of the electronic device through an electrical connection between the WB ports 274 and 275 and the bus interface 260.

An operation for capturing a screen described with reference to FIGS. 3, 4, 5, 6A to 6C, 7, 8A to 8G, 9, 10, 11A, 11B, 12A, 12B, 13, 14A to 14D, and 15 may be performed based on information transmitted through an interface (e.g., the WB ports 274 and 275) connecting the DPU 214 and the memory. The processor may generate an image file and/or a video file to be stored in the non-volatile memory 224 by editing the information stored in the volatile memory 222 through the interface. The image file and/or the video file may include the edited information.

Hereinafter, an operation of the processor 210 (e.g., the LPU 212 and/or the DPU 214) of the electronic device 101 for performing screen capture will be described with reference to FIG. 3.

FIG. 3 illustrates a flowchart of an electronic device according to an embodiment of the disclosure.

The electronic device 101 of FIGS. 1A, 1B, and/or 2A and/or 2B, and the processor 210 (e.g., the LPU 212 and/or the DPU 214) of FIG. 2A may perform at least one of operations described with reference to FIG. 3.

Referring to FIG. 3, in operation 310, a processor of the electronic device according to an embodiment may display a screen on one or more displays based on a state of the electronic device. A state of the operation 310 may be distinguished by a posture and/or a shape of the electronic device and/or a display (e.g., the flexible display 150 and/or the cover display 152 of FIGS. 1A and/or 1B) of the electronic device described with reference to FIGS. 1A and/or 1B. The state of the operation 310 may include, for example, an unfold state, a sub-fold state (or an intermediate state), and/or a fold state. The state of the operation 310 may be identified based on data of a sensor (e.g., the sensor 250 of FIG. 2A) of the electronic device. The one or more displays of the operation 310 may include the first display 230 and the second display 240 of FIGS. 2A and/or 2B, the flexible display 150 of FIGS. 1A and 1B, and/or the cover display 152 of FIG. 1A.

Referring to FIG. 3, the processor may determine one or more displays and/or at least a portion of the display on which a screen is to be displayed based on the state of the operation 310. For example, the processor of the electronic device including the flexible display 150 and the cover display 152 of FIG. 1A may activate at least one of the flexible display 150 or the cover display 152 and deactivate another one based on the state of operation 310. The processor may at least partially activate the activated display among the flexible display 150 or the cover display 152 based on the state of the operation 310. An embodiment is not limited thereto, and the processor may activate both the flexible display 150 and the cover display 152 based on the state of the operation 310. While both the flexible display 150 and the cover display 152 are simultaneously activated, the processor may deactivate at least a portion of the flexible display 150 based on the state of the operation 310.

In an embodiment, activating the display by the processor may include a state in which a power signal greater than a preset voltage is transmitted to at least one of circuitry (e.g., a display panel and/or a touch panel) of the display and/or pixels included in the display. Deactivating the display by the processor may include a state in which a power signal less than the preset voltage is transmitted to at least one of the circuitry and/or the pixels, or the transmission of the power signal is ceased.

Referring to FIG. 3, in operation 320, the processor of the electronic device according to an embodiment may receive a touch input on one or more displays. The processor may receive the touch input of the operation 320 on one or more displays on which the screen based on the operation 310 is displayed. For example, the processor of the electronic device including the flexible display 150 and the cover display 152 of FIG. 1A may receive the touch input of the operation 320 based on a touch panel of the activated display among the flexible display 150 and the cover display 152. In response to the touch input of the operation 320, the processor may perform operation 330.

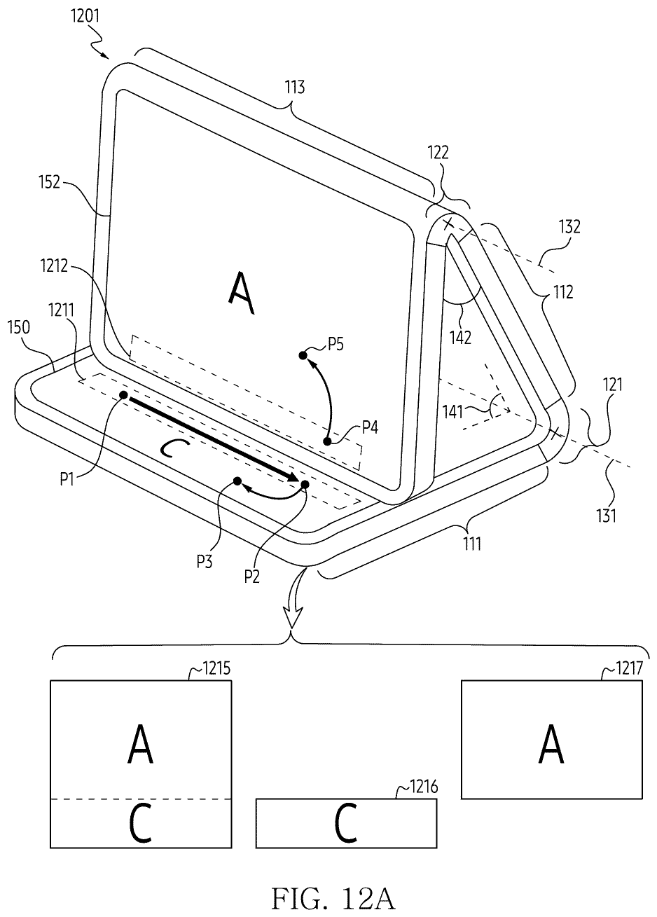

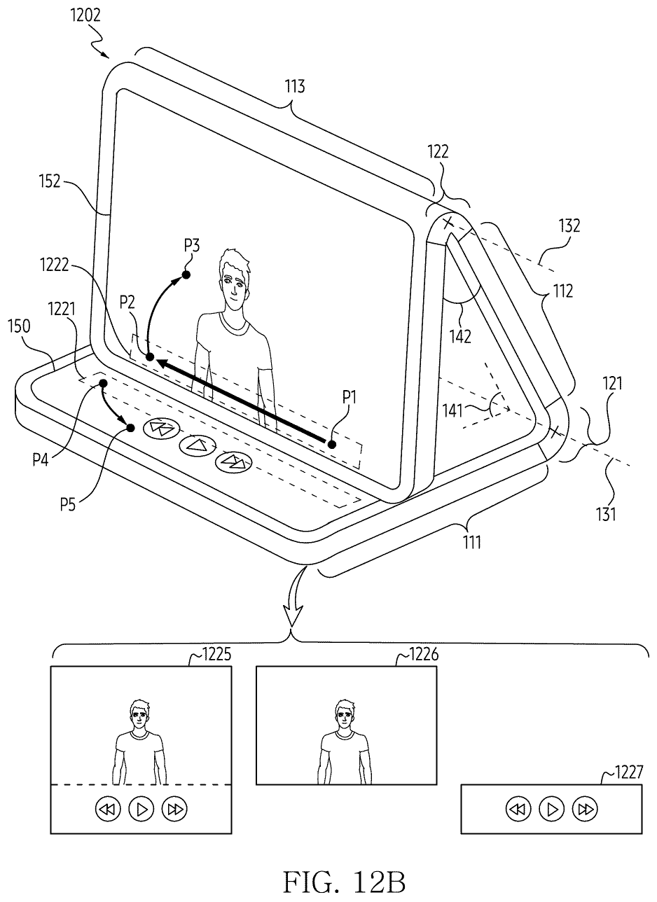

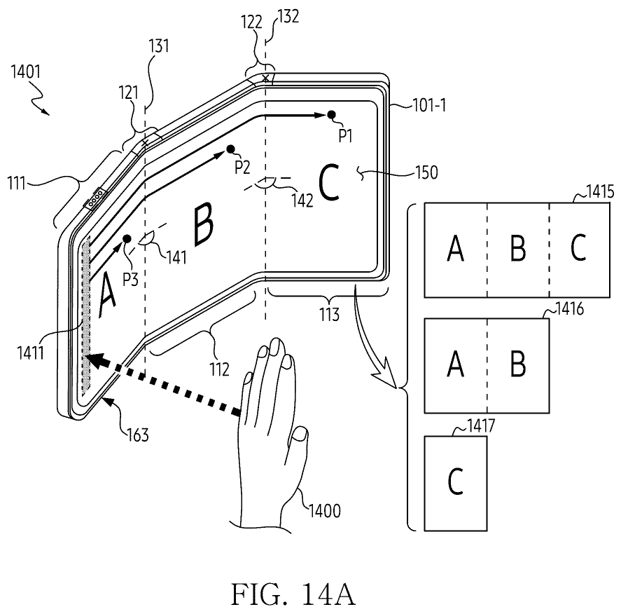

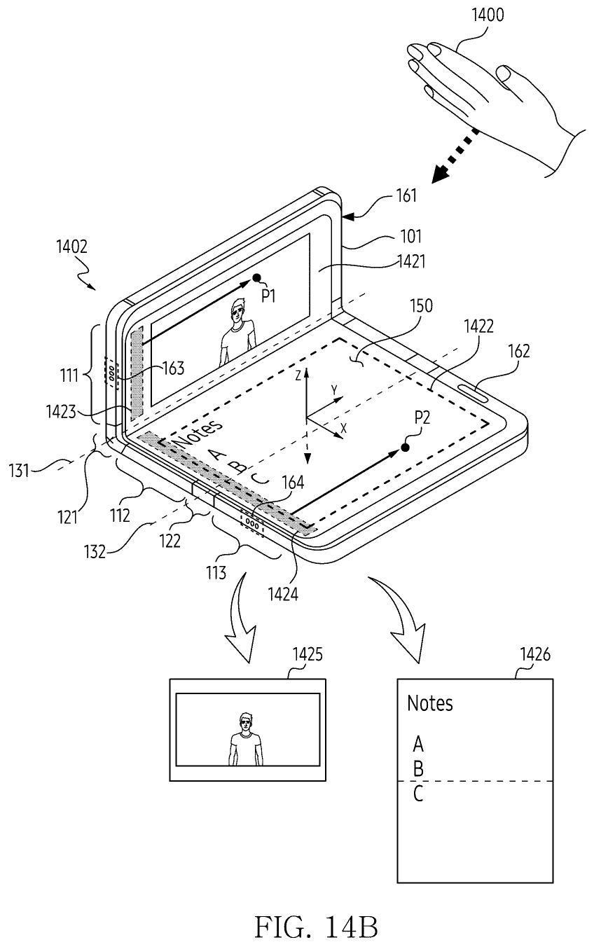

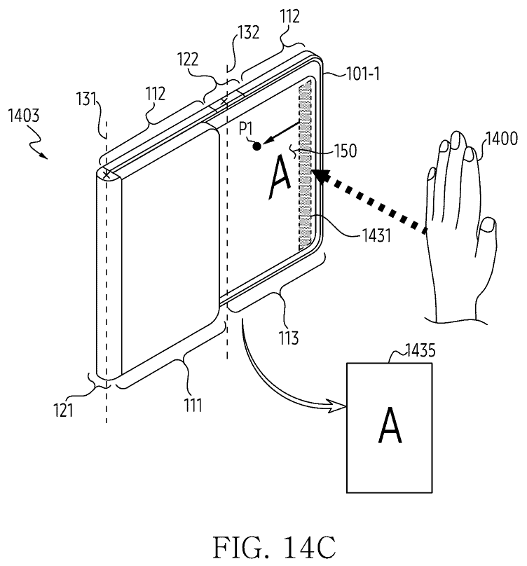

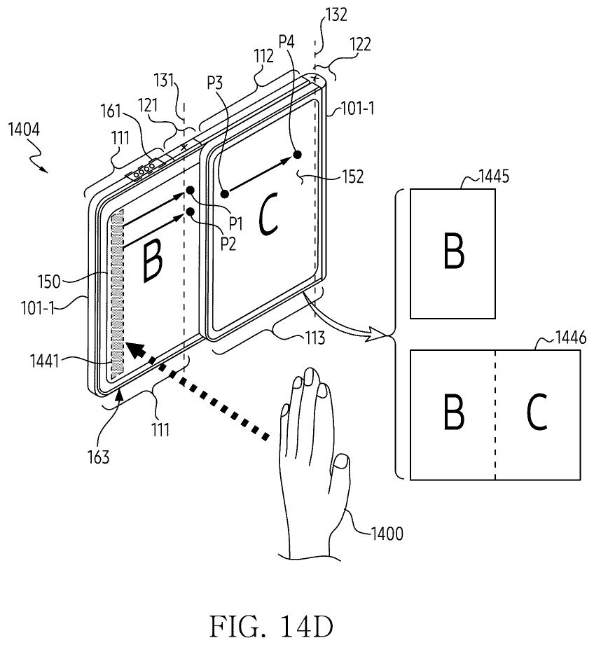

Referring to FIG. 3, in operation 330, the processor of the electronic device according to an embodiment may determine whether a preset touch input for capturing a screen has been received. The preset touch input of the operation 330 may include a gesture based on a structure of a multi-foldable electronic device. The preset touch input of the operation 330 may be detected based on a gesture different from a gesture mapped to a function (e.g., a function supported by a software application for displaying the screen of the operation 310) of the electronic device. In an embodiment, the preset touch input of the operation 330 may include a drag gesture performed on a foldable area of a display (e.g., the flexible display 150 of FIGS. 1A and/or 1B) as described with reference to FIGS. 4, 5, 6A to 6C, 7, 8A to 8G, 9, 10, and/or 11A and 11B. In an embodiment, while displaying a screen using all of a first display and a second display spaced less than a preset distance from an edge of the first display, as described with reference to FIGS. 12A, 12B, and/or 13, the preset touch input of the operation 330 may include a drag gesture performed on the first display and/or the second display. In an embodiment, the preset touch input of the operation 330 may include a drag gesture performed, on a display, based on an external object in a preset shape and/or an extent range, such as a hand blade, as described with reference to FIGS. 14A to 14D and/or 15.

Referring to FIG. 3, in a case that the touch input of the operation 320 does not correspond to the preset touch input (330-NO), the processor may perform operation 370. For example, in a case that a touch input different from the preset touch input is received, the processor may perform operation 370. In a case that the touch input of the operation 320 corresponds to the preset touch input (330-YES), the processor may perform operation 340.

Referring to FIG. 3, in operation 340, the processor of the electronic device according to an embodiment may execute a first function for capturing a screen. The first function may include an operation of storing information related to the screen to be displayed on the one or more displays of the operation 310 in memory (e.g., the memory 220 of FIG. 2A) of the electronic device based on the DPU 214 of FIGS. 2A and/or 2B. Based on the execution of the first function, the processor may perform at least one of operations 350 and 360 of FIG. 3.

Referring to FIG. 3, in operation 350, the processor of the electronic device according to an embodiment may upload an image synthesized by the DPU to volatile memory (e.g., the volatile memory 222 of FIG. 2A) for displaying a screen. The operation 350 may be referred to as write back. The image uploaded to the volatile memory based on the operation 350 may have a size of a displaying area (or active area) of the one or more displays activated based on the operation 310. For example, in a case that a plurality of displays (e.g., the flexible display 150 and/or the cover display 152 of FIGS. 1A and/or 1B, the first display 230 and/or the second display 240 of FIGS. 2A and/or 2B) are all activated, images corresponding to each of the plurality of displays may be uploaded from the DPU to the volatile memory based on the operation 350.

The image uploaded based on the operation 340 may be changed based on the preset touch input received based on the operation 320. For example, based on a path (or a trajectory) of the drag gesture performed for the preset touch input, a user may preset or select at least a portion to be stored in the memory in the screen displayed according to the operation 310. Based on the path, the processor may edit the image uploaded to the volatile memory. Based on editing the image stored in the volatile memory, the processor may include an operation of obtaining or generating an image to be stored in non-volatile memory (e.g., the non-volatile memory 224 of FIG. 2A). For example, based on the preset touch input, the processor may crop the image and/or merge images uploaded from the plurality of displays to the volatile memory.

Referring to FIG. 3, in operation 360, the processor of the electronic device according to an embodiment may store the image uploaded to the volatile memory based on the operation 350 in the non-volatile memory (e.g., the non-volatile memory 224 of FIG. 2A). In a case that the processor changes one or more images uploaded to the volatile memory based on the preset touch input, the processor may store the changed one or more images in the non-volatile memory. The processor may store the image in the non-volatile memory based on a format such as a jpeg, a tagged image file format (tiff), portable network graphics (png), a bitmap (bmp), and/or a graphics interchange format (gif).

Referring to FIG. 3, in operation 370, the processor of the electronic device according to an embodiment may execute a second function different from the first function. The processor receiving a touch input different from the preset touch input for capturing a screen may execute the second function mapped to the touch input. The second function may be set by the software application displaying the screen of the operation 310. The second function may be set by a system process and/or an operating system installed in the electronic device. An embodiment is not limited thereto, and in a case that the touch input of the operation 320 is not mapped to any function, the processor may not execute any function.

As described above, the processor of the electronic device according to an embodiment may execute the first function of the operation 340 based on the touch input performed on the one or more displays on which the screen of the operation 310 is displayed. The preset touch input for capturing a screen may be related to a structure of a multi-foldable housing of the electronic device. Hereinafter, an operation of an electronic device related to the preset touch input set based on the structure of the multi-foldable housing will be described with reference to FIGS. 4, 5, 6A to 6C, 7, 8A to 8G, 9, 10, 11A, 11B, 12A, 12B, 13, 14A to 14D, and 15.

FIG. 4 illustrates an operation of an electronic device receiving a preset touch input for capturing a screen displayed on a display (e.g., a flexible display 150) according to an embodiment of the disclosure.

The electronic device 101 of FIGS. 1A, 1B, and/or 2A and/or 2B may include the electronic device 101 of FIG. 4. The electronic device 101 and/or the processor 210 of FIGS. 2A and/or 2B may perform an operation of the electronic device 101 of FIG. 4. The operation of the electronic device 101 described with reference to FIG. 4 may be related to at least one of the operations of FIG. 3.

Referring to FIG. 4, states 401 and 402 of an electronic device 101 included in a sub-fold state (e.g., the second state 192 of FIG. 1A and/or the fifth state 195 of FIG. 1B) between an unfold state (e.g., the first state 191 of FIG. 1A and/or the fourth state 194 of FIG. 1B) and a fold state (e.g., the third state 193 of FIG. 1A and/or the sixth state 196 of FIG. 1B) are illustrated. The electronic device 101 may detect a posture and/or a shape of a first housing 111, a second housing 112, and a third housing 113 by using a sensor (e.g., the sensor 250 of FIG. 2A). The electronic device 101 may detect or calculate a first angle 141 and/or a second angle 142 based on data of the sensor. Referring to FIG. 4, in each of the states 401 and 402 in which the third housing 113 is rotated with respect to the second housing 112, the electronic device 101 may detect, based on one or more sensors, a first hinge assembly 121 and/or the first angle 141 being substantially unfolded at 180°, and may identify a second hinge assembly 122 and/or the second angle 142 being bent less than 180°.

In an embodiment, the preset touch input for capturing a screen displayed on the display may be identified based on a drag gesture performed on a portion of the display bendable by a multi-foldable housing. Referring to FIG. 4, the flexible display 150 bendable by the first hinge assembly 121 and/or the second hinge assembly 122 may include a first displaying area positioned on the first housing 111, a second displaying area positioned on the second housing 112, and a third displaying area positioned on the third housing 113. The flexible display 150 may include a first border area (or border region) 413 positioned on the first hinge assembly 121 and located between the first displaying area and the second displaying area. The flexible display 150 may include a second border area 411 positioned on the second hinge assembly 122 and located between the second displaying area and the third displaying area.

In an embodiment, the preset touch input for capturing a screen displayed on the display may be detected based on a drag gesture performed on a portion of the substantially bent display. In the state 401 of FIG. 4, the electronic device 101 may identify the preset touch input through the second border area 411 bent based on the rotation of the third housing 113 with respect to the second housing 112, among the first border area 413 and the second border area 411. The preset touch input received through the second border area 411 may include a drag gesture based on an external object contacted on a location p1 within the second border area 411 and moved to a location p2 on the second border area 411 along a path 412. The path 412 of the drag gesture performed within the second border area 411 may be substantially the same as or parallel to a direction of a second folding axis 132.

In an embodiment, the electronic device 101 may identify the preset touch input in response to detecting the drag gesture based on the path 412 longer than a preset distance within the second border area 411. For example, within the second border area 411, the electronic device 101 may identify the preset touch input based on an external object moved farther than the preset distance along the direction of the second folding axis 132. The preset distance may be equal to or less than a width and/or a height of the second border area 411. For example, the preset distance may be a value to which a preset ratio is applied to the height of the second border area 411. The preset ratio may be set heuristically or set adaptively based on a model, such as an artificial neural network. The electronic device 101 detecting the external object released on the location p2 within the second border area 411 or spaced apart from the flexible display 150 may initiate capturing a screen displayed on the flexible display 150.

In an embodiment, in response to the preset touch input received through the second border area 411, the electronic device 101 may execute a first function for storing an image 415 corresponding to at least a portion of the screen displayed on the flexible display 150. Referring to FIG. 4, the image 415 stored by the electronic device 101 may correspond to an entire screen displayed through an entire displaying area of the flexible display 150. For example, a width, a height, a size, an aspect ratio, and/or extent of the image 415 may correspond to a width, a height, a size, an aspect ratio, and/or extent of the entire displaying area of the flexible display 150.

Referring to FIG. 4, in the state 401 in which the first housing 111 is unfolded with respect to the second housing 112 and the third housing 113 is rotated with respect to the second housing 112, the first border area 413 between the first displaying area corresponding to the first housing 111 and the second displaying area corresponding to the second housing 112 may not be mapped to or may be disassociated (or unlinked) with the preset touch input. For example, the electronic device 101 detecting a drag gesture based on an external object contacted on a location p3 within the first border area 413 and moved to a location p4 within the first border area 413 along a path 414 may determine that a touch input different from the preset touch input is detected. In response to the touch input, the electronic device 101 may execute a second function different from the first function for capturing a screen. In response to the touch input received through the substantially flat first border area 413, the electronic device 101 may execute a function different from screen capture. For example, the electronic device 101 detecting a drag gesture performed within the first border area 413 along the path 414 may switch from the state 401 to the state 402. In the state 402, the electronic device 101 may display a user interface (UI) provided by a system process and/or an operating system, such as a notification panel.

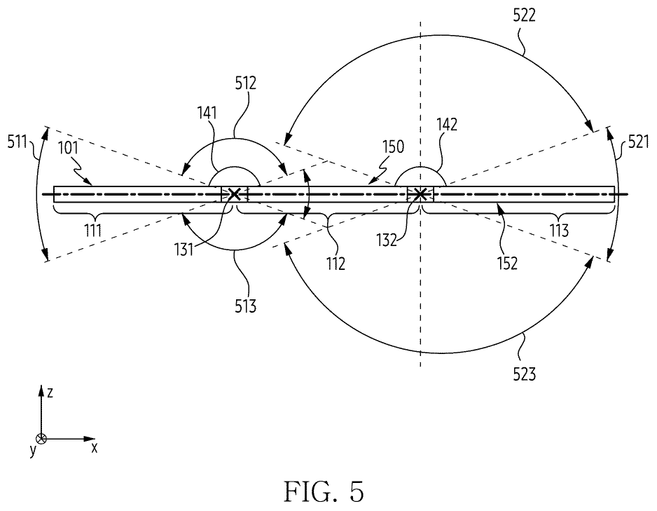

As described above, according to an embodiment, the electronic device 101 may receive the preset touch input for capturing a screen through a portion (in the state 401 of FIG. 4, the second border area 411) of the flexible display 150 bent by a folding axis. In an embodiment, the electronic device 101 may receive the preset touch input through the portion of the flexible display 150 bent based on a preset angle range. Hereinafter, an example of the preset angle range will be described with reference to FIG. 5.

FIG. 5 illustrates an example of an operation of an electronic device obtaining information related to an angle (e.g., a first angle 141 and/or a second angle 142) between housings (e.g., a first housing 111 to a third housing 113) according to an embodiment of the disclosure.

The electronic device 101 of FIGS. 1A, 1B, and/or 2A and/or 2B may include the electronic device 101 of FIG. 5. The electronic device 101 and/or the processor 210 of FIGS. 2A and/or 2B may perform an operation of the electronic device 101 described with reference to FIG. 5. The operation of the electronic device 101 described with reference to FIG. 5 may be related to at least one of the operations of FIG. 3.

Referring to FIG. 5, an exterior of an electronic device 101 in an unfold state viewed from a y-axis (or viewed from a-y-axis) is illustrated. The electronic device 101 may identify the first angle 141 between the first housing 111 and the second housing 112 by using one or more sensors (e.g., the sensor 250 of FIG. 2A). The electronic device 101 may identify the second angle 142 between the second housing 112 and the third housing 113 by using one or more sensors. While both the first angle 141 and the second angle 142 maintain a preset angle (approximately 180°) corresponding to the unfold state, a state of the electronic device 101 may maintain the unfold state.

In an embodiment, the electronic device 101 may monitor changes in a state and/or a shape of the electronic device 101 based on the first angle 141 and/or the second angle 142. For example, a user of the electronic device 101 may rotate the first housing 111 with respect to the second housing 112 and/or rotate the third housing 113 with respect to the second housing 112. In a case that the user rotates the first housing 111 with respect to the second housing 112, the electronic device 101 may identify a change in the first angle 141 using a sensor. Referring to FIG. 5, an angle range 511 may be formed based on a preset angle corresponding to the unfold state. For example, the angle range 511 may be formed within a range of ±30∪ (e.g., 150° to 210°) based on 180°.

Using a sensor for identifying the rotation of the first housing 111 with respect to the second housing 112, the electronic device 101 may detect or determine whether the first angle 141 is changed greater than the angle range 511. The electronic device 101 identifying the first angle 141 changed greater than the angle range 511 may switch from the unfold state to another state.

In the unfold state, as the first housing 111 is rotated with respect to the second housing 112, the first angle 141 may be included within one of angle ranges 512 and 513 different from the angle range 511. The angle range 512 may be formed between 30° and 150°. The angle range 513 may be formed between 210° and 330°. While the first angle 141 is included within one of the angle ranges 512 and 513, the processor may receive or identify a preset touch input through a first border area (e.g., the first border area 413 of FIG. 4) of a flexible display 150 positioned on a first folding axis 131. In response to the preset touch input received through the first border area, the electronic device 101 may perform screen capture. For example, while the first angle 141 is included within one of the angle ranges 512 and 513, the processor of the electronic device 101 may link (associate and/or connect) or map the first border area corresponding to the first angle 141 and the preset touch input.

In an embodiment, similar to the operation described based on the first angle 141, the electronic device 101 may identify a change in the second angle 142. For example, in a case that the user rotates the third housing 113 with respect to the second housing 112, the electronic device 101 may identify the change in the second angle 142 using a sensor. Referring to FIG. 5, an angle range compared to the second angle 142 may include at least one of an angle range 521 formed based on the preset angle corresponding to the unfold state and angle ranges 522 and 523 different from the angle range 521. The angle range 521 may be formed in a range between 150° and 210°. The angle range 522 may be formed in a range between 30° and 150°. The angle range 523 may be formed in a range between 210° and 330°. While the second angle 142 substantially corresponding to 180° based on the unfold state changes exceeding a preset period into one of the angle ranges 522 and 523 from the 180°, the electronic device 101 may identify or receive the preset touch input through a border area (e.g., the second border area 411 of FIG. 4) on a second folding axis 132.

In response to the preset touch input received through the flexible display 150 bent in at least one of the first hinge assembly 121 and/or the second hinge assembly 122, the electronic device 101 may store an image corresponding to a screen displayed on the flexible display 150. In an embodiment in which a screen is displayed on the cover display 152, the electronic device 101 may store an image corresponding to the screen displayed on the cover display 152 in response to receiving the preset touch input through the flexible display 150 and/or receiving the preset touch input through the cover display 152. In an embodiment, the electronic device 101 may perform screen capture on at least a portion of the flexible display 150 and/or the cover display 152 specified by the preset touch input.

The angle ranges 512, 513, 522, and 523 compared to the first angle 141 and/or the second angle 142 to receive the preset touch input are not limited to an embodiment of FIG. 5. For example, the angle ranges 512 and 522 compared to the first angle 141 and/or the second angle 142 of the flexible display 150 bent less than 180°, and the angle ranges 513 and 523 compared to the second angle 142 and/or the second angle 142 of the flexible display 150 bent more than 180° may have different sizes.

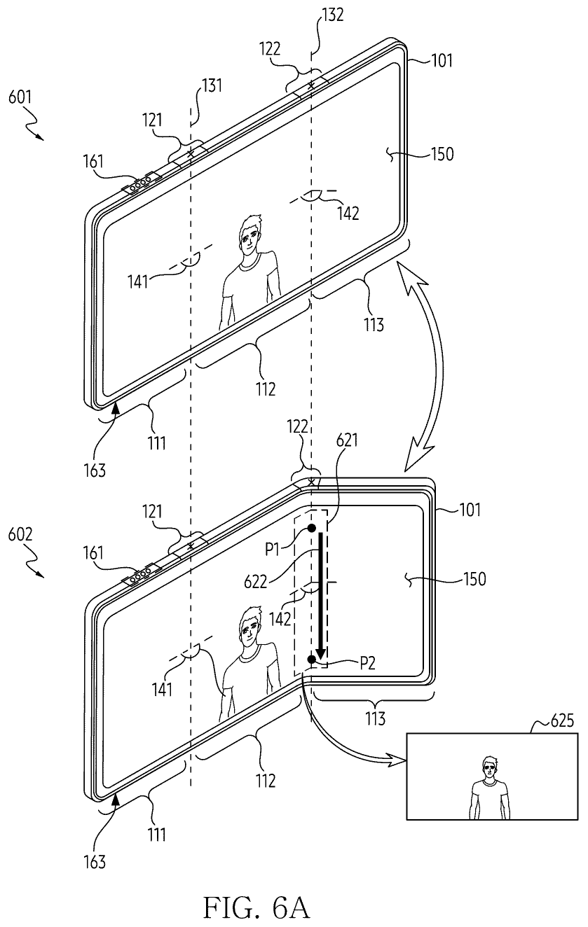

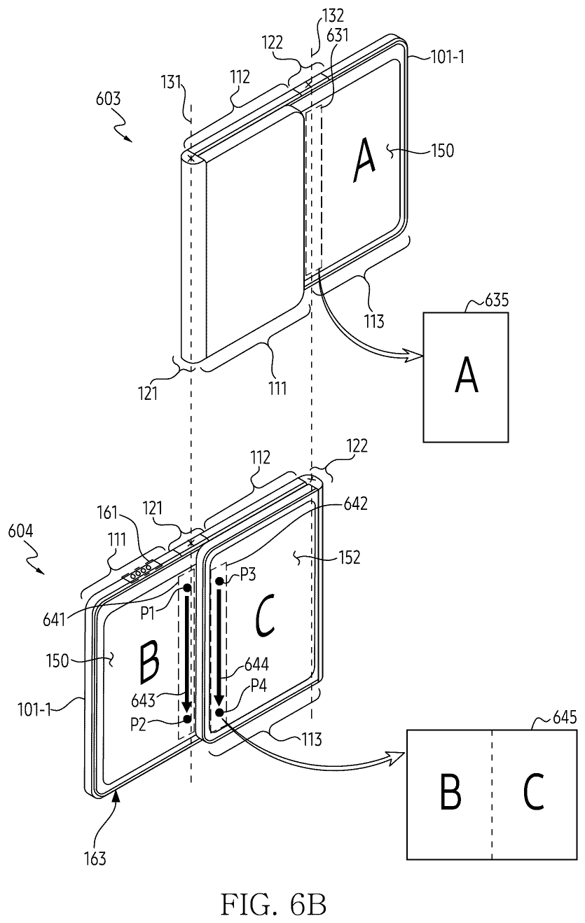

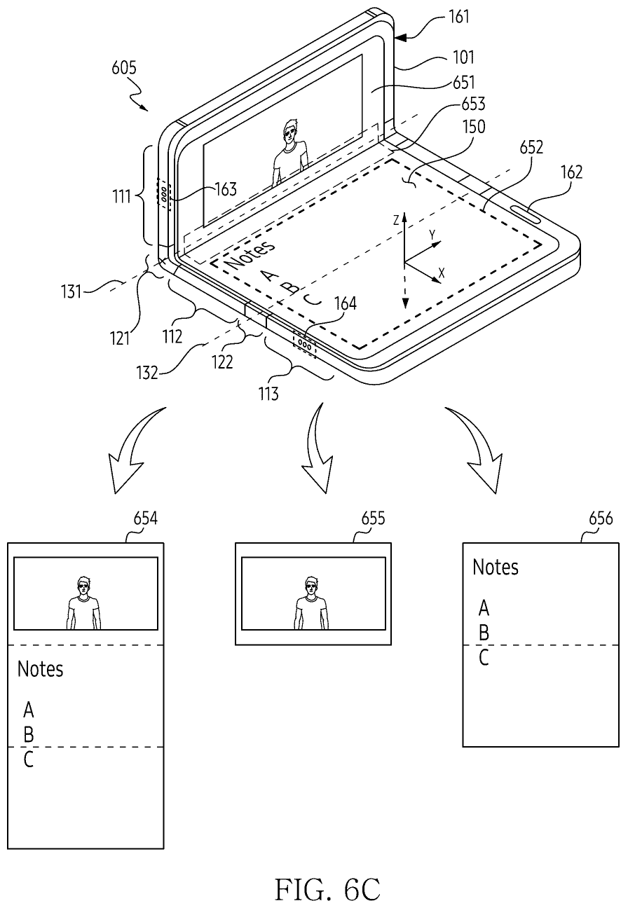

Hereinafter, an operation of the electronic device 101 receiving the preset touch input through a border area determined by the first angle 141 and/or the second angle 142 will be described with reference to FIGS. 6A to 6C.

FIGS. 6A, 6B, and 6C illustrate an operation of an electronic device storing an image related to a screen displayed on one or more displays (e.g., a flexible display 150 and/or a cover display 152) based on a preset touch input according to various embodiments of the disclosure.

The electronic device 101 of FIGS. 1A, 1B, and/or 2A and/or 2B may include the electronic device 101 of FIGS. 6A to 6C. The electronic device 101 and/or the processor 210 of FIG. 2A may perform an operation of the electronic device 101 described with reference to FIGS. 6A to 6C. The operation of the electronic device 101 described with reference to FIGS. 6A to 6C may be related to at least one of the operations of FIG. 3.

Referring to FIG. 6A, in a state 601, an electronic device 101 may determine that a state of the electronic device 101 corresponds to an unfold state by using a sensor (e.g., the sensor 250 of FIG. 2A). In the state 601 corresponding to the unfold state, the electronic device 101 may display a screen on the substantially unfolded flexible display 150 based on a software application executed by a processor (e.g., the processor 210 of FIG. 2A) of the electronic device 101. Referring to FIG. 6A, the state 601 of the electronic device 101 displaying a screen including an image and/or a video is illustrated.

In the state 601 of FIG. 6A, the electronic device 101 may display a screen based on the unfold state of a first housing 111, a second housing 112, and a third housing 113. For example, in the state 601, the electronic device 101 may display a screen corresponding to an entire displaying area of the flexible display 150 in response to detecting and/or calculating a first angle 141 and/or a second angle 142, which are substantially 180° (or the angle ranges 511 and 521 of FIG. 5). While displaying the screen based on the unfold state, the electronic device 101 may detect rotation of the third housing 113 with respect to the second housing 112 using a sensor. From the state 601 corresponding to the unfold state, the electronic device 101 detecting the rotation of the third housing 113 with respect to the second housing 112 may switch to a state 602.

Referring to FIG. 6A, in the state 602 of identifying the second angle 142 included within an angle range (e.g., the angle ranges 522 and 523 of FIG. 5) set to receive the preset touch input for capturing a screen, the electronic device 101 may identify or receive the preset touch input through a border area 621 corresponding to the second angle 142. Referring to FIG. 6A, in the state 602, the electronic device 101 may identify the preset touch input based on a drag gesture of an external object moved from a location p1 within the border area 621 to a location p2 within the border area 621 along a path 622. Based on whether the external object moved to the location p2 is spaced apart from the border area 621, the electronic device 101 may obtain or store an image 625 corresponding to the entire displaying area of the flexible display 150. For example, in a case that the external object dragged to the location p2 is spaced apart from the flexible display 150, the electronic device 101 may store the image 625 corresponding to the entire displaying area (e.g., an entire displaying area extended from a first displaying area positioned on the first housing 111 to a third displaying area positioned on the third housing 113) of the flexible display 150.

In the state 602 of FIG. 6A, the electronic device 101 may display, on the flexible display 150, the image 625 obtained in response to the preset touch input. For example, the electronic device 101 may display a thumbnail corresponding to the image 625 at least temporarily (e.g., for a preset period of a few seconds). Based at least on the thumbnail, the electronic device 101 may receive an input for storage in memory (e.g., the memory 220 and/or the non-volatile memory 224 of FIG. 2A). In response to the input, the electronic device 101 may cease displaying the thumbnail and may store the image 625 in the memory.

In an embodiment, a portion of the flexible display 150 capable of receiving the preset touch input for capturing a screen is not limited to a border area (e.g., the border area 621 of FIG. 6A) formed by a first folding axis 131 and/or a second folding axis 132. Referring to FIG. 6B, states 603 and 604 of a first electronic device 101-1 including both the flexible display 150 and the cover display 152 are illustrated. The first electronic device 101-1 of FIG. 6B may correspond to the first electronic device 101-1 of FIG. 1A.

Referring to FIG. 6B, states 603 and 604 of a first electronic device 101-1 in which at least one of the first angle 141 or the second angle 142 corresponds to substantially 0° are illustrated. The states 603 and 604 may be included in a sub-fold state of the electronic device 101. Such as the state 603, the sub-fold state in which the first angle 141 is reduced to substantially 0°, and the second angle 142 corresponds to substantially 180° may be referred to as a half-fold state. In the state 603 of FIG. 6B, since the first angle 141 corresponds to substantially 0°, the first displaying area of the flexible display 150 positioned on the first housing 111 and a second displaying area positioned on the second housing 112 may not be exposed to the outside, and may be occluded by the first housing 111 and the second housing 112. In the state 603 of FIG. 6B, only the third displaying area of the flexible display 150 positioned on the third housing 113 may be exposed to the outside.

In the state 603 of FIG. 6B, the first electronic device 101-1 may activate the flexible display 150. In the state 603, the first electronic device 101-1 may activate the third displaying area of the flexible display 150 positioned on the third housing 113. The first electronic device 101-1 may display a screen (e.g., a screen A) on at least a portion of the activated flexible display 150. In the state 603, the screen A displayed on the third displaying area of the flexible display 150 may be provided from a software application executed by the first electronic device 101-1. A width, a height, an aspect ratio, a size, and/or extent of the screen A may correspond to a width, a height, an aspect ratio, a size, and/or extent of the third displaying area exposed to the outside in the state 603.

Referring to FIG. 6B, in the state 603, the first electronic device 101-1 may receive or identify the preset touch input through a border area 631 corresponding to the second folding axis 132 adjacent to the third displaying area of the flexible display 150 exposed to the outside. Independently of whether the flexible display 150 is bent on the border area 631, the first electronic device 101-1 may identify the preset touch input. For example, on the border area 631, the first electronic device 101-1 identifying a drag gesture based on an external object moved farther than a preset distance along a direction of the border area 631 may store an image 635 corresponding to the screen A displayed on the third displaying area.

Referring to FIG. 6B, in the state 604 in which the first angle 141 between the first housing 111 and the second housing 112 corresponds to substantially 180°, and the second angle 142 between the second housing 112 and the third housing 113 is reduced to substantially 0°, the first electronic device 101-1 may display a screen B on the first displaying area of the flexible display 150 positioned on the first housing 111. In the state 604, the first electronic device 101-1 may display a screen C on the cover display 152. The screen B and/or the screen C may be displayed based on execution of one or more software applications executed by the first electronic device 101-1. For example, the screen B and the screen C may be displayed by a single software application. For example, the screen B and the screen C may be displayed by each of a plurality of software applications that are executed substantially simultaneously based on multitasking.

Such as the state 604 of FIG. 6B, the state 604 in which the first angle 141 corresponds to (or is maintained at) substantially 180° and the second angle 142 is reduced to substantially 0° may be referred to as an inverted half-fold state. In the inverted half-fold state, the first electronic device 101-1 may provide a UI based on both the flexible display 150 and the cover display 152. In the state 604 of FIG. 6B, since the first angle 141 corresponds to substantially 180°, the first displaying area positioned on the first housing 111 may be exposed to the outside. In the state 604, since the second angle 142 corresponds to substantially 0°, the second displaying area positioned on the second housing 112 and/or the third displaying area positioned on the third housing 113 may be occluded by the second housing 112 and/or the third housing 113. In the state 604 of FIG. 6B, the first displaying area of the flexible display 150 in which the screen B is displayed and the cover display 152 in which the screen C is displayed may face substantially the same direction. For example, directions of a normal direction (or a normal vector) of the first displaying area and a normal direction of the cover display 152 may be substantially identical or parallel in the state 604.

Referring to FIG. 6B, in the state 604 of displaying the screen B through the first displaying area of the flexible display 150 and displaying the screen C on the cover display 152, the first electronic device 101-1 may receive or identify the preset touch input through the border area between the first displaying area and the cover display 152. The border area between the first displaying area and the cover display 152 may include a border area 641 including an edge (e.g., a right edge) of the first displaying area adjacent to the cover display 152 in the state 604. The border area between the first displaying area and the cover display 152 may include a border area 642 including an edge (e.g., a left edge) of the cover display 152 adjacent to the first displaying area in the state 604.

In the state 604 of FIG. 6B, in response to the drag gesture of an external object spaced apart from the location p2 after being moved from a location p1 to a location p2 along a path 643 within the border area 641, the first electronic device 101-1 may identify the preset touch input including a drag gesture. Similarly, the first electronic device 101-1 may identify a preset touch input based on a drag gesture of an external object spaced apart from a location p4 after being moved from a location p3 to the location p4 along a path 644 within the border area 642, and then. In response to the preset touch input, the first electronic device 101-1 may store an image 645 including both the screen B and the screen C displayed through each of the flexible display 150 (e.g., the first displaying area) and the cover display 152 in the state 604. Referring to FIG. 6B, in the image 645, the screen B may be connected to an edge of the screen C.

In the state 604 of FIG. 6B, the first electronic device 101-1 identifying the preset touch input may generate or synthesize the image 645 to be stored in the memory (e.g., the memory 220 of FIG. 2A), by merging a first image for the screen B displayed on the first displaying area and a second image for the screen C displayed on the second displaying area. The first image and the second image may be uploaded to volatile memory of the first electronic device 101-1 based on the operation 350 of FIG. 3. The first electronic device 101-1 may generate the image 645 by combining (or joining) the first image and the second image based on a positional relationship between the first displaying area and the cover display 152 in the state 604. For example, the screen B and the screen C may be concatenated based on the positional relationship in the image 645. Such as the state 604 of FIG. 6B, while displaying screens (e.g., the screen B and/or the screen C) in physically separated active areas (e.g., the first displaying area and/or active areas of cover display 152), the first electronic device 101-1 may store the screens based on the one image 645 in response to the preset touch input.

Referring to FIG. 6C, a state 605 of the electronic device 101 bent based on rotation of the first housing 111 with respect to the second housing 112 is illustrated. In the state 605 identifying the first angle 141 between the first housing 111 and the second housing 112 included in the angle range 512 of FIG. 5 and the second angle 142 between the second housing 112 and the third housing 113 included in the angle range 521 of FIG. 5, the flexible display 150 may include two flat portions 651 and 652. In the state 605 of executing a plurality of software applications based on multitasking, the electronic device 101 may map each of the plurality of software applications to each of the portions 651 and 652.

Referring to FIG. 6C, the state 605 of the electronic device 101 in which a first screen provided by a first software application for video playback is displayed through the portion 651 and a second screen provided by a second software application for memo is displayed through the portion 652 is illustrated. The portion 651 may correspond to the first displaying area on the first housing 111. The portion 652 may include the second displaying area on the second housing 112 and the third displaying area on the third housing 113. A border area 653 between the portions 651 and 652 may correspond to a border area (e.g., the first border area 413 of FIG. 4) between the first displaying area and the second displaying area.

In the state 605 of FIG. 6C, directions (or orientations) of the first screen and the second screen displayed through each of the portions 651 and 652 may be related to a direction of the electronic device 101 (e.g., a direction of the electronic device 101 detected by the sensor 250 of FIG. 2A). The electronic device 101 may detect or calculate the direction of the electronic device 101 using a sensor for identifying gravitational acceleration. In the state 605 of FIG. 6C, in a case that a rear surface opposite to a front surface of the second housing 112 and the third housing 113 on which the flexible display 150 of the electronic device 101 is positioned is contacted with the ground, the electronic device 101 may detect a direction of the gravitational acceleration applied in a direction of a-z axis. Based on the direction of the gravitational acceleration, the electronic device 101 may detect a posture of the electronic device 101 mounted based on the rear surface of the second housing 112 and the third housing 113.

In the state 605 of FIG. 6C, according to an embodiment, the electronic device 101 may receive the preset touch input for capturing a screen through the border area 653. For example, on the border area 653, based on an external object being dragged substantially parallel to a direction (e.g., a direction of a y-axis) where the border area 653 is extended, the electronic device 101 may detect or identify the preset touch input. In response to the preset touch input, the electronic device 101 may store an image corresponding to at least a portion of the flexible display 150.

In an embodiment, at least a portion of the flexible display 150 captured based on the preset touch input may be changed according to a setting value. The setting value may be adjusted by a preset software application (e.g., a software application included in an operating system such as a setting application). Referring to FIG. 6C, based on the setting value, the electronic device 101 may store at least one of a first image 654 corresponding to the entire displaying area of the flexible display 150, a second image 655 corresponding to the portion 651, or a third image 656 corresponding to the portion 652. In the state 605 in which the electronic device 101 displays the first screen and the second screen on each of the portions 651 and 652 based on multitasking, the second image 655 may correspond to the first screen and the third image 656 may correspond to the second screen.

As described above, the electronic device 101 including the flexible display 150 having a relatively large size and/or extent may receive the preset touch input for storing the image corresponding to the entire displaying area (or a portion of the displaying area) of the flexible display 150 through a portion (e.g., the border area 653) of the flexible display 150.

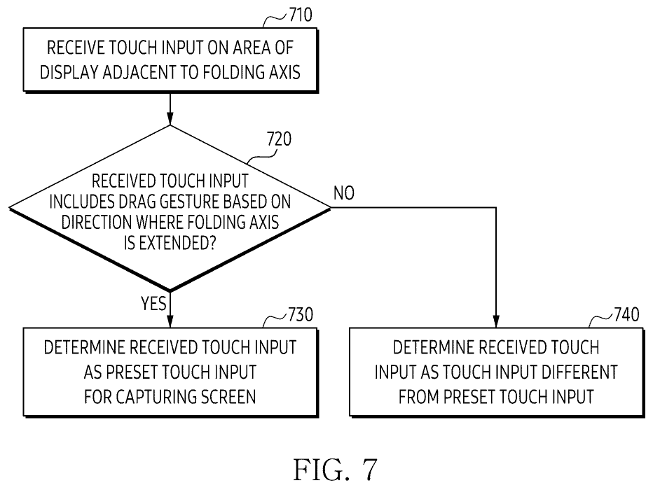

Hereinafter, an operation of the electronic device 101 described with reference to FIGS. 6A to 6C will be described with reference to FIG. 7.

FIG. 7 illustrates a flowchart of an electronic device according to an embodiment of the disclosure.

The electronic device 101 of FIGS. 1A, 1B, and/or 2A and/or 2B and the processor 210 (e.g., the LPU 212 and/or the DPU 214) of FIG. 2A may perform at least one of operations described with reference to FIG. 7. At least one of the operations of FIG. 7 may be related to the operation (e.g., the operation 330) described with reference to FIG. 3.

Referring to FIG. 7, in operation 710, a processor of the electronic device according to an embodiment may receive a touch input on an area of a display (e.g., the flexible display 150 and/or the cover display 152 of FIGS. 1A and/or 1B) adjacent to a folding axis. The operation 710 may be performed while displaying a screen through the display. The processor may perform the operation 710 of FIG. 7 similar to the operation 320 of FIG. 3. The folding axis of the operation 710 may include the first folding axis 131 and/or the second folding axis 132 of FIGS. 1A and/or 1B. The area of the operation 710 may include a border area (e.g., the first border area 413, the second border area 411 of FIG. 4, the border area 621 of FIG. 6A, the border areas 631, 641, and 642 of FIG. 6B, and/or the border area 653 of FIG. 6C) between displaying areas positioned on housings connected to each other by the folding axis. The touch input of the operation 710 may be detected or received based on sensor data of a touch panel (e.g., the first touch panel 234 and/or the second touch panel 244 of FIG. 2A) included in the display.

Referring to FIG. 7, in operation 720, the processor of the electronic device according to an embodiment may determine whether the touch input received based on the operation 710 includes a drag gesture based on a direction where the folding axis is extended. For example, the processor may determine whether the touch input of the operation 710 includes the drag gesture of the operation 720 by using the sensor data outputted from the touch panel. Using the sensor data, the processor may identify, within the area of the operation 710, a drag gesture based on an external object moved in a direction parallel to a direction of the folding axis or similar to the direction. For example, in a case that an angle difference between a direction of the drag gesture included in the touch input received based on the operation 710 and a direction of the folding axis is less than a preset angle, the processor may determine that the touch input includes the drag gesture of the operation 720. Referring to FIG. 7, in a case that the touch input received based on the operation 710 includes the drag gesture based on the direction of the folding axis (720—YES), the processor may perform operation 730. In a case that the touch input does not include the drag gesture (720—NO), the processor may perform operation 740.

Referring to FIG. 7, in operation 730, the processor of the electronic device according to an embodiment may determine the received touch input as a preset touch input for capturing a screen. The processor performing the operation 730 may execute a function (e.g., a function for capturing a screen) corresponding to the preset touch input. For example, based on the operation 730, the processor may perform at least one of the operations 340, 350, and 360 of FIG. 3. For example, the image 415 of FIG. 4, the image 625 of FIG. 6A, the images 635 and 645 of FIG. 6B, and the first image 654, the second image 655, and the third image 656 of FIG. 6C may be generated by the processor detecting (or identifying) the preset touch input based on the operation 730.

Referring to FIG. 7, in operation 740, the processor of the electronic device according to an embodiment may determine the received touch input as a touch input different from the preset touch input. The processor performing the operation 740 may not execute the function for capturing a screen, and may execute a different function from the function. For example, the processor may perform the operation 370 of FIG. 3. An embodiment is not limited thereto, and the processor may not execute any function in a case that a touch input not mapped to any function is received.

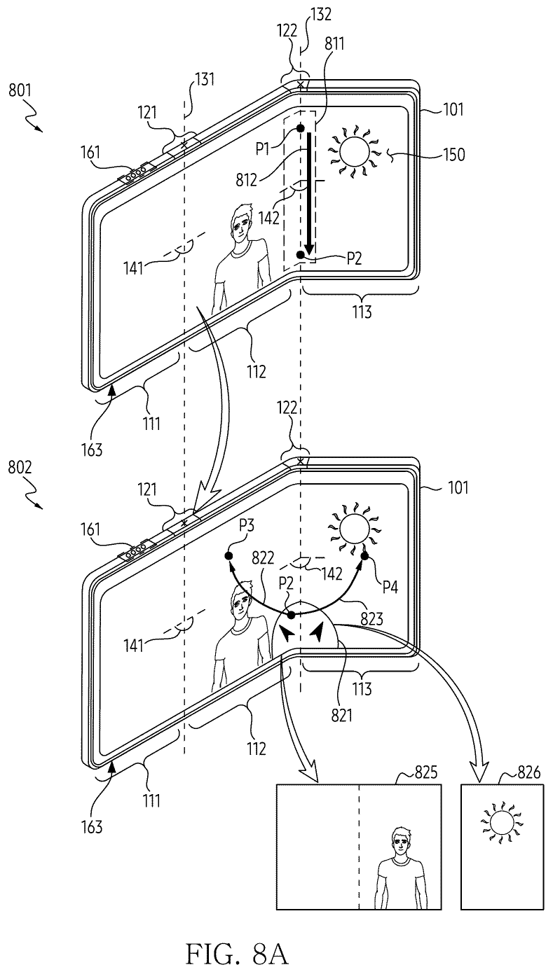

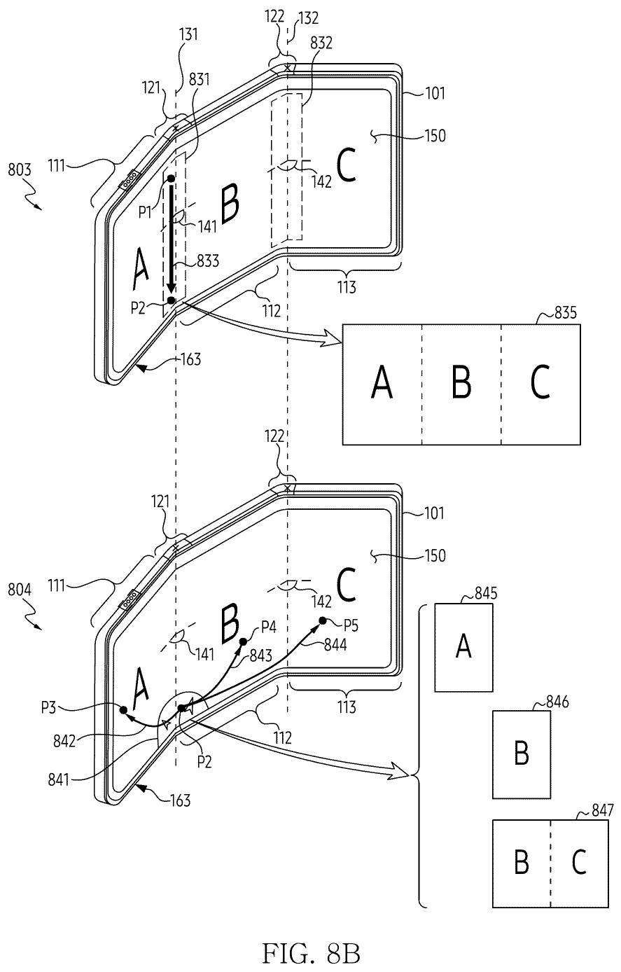

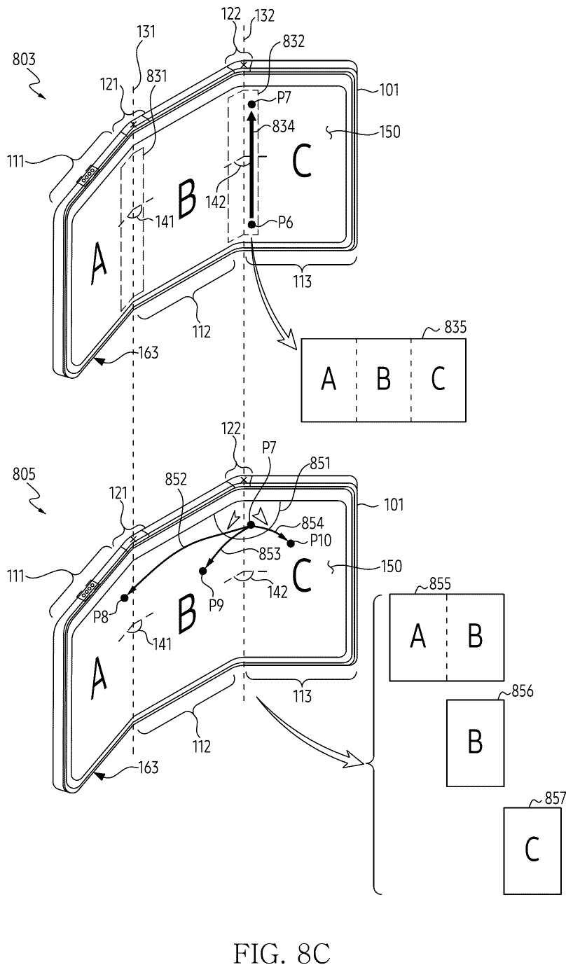

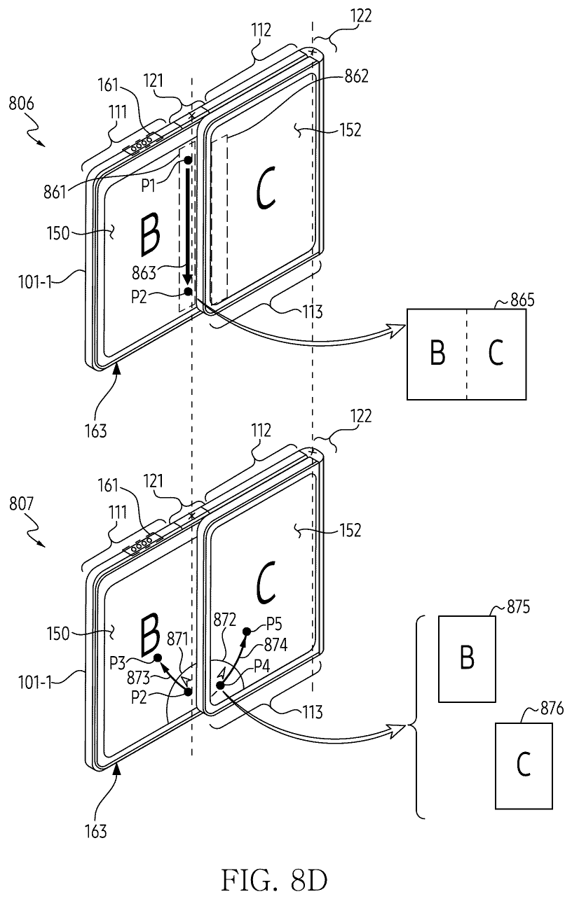

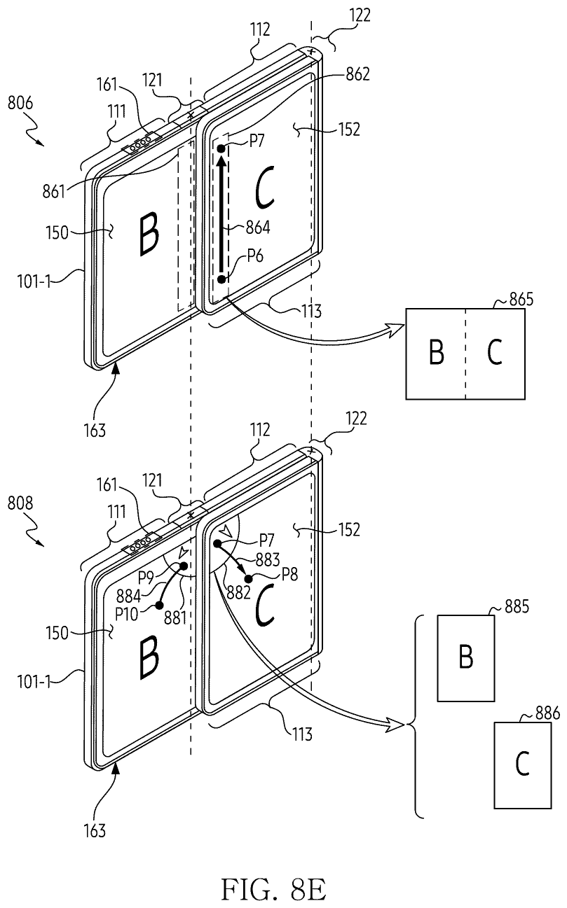

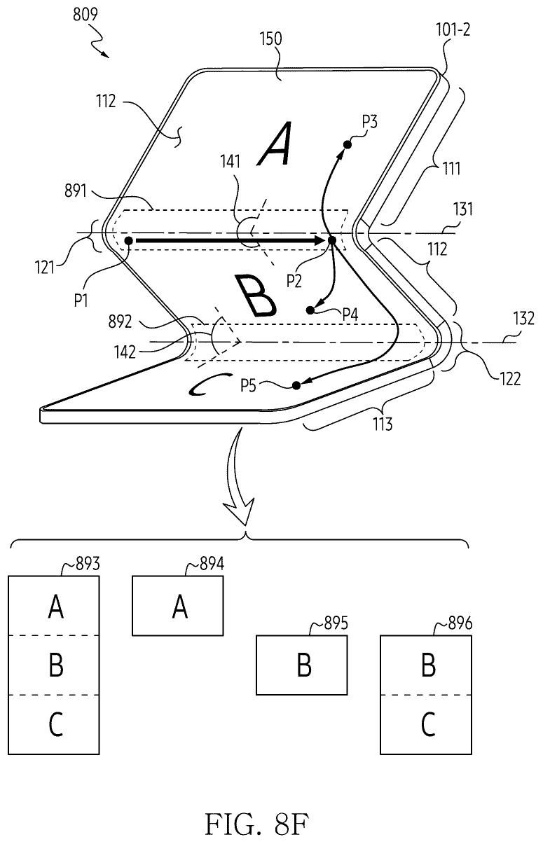

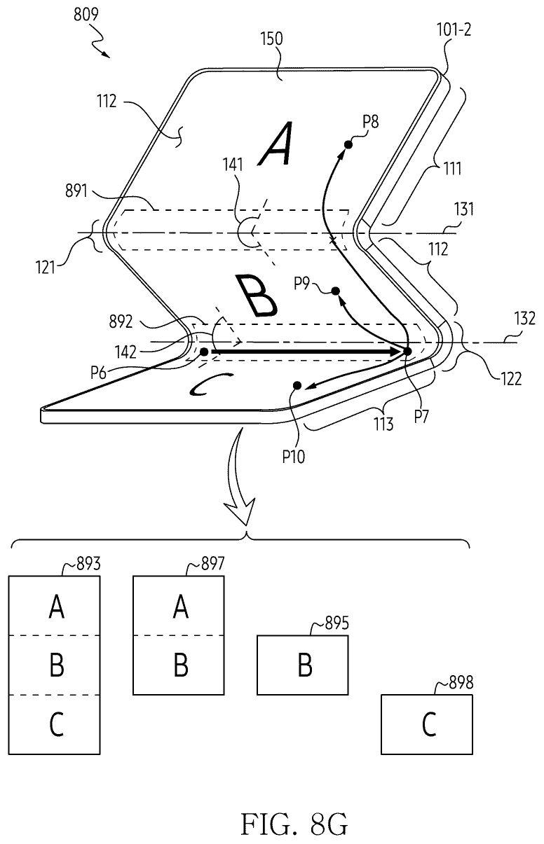

Hereinafter, an operation of the electronic device selectively capturing a portion of the screen displayed through the display based on the preset touch input of the operation 730 will be described with reference to FIGS. 8A to 8G.

FIGS. 8A, 8B, 8C, 8D, 8E, 8F, and 8G illustrate states of an electronic device receiving a preset touch input according to various embodiments of the disclosure.

The electronic device 101 of FIGS. 1A, 1B, 2A, and/or 2B may include the electronic device 101 of FIGS. 8A to 8G. The electronic device 101 and/or the processor 210 of FIG. 2A may perform an operation of the electronic device 101 described with reference to FIGS. 8A to 8G. The operation of the electronic device 101 described with reference to FIGS. 8A to 8G may be related to at least one of the operations of FIGS. 3 and/or 7.

Referring to FIG. 8A, states 801 and 802 of an electronic device 101 including a flexible display 150 bent at a second folding axis 132 are illustrated. In the states 801 and 802, the electronic device 101 may display a screen based on an entire displaying area of the flexible display 150. Referring to FIG. 8A, the states 801 and 802 of the electronic device 101 displaying a screen including a video and/or an image are illustrated, but an embodiment is not limited thereto.

Referring to FIG. 8A, the electronic device 101 may receive or identify a preset touch input for capturing at least a portion of a screen displayed on the flexible display 150 through a border area 811 of the folded flexible display 150. In the state 801 in which the border area 811 on the second folding axis 132 is bent, the electronic device 101 may identify a drag gesture initiated at a location p1 within the border area 811, and moved to a location p2 along a path 812. A direction of the path 812 (or a direction of the drag gesture) may be parallel to or similar to a direction of the second folding axis 132 in which the border area 811 is extended.

In the state 801 of FIG. 8A, based on whether an external object moved along the path 812 is spaced apart from the flexible display 150, the electronic device 101 may execute a function for screen capture. For example, in a case that an external object moved to the location p2 is spaced apart from the location p2, the electronic device 101 may initiate the function. For example, an image stored in the electronic device 101 based on the function may correspond to the screen displayed on the flexible display 150 when the external object is spaced apart from the flexible display 150.

In an embodiment, in a case that an external object moved along the direction of the second folding axis 132 is contacted on the location p2 within the border area 811 for a specified period, the electronic device 101 may switch to the state 802 for selecting a portion of a screen to be stored by the preset touch input. In the state 801, based on whether an external object moved along the path 812 is contacted on the location p2 for the preset period, the electronic device 101 may switch to the state 802. In the state 802, the electronic device 101 may display a visual object 821 for guiding selection of one portion among portions of the flexible display 150 distinguished by the border area 811, on an end adjacent to the location p2 where the external object is contacted among both ends of the border area 811. Referring to FIG. 8A, the electronic device 101 may display the visual object 821 for guiding selection of one of portions of the flexible display 150 distinguished by the border area 811 where the external object is contacted, on an end point (e.g., an end point on a lower portion of the flexible display 150) adjacent to the location p2 among two end points of the border area 811. The visual object 821 may be referred to as a visual affordance, an affordance UI, and/or an affordance user experience (UX).

Referring to FIG. 8A, a form of the visual object 821 for guiding selection of one of flat portions (e.g., a portion including a first displaying area and a second displaying area and another portion corresponding to a third displaying area) of the flexible display 150 distinguished by the border area 811 is illustrated. The visual object 821 may have a semi-circular shape having a center at a lower end of the border area 811 adjacent to the location p2. The visual object 821 may include figures (e.g., a triangle and/or an arrow) facing each of the portions. The figures may be positioned to guide that screen capture on one of the portions is performed based on an additional drag of the external object contacted on the location p2. In the state 802, in response to the external object released in the visual object 821, the electronic device 101 may perform screen capture on the entire displaying area of the flexible display 150. In the state 802, the electronic device 101 identifying an external object being dragged outside the visual object 821 may perform screen capture on one portion from which the external object is released among portions of the flexible display 150.

Referring to FIG. 8A, in the state 802 of displaying the visual object 821, the electronic device 101 may identify an external object moved (or dragged) from the location p2 to one portion among the flat portions of the flexible display 150. For example, the electronic device 101 identifying an external object dragged from the location p2 to a location p3 may store an image 825 corresponding to a portion of the flexible display 150 including the location p3 (e.g., a portion of the flexible display 150 positioned on a first housing 111 and a second housing 112) at a timing when the external object is spaced apart from the flexible display 150. Similarly, the electronic device 101 identifying an external object moved to a portion of the flexible display 150 positioned on a third housing 113 as it is moved from the location p2 to a location p4 may store an image 826 corresponding to the third displaying area of the flexible display 150 positioned on the third housing 113.

The electronic device 101 receiving the preset touch input for capturing any one portion of the flexible display 150 based on the visual object 821 may generate images (e.g., images 825 and 826) to be stored in non-volatile memory (e.g., the non-volatile memory 224 of FIG. 2A), by cropping an image uploaded to volatile memory (e.g., the volatile memory 222 of FIG. 2A) based on the operation 350 of FIG. 3.

For example, a DPU (e.g., the DPU 214 of FIGS. 2A and/or 2B) of the electronic device 101 may store an image corresponding to the entire displaying area of the flexible display 150 in the volatile memory in response to release of the external object dragged from the location p2 to the location p3. The DPU may obtain the image 825 by segmenting or cropping a portion corresponding to a portion of the flexible display 150 including the location p3 (e.g., a portion of the flexible display 150 including the first displaying area and the second displaying area) from the image stored in the volatile memory. The DPU may store the obtained image 825 in the non-volatile memory.

Similarly, in response to release of the external object dragged from the location p2 to the location p4, the electronic device 101 may upload the image corresponding to the entire displaying area of the flexible display 150 to the volatile memory. The electronic device 101 may obtain the image 826 by segmenting or cropping a portion of the flexible display 150 including the location p4 (e.g., a portion of the flexible display 150 corresponding to the third displaying area) in the uploaded image. The obtained image 826 may be stored in the non-volatile memory.

In the state 802 of FIG. 8A, in response to an external object dragged from the visual object 821, the electronic device 101 may generate an image (e.g., one image among the images 825 and 826) corresponding to a portion of the flexible display 150 including a location (e.g., one location among the locations p3 and p4) from which the external object is released. The portion of the flexible display 150 may correspond to one of the flat portions of the flexible display 150 distinguished by the border area 811 corresponding to the visual object 821.

Referring to FIG. 8A, a preset touch input for capturing a screen may include a first drag gesture (e.g., a drag gesture of operation 720 of FIG. 7) based on an external object dragged along the direction of the second folding axis 132 on the border area 811, a holding gesture based on an external object maintained for a period exceeding a preset period at a terminal point (or an end point) of the drag gesture, and a second drag gesture based on the external object dragged from the terminal point to one of the flat portions of the flexible display 150 distinguished by the border area 811. The electronic device 101 detecting the holding gesture may switch from the state 801 to the state 802 of FIG. 8A. Screen capture based on the preset touch input may be performed in response to termination of the second drag gesture.

Referring to FIG. 8A, an operation of the electronic device 101 for generating and/or storing an image for at least a portion of a screen provided from one software application has been described, but an embodiment is not limited thereto. Referring to FIG. 8B, different states 803 and 804 of the electronic device 101 displaying a plurality of screens (e.g., a screen A, a screen B, and a screen C) based on multitasking are illustrated. The plurality of screens may be displayed by each of a plurality of software applications executed by the processor (e.g., the processor 210 of FIG. 2A) of the electronic device 101. A user may set positions of the plurality of screens based on flat portions of the flexible display 150.

Referring to FIG. 8B, states 803 and 804 of an electronic device 101 including a flexible display 150 bent at each of a first folding axis 131 and a second folding axis 132 are illustrated. In the states 803 and 804, the electronic device 101 may detect a preset touch input for capturing at least a portion of a screen displayed on the flexible display 150 through a first border area 831 and a second border area 832 corresponding to the first folding axis 131 and the second folding axis 132, respectively. For example, in the state 803, in a case that an external object contacted on a location p1 within the first border area 831 is moved to a location p2 along a path 833 in a direction substantially parallel to the first folding axis 131 and then separated from the flexible display 150, the electronic device 101 may identify the preset touch input based on the external object. In response to the preset touch input, the electronic device 101 may store an image 835 corresponding to the entire displaying area of the flexible display 150. For example, the image 835 may include all of the screen A, the screen B, and the screen C displayed on the flexible display 150. Similarly, in response to a drag gesture performed within the second border area 832 and performed along the direction of the second folding axis 132, the electronic device 101 may receive the preset touch input for screen capture for the entire displaying area of the flexible display 150.

In the state 803 of FIG. 8B, in a case that the external object moved to the location p2 along the path 833 is contacted on the location p2 for a period exceeding a preset period (e.g., a few seconds), the electronic device 101 may switch to the state 804 for receiving an additional drag gesture for selecting at least a portion of the flexible display 150 for screen capture. The electronic device 101 switched to the state 804 may display a visual object 841 within the first border area 831 adjacent to the location p2 or including the location p2. Although the visual object 841 having a semi-circular shape having a center at an end of the first border area 831 is exemplarily illustrated, an embodiment is not limited thereto. Similar to the visual object 821 of FIG. 8A, the electronic device 101 may display the visual object 841 including figures facing each of flat portions of the flexible display 150 distinguished by the first border area 831 corresponding to the location p2.

Referring to FIG. 8B, in the state 804 of displaying the visual object 841, the electronic device 101 may identify an external object moved from the location p2 to one portion among the flat portions of the flexible display 150. Among three flat portions of the flexible display 150 distinguished by the first folding axis 131 and the second folding axis 132, the electronic device 101 may generate or store an image corresponding to at least one portion overlapping paths (e.g., paths 842, 843, and 844) of the external object moved from the location p2.

For example, when an external object moved from the location p2 to a location p3 on the first displaying area along the path 842 is spaced apart from the flexible display 150, the electronic device 101 may store a first image 845 corresponding to the first displaying area. In the example, the electronic device 101 may obtain or store the first image 845 including the screen A from among the screen A displayed on the first displaying area, the screen B displayed on the second displaying area, and the screen C displayed on the third displaying area.

For example, in a case that an external object moved from the location p2 to a location p4 on the second displaying area along the path 843 is separated from the flexible display 150, the electronic device 101 may generate a second image 846 corresponding to the second displaying area. In the example, the electronic device 101 may store the second image 846 corresponding to the screen B displayed on the second displaying area among a plurality of screens displayed on the flexible display 150.

For example, the electronic device 101 identifying an external object moved from the location p2 to a location p5 on the third displaying area from the second displaying area along a path 944 may generate a third image 847 corresponding to the second displaying area and the third displaying area in response to the external object released from the location p5. In the example, the electronic device 101 may obtain the third image 847 including the screen B and the screen C displayed on each of the second displaying area and the third displaying area, among the screens displayed on the flexible display 150.

Referring to FIG. 8B, the preset touch input for capturing at least a portion of the flexible display 150 may include a first drag gesture based on the external object moved along the path 833, a holding gesture based on the external object contacted at a terminal point of the first drag gesture for a period exceeding a preset period, and a second drag gesture based on the external object moved along one of the paths 842, 843, and 844 from the terminal point. The electronic device 101 may determine at least one portion corresponding to an image to be stored in the electronic device 101 among the flat portions of the flexible display 150 distinguished by the first folding axis 131 and the second folding axis 132 based on a path of the second drag gesture. The electronic device 101 may generate an image corresponding to at least one portion swept by the second drag gesture, among the portions.

Referring to FIG. 8B, an embodiment of receiving the preset touch input through the first border area 831 formed on the first folding axis 131 has been described, but an embodiment is not limited thereto. Referring to FIG. 8C, in the state 803, the electronic device 101 may identify a preset touch input based on the second border area 832 corresponding to the second folding axis 132. For example, in the state 803 of FIG. 8C, the electronic device 101 may detect or identify a drag gesture based on an external object moved from a location p6 within the second border area 832 to a location p7 along a path 834. In a case that the external object performing the drag gesture is released from the location p7, the electronic device 101 may store the image 835 including all of the screens (e.g., the screen A, the screen B, and the screen C) displayed on the flexible display 150.

In the state 803 of FIG. 8C, in a case that the external object moved to the location p7 along the path 834 is contacted on the location p7 for a period exceeding a preset period, the electronic device 101 may display a visual object 851. The visual object 851 may be displayed on a portion of the flexible display 150 adjacent to the location p7. The visual object 851 may overlap at least one of a plurality of screens displayed on the flexible display 150. The visual object 851 may have preset opacity (or transparency) to minimize information occluded by the visual object 851. The visual object 851 of FIG. 8C may correspond to the visual object 821 of FIG. 8A and/or the visual object 841 of FIG. 8B.

Referring to FIG. 8C, in a state 805 in which a visual object 851 is displayed, an electronic device 101 may generate or store an image corresponding to at least one of the three flat portions of the flexible display 150 based on a path (e.g., paths 852, 853, and 854) of an external object dragged from the location p7. An embodiment is not limited thereto, and the electronic device 101 identifying an external object spaced apart from the location p7 on the visual object 851 may generate or store the image 835 corresponding to all of the screens displayed on the flexible display 150.

In the state 805 of FIG. 8C, the electronic device 101 detecting an external object moved to a location p8 on the first displaying area of the flexible display 150 positioned on the first housing 111 along the path 852 may store a first image 855 including screens (e.g., the screen A and the screen B) positioned in the first displaying area and the second displaying area of the flexible display 150 positioned on the second housing 112 that are overlapped with the path 852. The electronic device 101 may obtain the first image 855 based on release of the external object at the location p8.

In the state 805 of FIG. 8C, the electronic device 101 detecting an external object moved from the location p7 to a location p9 along the path 853 may generate a second image 856 corresponding to the second displaying area including the path 853 in response to release of the external object. The second image 856 may include the screen B displayed on the second displaying area among the screen A to the screen C respectively displayed on the first displaying area to the third displaying area.

In the state 805 of FIG. 8C, the electronic device 101 identifying an external object moved from the location p7 to a location p10 along the path 854 may obtain a third image 857 corresponding to the third displaying area overlapping the path 854 when the external object is separated from the location p10. For example, the electronic device 101 may store the third image 857 including the screen C displayed on the third displaying area.

In the state 805 of FIG. 8C, the electronic device 101 identifying a preset touch input may generate an image (e.g., the first image 855, the second image 856, and/or the third image 857) to be stored in memory by cropping an image corresponding to the entire displaying area of the flexible display 150. A width, a height, and/or a size of the image segmented by cropping may be related to a path (e.g., the paths 852, 853, and 854 of FIG. 8C) of a drag gesture included in the preset touch input. For example, the electronic device 101 may determine at least a portion of the flexible display 150 to be stored in an image in the state 805 of displaying the visual object 851 or based on a path of a drag gesture detected after a timing of displaying the visual object 851.

Referring to FIGS. 8A to 8C, an operation of the electronic device 101 for generating and storing an image corresponding to at least a portion of the flexible display 150 has been described, but an embodiment is not limited thereto. As described above with reference to FIGS. 1A and/or 2A and/or 2B, in an embodiment of the electronic device 101 including a plurality of displays (e.g., the flexible display 150 and the cover display 152 of FIG. 1A, and the first display 230 and the second display 240 of FIGS. 2A and/or 2B), the electronic device 101 may simultaneously activate the plurality of displays and display a plurality of screens through the plurality of displays.

Referring to FIG. 8D, states 806 and 807 of a first electronic device 101-1 including the flexible display 150 and the cover display 152 are illustrated. The states 806 and 807 of the first electronic device 101-1 of FIG. 8D may correspond to the inverted half-fold state described with reference to FIG. 6B. In the state 806, the first electronic device 101-1 may display a screen B on a first displaying area of the flexible display 150 positioned on the first housing 111. In the state 806, the first electronic device 101-1 may display a screen C on the cover display 152. The screen B and the screen C may be provided by one or more software applications executed by the first electronic device 101-1.

In the state 806 of FIG. 8D, the first electronic device 101-1 may receive a preset touch input for capturing a screen displayed on the flexible display 150 and/or the cover display 152 through a border area 861 between the first displaying area in which the screen B is displayed and another displaying area of the flexible display 150 occluded by the third housing 113, and/or a border area 862 of the cover display 152 adjacent to the first displaying area. For example, the preset touch input may include a drag gesture initiated at a location p1 within the border area 861 and ceased at a location p2 within the border area 861 along a path 863. In response to the preset touch input including the drag gesture, the first electronic device 101-1 may generate or store an image 865 including all of the screen B displayed on the first displaying area and the screen C displayed on the cover display 152. In the image 865, the screen B and the screen C may be positioned based on a positional relationship between the first displaying area and the cover display 152.

In the state 806 of FIG. 8D, in a case that an external object moved to the location p2 along the path 863 is contacted on the location p2 for a period greater than a preset period, the first electronic device 101-1 may switch to the state 807. In the state 807, the first electronic device 101-1 may display a visual object 871 on a portion of the first displaying area adjacent to the location p2, and may display a visual object 872 on a portion of the cover display 152 adjacent to the location p2. The visual objects 871 and 872 displayed on each of the flexible display 150 and the cover display 152 may have a shape of quadrants segmented from a semicircle. An embodiment is not limited thereto. The visual objects 871 and 872 of FIG. 8D may correspond to the visual object 821 of FIG. 8A, the visual object 841 of FIG. 8B, and/or the visual object 851 of FIG. 8C.

Referring to FIG. 8D, in the state 807 of displaying the visual objects 871 and 872, the first electronic device 101-1 may additionally identify a drag gesture based at least on an external object contacted on the location p2. Based on the additionally identified drag gesture, the first electronic device 101-1 may identify the preset touch input for selectively capturing one of the flexible display 150 and the cover display 152. For example, the first electronic device 101-1 detecting an external object moved from the location p2 to a location p3 along path 873 may obtain or store a first image 875 corresponding to the screen B of the first displaying area overlapping the path 873.

For example, in a case that the external object contacted on the location p2 is contacted on a location p4 on the cover display 152, the first electronic device 101-1 may detect the preset touch input based on the external object contacted on the location p4, based on at least one of a time difference between a first timing where the external object is separated from the location p2 and a second timing where the external object is contacted on the location p4 and/or a distance between the locations p2 and p4.

For example, in a case that the time difference is less than a preset time difference, and the distance is less than a preset distance, the first electronic device 101-1 may identify the preset touch input based on a drag gesture of the external object contacted on the location p4. In the example, in a case that the time interval difference is greater than or equal to the preset time difference, or the distance is greater than or equal to the preset distance, the first electronic device 101-1 may identify termination of the preset touch input. In response to the termination of the preset touch input, the first electronic device 101-1 may perform screen capture for all of the screen B displayed on the first displaying area of the flexible display 150 and the screen C displayed on the cover display 152, such as the image 865. In the state 807, the first electronic device 101-1 identifying the termination of the preset touch input may at least temporarily cease displaying the visual objects 871 and 872.

In the state 807 of FIG. 8D, the first electronic device 101-1 identifying the external object contacted on the location p4 in the preset time difference after the external object is separated from the location p2 may identify the preset touch input related to the cover display 152 based on a drag gesture of the external object contacted on the location p4. For example, based on an external object dragged from the location p4 to a location p5 along a path 874, the first electronic device 101-1 may identify the preset touch input for capturing the screen C among the screen B displayed on the first displaying area and the screen C displayed on the cover display 152. In the example, when the external object is spaced apart from the location p5, the first electronic device 101-1 may generate or store an image 876 corresponding to the screen C displayed on the cover display 152.

In the states 806 and 807 corresponding to the inverted half-fold state described with reference to FIG. 8D, a DPU (e.g., the DPU 214 of FIGS. 2A and/or 2B) of the first electronic device 101-1 may upload all of a first image corresponding to the screen B displayed on the first displaying area and a second image corresponding to the screen C displayed on the cover display 152 to volatile memory (e.g., the volatile memory 222 of FIGS. 2A and/or 2B) in response to the preset touch input. The first electronic device 101-1 may generate the image 865 by coupling the first image and the second image uploaded to the volatile memory. The first electronic device 101-1 may generate one of the images 875 and 876 by selecting one of the first image and the second image and discarding another one. Coupling or selecting the first image and the second image uploaded to the volatile memory by the first electronic device 101-1 may be performed based on the drag gesture described with reference to FIG. 8D.

Referring to FIG. 8E, in the state 806, the first electronic device 101-1 may identify a preset touch input based on a drag gesture performed within the border area 862. In the state 806 of FIG. 8E, a drag gesture moved from a location p6 within the border area 862 to a location p7 within the border area 862 along a path 864 is illustrated, but an embodiment is not limited thereto. The first electronic device 101-1 identifying the drag gesture along the path 864 may perform screen capture on at least one of the screen B and/or the screen C displayed in the state 806 in response to release of an external object performing the drag gesture. For example, in response to the external object released on the location p7, the first electronic device 101-1 may generate or store an image 865 including all of the screen B and the screen C.

For example, the first electronic device 101-1 identifying an external object contacted on the location p7 for a period exceeding a preset period may switch from the state 806 to a state 808. In the state 808, the first electronic device 101-1 may display a visual object 882 on a portion of the cover display 152 adjacent to the location p7. In the state 808, the first electronic device 101-1 may display a visual object 881 on a portion of the first displaying area adjacent to the location p7. The visual objects 881 and 882 may correspond to the visual objects 871 and 872 of FIG. 8D. In the state 808 of displaying the visual objects 881 and 882, the first electronic device 101-1 may receive a drag gesture for selectively performing screen capture on one of the first displaying area or the cover display 152.

In the state 808 of FIG. 8E, in a case that the external object contacted on the location p7 is moved to a location p8 along a path 883, the first electronic device 101-1 may store an image 886 corresponding to the screen C displayed on the cover display 152 in which the external object is contacted. In the state 808, the first electronic device 101-1 detecting an external object contacted on a location p9 less than a preset distance from the location p7 in a preset time difference after identifying release of the external object contacted on the location p7 may receive a drag gesture for selectively performing screen capture on the first displaying area based on a path 884 of the external object contacted on the location p9. For example, in response to a drag gesture initiated at the location p9 and ceased at a location p10 on the first displaying area along the path 884, the first electronic device 101-1 may obtain or store an image 885 corresponding to the screen B displayed on the first displaying area.

Referring to FIGS. 8F and/or 8G, a state 809 of a second electronic device 101-2 including the flexible display 150 that may be folded at an angle exceeding 180° is illustrated. The state 809 of the second electronic device 101-2 of FIGS. 8F and 8G may be included in the sub-fold state described with reference to FIG. 1B. In the state 809, the second electronic device 101-2 may detect a first angle 141 included within an angle range 513 and a second angle 142 included within an angle range 522 using a sensor (e.g., the sensor 250 of FIG. 2A). In the state 809 folded by the first folding axis 131 and the second folding axis 132, the flexible display 150 may include three flat portions.

Referring to FIGS. 8F and 8G, state 809 in which the second electronic device 101-2 displays a screen A, a screen B, and a screen C provided by a plurality of software applications executed by the second electronic device 101-2 on each of a first displaying area on the first housing 111, a second displaying area on the second housing 112, and a third displaying area on the third housing 113 is illustrated. An embodiment is not limited thereto, and the second electronic device 101-2 may display a single screen provided from a single software application on the entire flexible display 150 in the sub-fold state such as the state 809. In the state 809 of displaying the screen A to the screen C, a first border area 891 may be formed between the screen A displayed on the first displaying area and the screen B displayed on the second displaying area. In the state 809, a second border area 892 may be formed between the screen B displayed on the second displaying area and the screen C displayed on the third displaying area.

Referring to FIG. 8F, in the state 809, the second electronic device 101-2 may receive a preset touch input through the first border area 891 formed on the first folding axis 131. For example, the preset touch input may include a drag gesture based on an external object moved from a location p1 within the first border area 891 between the first displaying area and the second displaying area to a location p2 within the first border area 891. The second electronic device 101-2 detecting the drag gesture may store an image 893 including all of the screen A to the screen C displayed on the flexible display 150 in response to release of the external object on the location p2. The second electronic device 101-2 detecting the drag gesture may switch to a state for selectively capturing at least one of the flat portions of the flexible display 150 in response to a hold gesture based on an external object contacted on the location p2 for a period exceeding a preset period. The second electronic device 101-2 detecting the hold gesture may display a visual object for guiding selection of the flat portions of the flexible display 150, such as the visual object 821 of FIG. 8A.

Referring to FIG. 8F, based on an additional drag gesture initiated at the location p2, the second electronic device 101-2 may obtain an image (e.g., images 894, 895, and 896) corresponding to a portion of the flexible display 150. For example, in response to a drag gesture facing from the location p2 to a location p3 on the first displaying area, the second electronic device 101-2 may store the image 894 corresponding to the screen A on the first displaying area. For example, the second electronic device 101-2 detecting a drag gesture facing from the location p2 to a location p4 on the second displaying area may store the image 895 corresponding to the screen B on the second displaying area. For example, the second electronic device 101-2 detecting a drag gesture based on an external object moved from the location p2, across the second displaying area, to a location p5 on the third displaying area may store the image 896 including all of the screen B on the second displaying area and the screen C on the third displaying area.

Referring to FIG. 8G, in the state 809, the second electronic device 101-2 may detect or receive a preset touch input through the second border area 892 formed on the second folding axis 132. Referring to FIG. 8G, the preset touch input may include a drag gesture initiated at a location p6 within the second border area 892 and ceased at a location p7. In a case that release (or termination) of the drag gesture is detected at the location p7, the second electronic device 101-2 detecting the drag gesture may store the image 893 corresponding to an entire displaying area of the flexible display 150. The second electronic device 101-2 detecting an external object contacted on the location p7 for a period exceeding a preset period instead of the release of the drag gesture may obtain or store an image (e.g., images 895, 897, and 898) corresponding to a portion of the flexible display 150 in response to an additional drag gesture performed by the external object.

Referring to FIG. 8G, the second electronic device 101-2 detecting a drag gesture facing from the location p7, across the second displaying area, to a location p8 on the first displaying area may obtain or store the image 897 including all of the screen A and the screen B displayed on the second displaying area and the first displaying area identifying the drag gesture. For example, the second electronic device 101-2 detecting a drag gesture facing from the location p7 to a location p9 on the second displaying area may store the image 895 including the screen B corresponding to the second displaying area. For example, in response to a drag gesture facing from the location p7 to a location p10 on the third displaying area, the second electronic device 101-2 may store the image 898 including the screen C displayed on the third displaying area. Generating and/or storing an image corresponding to a portion of a displaying area of the flexible display 150, such as the images 895, 897, and 898, may be performed based on segmentation and/or crop of an image, uploaded to the volatile memory, for the entire displaying area of the flexible display 150. The segmentation and/or the crop of the image uploaded to the volatile memory may be performed based on a DPU (e.g., the DPU 214 of FIGS. 2A and/or 2B) of the second electronic device 101-2.

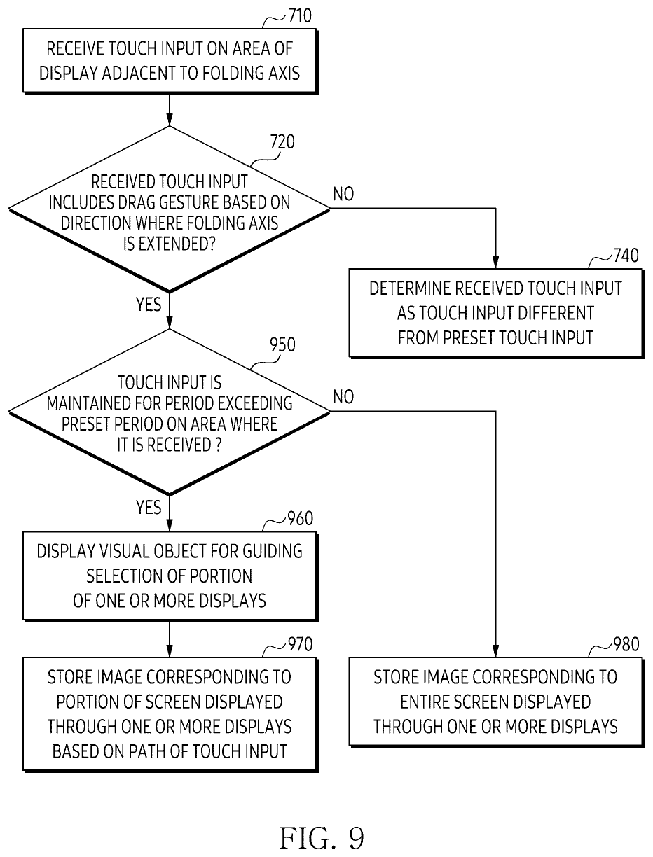

As described above, according to an embodiment, the electronic device 101 may selectively capture a portion (e.g., at least one of the flat portions of the flexible display 150 distinguished by the first folding axis 131 and/or the second folding axis 132) of the entire displaying area of the relatively wide flexible display 150 in response to the preset touch input. The preset touch input may include a first drag gesture within a border area formed on a folding axis, a hold gesture for a terminal point of the first drag gesture, and a second drag gesture initiated at the terminal point of the first drag gesture after the hold gesture. The electronic device 101 sequentially detecting the first drag gesture, the hold gesture, and the second drag gesture in a time domain may perform screen capture in response to termination of the second drag gesture. Hereinafter, an operation of the electronic device 101 described with reference to FIGS. 8A to 8G will be described with reference to FIG. 9.

FIG. 9 illustrates a flowchart of an electronic device according to an embodiment of the disclosure.

The electronic device 101 of FIGS. 1A, 1B, and/or 2A and/or 2B and the processor 210 (e.g., the LPU 212 and/or the DPU 214) of FIG. 2A may perform at least one of operations described with reference to FIG. 9. At least one of the operations of FIG. 9 may be related to the operation (e.g., the operation 330) described with reference to FIGS. 3 and/or 7. For example, operations 950, 960, 970, and 980 of FIG. 9 may be performed based on the operation 720 of FIG. 7.

Referring to FIG. 9, in operation 950, a processor of the electronic device according to an embodiment may identify or determine whether the touch input received based on the operation 710 is maintained for a period exceeding a preset period on an area (e.g., a border area) where the touch input is received. In a case that the touch input received based on the operation 710 includes the drag gesture of the operation 720 (720—YES), the processor may perform the operation 950. The preset period of the operation 950 may have a length of a few seconds, as a non-limiting example, such as 0.5 seconds to 1.5 seconds. Based on the operation 950, the processor may detect a hold gesture performed after the drag gesture of the operation 720 and performed at a terminal point of the drag gesture. In a case that the touch input is maintained on the area of the operation 710 for a period exceeding the preset period (950—YES), the processor may perform operation 960. In a case that the touch input is maintained on the area of the operation 710 for a period less than the preset period (950—NO) (e.g., in a case that the touch input terminates within the preset period), the processor may perform operation 980.

Referring to FIG. 9, in operation 960, the processor of the electronic device according to an embodiment may display a visual object for guiding selection of a portion of one or more displays. The visual object of the operation 960 may include the visual object 821 of FIG. 8A, the visual object 841 of FIG. 8B, the visual object 851 of FIG. 8C, the visual objects 871 and 872 of FIG. 8D, and/or the visual objects 881 and 882 of FIG. 8E. A position at which the visual object of the operation 960 is displayed may include a location at which a touch input is maintained, or may be adjacent to the location.

Referring to FIG. 9, in operation 970, the processor of the electronic device according to an embodiment may store an image corresponding to a portion of a screen displayed through the one or more displays based on a path of a touch input. The path of the operation 970 may include paths 822, 823, 842, 843, 844, 852, 853, 854, 883, and 884 described with reference to FIGS. 8A to 8G. Based on the operation 970, the processor may generate an image to be stored in memory (e.g., the memory 220 and/or the non-volatile memory 224 of FIGS. 2A and/or 2B), using one or more images for one or more screens provided on the one or more displays (e.g., the flexible display 150 and/or the cover display 152 of FIGS. 1A and 1B, and the first display 230 and/or the second display 240 of FIGS. 2A and/or 2B). Referring to FIGS. 8A to 8G, the images 825, 826, 845, 846, 847, 856, 857, 875, 876, 885, 886, 894, 895, 896, 897, and 898 may be stored in the electronic device based on the operation 970.

Referring to FIG. 9, in operation 980, the processor of the electronic device according to an embodiment may store an image corresponding to an entire screen displayed through the one or more displays. For example, in a case that an external object performing a touch input is separated from a display within a period less than a preset period, the processor may perform the operation 980. Referring to FIGS. 8A to 8G, the images 835, 865, and 893 may be stored in the electronic device based on the operation 980.

As described above, according to an embodiment, the processor of the electronic device may identify a preset touch input initiated at a location within an area (e.g., the border areas 811, 831, 832, 861, 862, 891, and 892 exemplified in FIGS. 8A to 8G) formed on the display. Based on a path of a drag gesture included in the preset touch input, the processor may perform screen capture on all of the one or more screens displayed on the one or more displays. Based on the path, the processor may perform screen capture on at least one of flat portions of the flexible display. Based on the path, the processor may perform screen capture for generating one image from a plurality of displays.

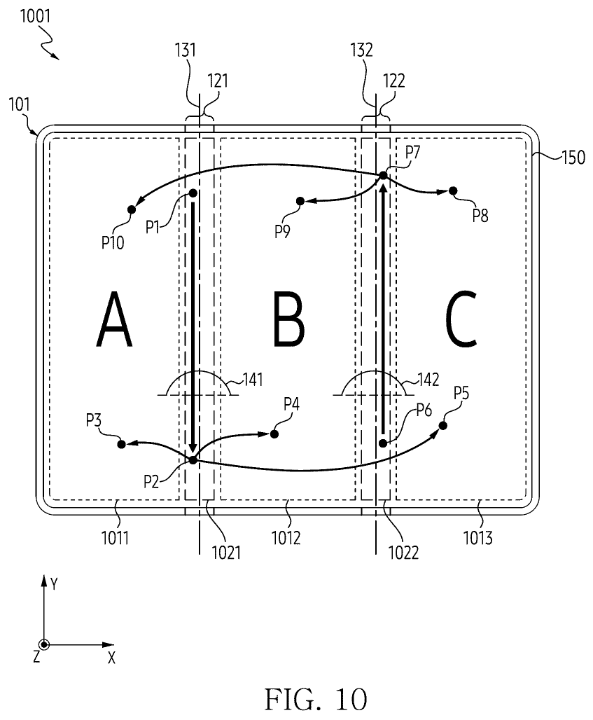

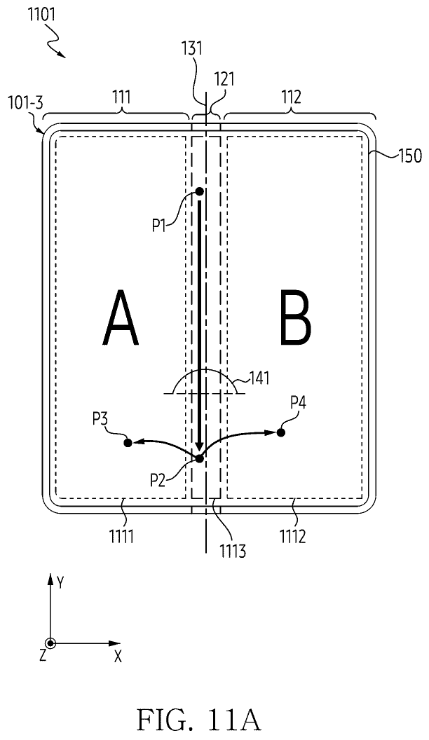

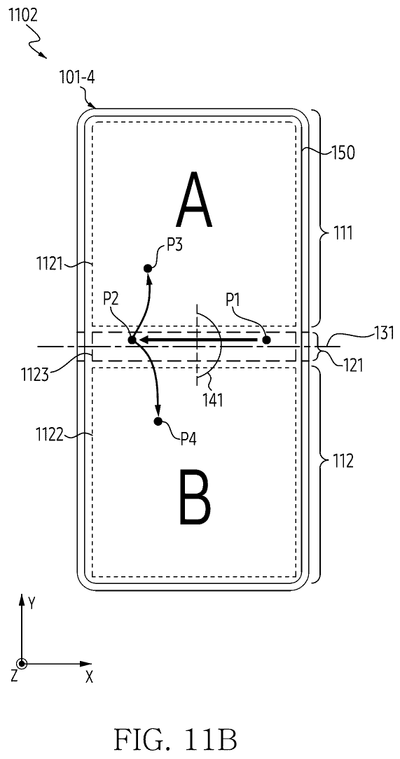

An embodiment is not limited to an embodiment of the electronic device 101 receiving the preset touch input in the sub-fold state described above with reference to FIGS. 8A to 8G. Hereinafter, an operation of the electronic device 101 receiving a preset touch input in an unfold state will be described with reference to FIGS. 10, 11A, and/or 11B.

FIG. 10 illustrates an operation of an electronic device based on a touch input on an area of a display (e.g., a flexible display 150) formed on a folding axis (e.g., a first folding axis 131 and/or a second folding axis 132) according to an embodiment of the disclosure.

The electronic device 101 of FIGS. 1A, 1B, and/or 2A and/or 2B may include the electronic device 101 of FIG. 10. The electronic device 101 and/or the processor 210 of FIG. 2A may perform an operation of the electronic device 101 described with reference to FIG. 10. The operation of the electronic device 101 described with reference to FIG. 10 may be related to at least one of the operations of FIGS. 3, 7, and/or 9.

Referring to FIG. 10, a state 1001 of an electronic device 101 corresponding to an unfold state is illustrated. The state 1001 of the electronic device 101 displaying a plurality of screens (e.g., a screen A, a screen B, and a screen C) on the flexible display 150 based on multitasking is illustrated, but an embodiment is not limited thereto. For example, the electronic device 101 may display, on the flexible display 150, a screen provided from one software application and occupying an entire displaying area of the flexible display 150. In the state 1001, the electronic device 101 may display the plurality of screens on each of a first displaying area 1011 on a first housing 111, a second displaying area 1012 on a second housing 112, and a third displaying area 1013 on a third housing 113.

While displaying a screen on the flexible display 150, the electronic device 101 according to an embodiment may detect a touch input based on an external object contacted on a border area (e.g., a first border area 1021 and/or a second border area 1022) between two displaying areas among the first displaying area 1011, the second displaying area 1012, and the third displaying area 1013. For example, in response to a touch input based on an external object moved along a direction in which a border area is extended, the electronic device 101 may store an image corresponding to at least a portion of the screen displayed on the flexible display 150.

In the state 1001 of FIG. 10, the electronic device 101 may detect a touch input based on an external object moved from a location p1 within the first border area 1021 toward a location p2 along a direction of the first folding axis 131. In a case that the external object is separated from the location p2 within the first border area 1021, the electronic device 101 may store an image corresponding to the entire displaying area (e.g., the first displaying area 1011 to the third displaying area 1013) of the flexible display 150. In a case that the external object moved to the location p2 is moved to a location p3 on the first displaying area 1011 different from the first border area 1021 and then separated from the flexible display 150, the electronic device 101 may store an image including the screen A displayed on the first displaying area 1011. In a case that the external object moved to the location p2 is moved to a location p4 on the second displaying area 1012 different from the first border area 1021 and then separated from the flexible display 150, the electronic device 101 may store an image including the screen B displayed on the second displaying area 1012. In a case that the external object moved to the location p2 within the first border area 1021 is moved across the second displaying area 1012 to a location p5 on the third displaying area 1013 and then separated from the flexible display 150, the electronic device 101 may store an image including the screen B and the screen C respectively displayed on the second displaying area 1012 and the third displaying area 1013.

In the state 1001 of FIG. 10, the electronic device 101 may detect an external object moved from a location p6 within the second border area 1022 to a location p7 along a direction of the second folding axis 132. In a case that the external object is separated from the location p7 within the second border area 1022, the electronic device 101 may store an image corresponding to the entire displaying area (e.g., the first displaying area 1011 to the third displaying area 1013) of the flexible display 150. In a case that the external object moved to the location p7 is moved to a location p8 on the third displaying area 1013 different from the second border area 1022 and then separated from the flexible display 150, the electronic device 101 may store an image including the screen C displayed on the third displaying area 1013. In a case that the external object moved to the location p7 is moved to a location p9 on the second displaying area 1012 next to the second border area 1022 and then separated from the flexible display 150, the electronic device 101 may store an image including the screen B corresponding to the second displaying area 1012. In a case that the external object moved to the location p7 within the second border area 1022 is moved across the second displaying area 1012 to a location p10 on the first displaying area 1011 and then separated from the flexible display 150, the electronic device 101 may store an image including the screen A and the screen B respectively displayed on the first displaying area 1011 and the second displaying area 1012.

As described above, without rotation based on a first hinge assembly 121 and/or a second hinge assembly 122 in the unfold state, the electronic device 101 may receive a preset touch input. By setting a portion (e.g., the first border area 1021 and/or the second border area 1022) of the flexible display 150 as an area for receiving the preset touch input, the electronic device 101 may receive the preset touch input without the rotation. An embodiment is not limited to a structure of the electronic device 101 including at least two folding axes (e.g., the first folding axis 131 and/or the second folding axis 132). For example, the electronic device 101 including folding axes more than two or including one folding axis may also receive the preset touch input through a portion of a display adjacent to the folding axis and formed along a direction of the folding axis. Hereinafter, an embodiment of the electronic device 101 including one folding axis will be described with reference to FIGS. 11A and 11B.

FIGS. 11A and 11B illustrate an operation of an electronic device based on a touch input on an area of a display (e.g., a flexible display 150) formed on a folding axis (e.g., a first folding axis 131) according to various embodiments of the disclosure.

Referring to FIGS. 11A and 11B, a third electronic device 101-3 and a fourth electronic device 101-4 including the single first folding axis 131 are illustrated. The third electronic device 101-3 and/or the fourth electronic device 101-4 may correspond to an example of the electronic device 101 described with reference to FIGS. 1A, 1B, and/or 2A and/or 2B. Operations of the third electronic device 101-3 and/or the fourth electronic device 101-4 described with reference to FIGS. 11A and/or 11B may be performed by the processor 210 of FIG. 2A.

Referring to FIG. 11A, an exterior of the third electronic device 101-3, including a flexible display 150 in which a width in an x-axis direction is longer than a height in a y-axis direction and a foldable housing that may be folded by a first folding axis 131 extended along the y-axis direction is illustrated. Referring to FIG. 11B, an exterior of the fourth electronic device 101-4 including a flexible display 150 in which a height in a y-axis direction is longer than a width in an x-axis direction and a foldable housing that may be folded by a first folding axis 131 extended along the x-axis direction is illustrated.

Referring to FIGS. 11A and/or 11B, the foldable housings of the third electronic device 101-3 and/or the fourth electronic device 101-4 may include a first housing 111, a second housing 112, and a first hinge assembly 121 between the first housing 111 and the second housing 112. Referring to FIG. 11A, the flexible display 150 of the third electronic device 101-3 may include a first displaying area 1111 on the first housing 111, a second displaying area 1112 on the second housing 112, and a border area 1113 between the first displaying area 1111 and the second displaying area 1112. In a case that the first housing 111 and/or the second housing 112 are rotated with respect to the first hinge assembly 121, the border area 1113 of the flexible display 150 may be bent (or folded). In a case that the first housing 111 and/or the second housing 112 are rotated, the border area 1113 of the flexible display 150 may be extended or contracted.

Referring to FIG. 11A, a state 1101 of the third electronic device 101-3 corresponding to an unfold state is illustrated. The third electronic device 101-3 may receive a preset touch input for at least a portion of a displaying area of the flexible display 150 through the border area 1113. For example, the preset touch input may include a drag gesture facing from a location p1 within the border area 1113 to a location p2 within the border area 1113 along a direction of the first folding axis 131. The third electronic device 101-3 detecting the drag gesture may store an image corresponding to an entire displaying area of the flexible display 150 in a case that an external object performing the drag gesture is separated from the location p2. The third electronic device 101-3 detecting the drag gesture may store an image corresponding to the first displaying area 1111 (e.g., an image corresponding to a screen A) in a case of receiving an additional drag gesture facing from the location p2 to a location p3 on the first displaying area 1111. The third electronic device 101-3 detecting the drag gesture may store an image corresponding to the second displaying area 1112 (e.g., an image corresponding to a screen B) in a case of detecting an additional drag gesture facing from the location p2 to a location p4 on the second displaying area 1112.

In an embodiment of FIG. 11A, the third electronic device 101-3 may receive the preset touch input based on whether a first angle 141 is included within a preset angle range for receiving the preset touch input. For example, in a case that the first angle 141 is included in one of the angle ranges 512 and 513 of FIG. 5, the third electronic device 101-3 may receive the preset touch input through the border area 1113. An embodiment is not limited thereto, and the third electronic device 101-3 may detect the preset touch input through the border area 1113 independently of the first angle 141.

Referring to FIG. 11B, a state 1102 of the fourth electronic device 101-4 corresponding to an unfold state is illustrated. The flexible display 150 of the fourth electronic device 101-4 may include a first displaying area 1121 on a first housing 111, a second displaying area 1122 on a second housing 112, and a border area 1123 between the first displaying area 1121 and the second displaying area 1122. In a case that the first housing 111 and/or the second housing 112 of the fourth electronic device 101-4 are rotated, the border area 1123 of the flexible display 150 may be folded.

Referring to FIG. 11B, the fourth electronic device 101-4 may obtain or store an image corresponding to at least a portion of a displaying area of the flexible display 150 based on a preset touch input initiated within the border area 1123. For example, within the border area, based on a drag gesture performed along a direction of the first folding axis 131, the fourth electronic device 101-4 may store an image corresponding to an entire displaying area of the flexible display 150. In a case that an external object moved within the border area 1123 along the direction of the first folding axis 131 is dragged to the first displaying area 1121, the fourth electronic device 101-4 may store an image corresponding to the first displaying area 1121 (e.g., an image corresponding to a screen A). In a case that an external object moved within the border area 1123 along the direction of the first folding axis 131 is dragged to the second displaying area 1122, the fourth electronic device 101-4 may store an image corresponding to the second displaying area 1122 (e.g., an image corresponding to a screen B).

In an embodiment of FIG. 11B, the fourth electronic device 101-4 may receive the preset touch input based on a first angle 141 between the first housing 111 and the second housing 112. For example, while the first angle 141 is included within an angle range (e.g., the angle ranges 512 and 513 of FIG. 5) corresponding to a sub-fold state, the fourth electronic device 101-4 may receive the preset touch input. An embodiment is not limited thereto, and in the state 1102 corresponding to the unfold state, the fourth electronic device 101-4 may receive the preset touch input without rotation of the first housing 111 and/or the second housing 112 based on a first hinge assembly 121.

Hereinafter, an operation of the electronic device 101 receiving a preset touch input related to a shape of a multi-foldable housing will be described with reference to FIGS. 12A and/or 12B.

FIGS. 12A and 12B illustrate an operation of an electronic device storing an image corresponding to at least one of screens respectively displayed on a plurality of displays (e.g., a flexible display 150 and/or a cover display 152) according to various embodiments of the disclosure.

The electronic device 101 of FIGS. 1A, 1B, and/or 2A and/or 2B may include the electronic device 101 of FIGS. 12A and/or 12B. The electronic device 101 and/or the processor 210 of FIGS. 2A and/or 2B may perform an operation of the electronic device 101, described with reference to FIGS. 12A and/or 12B. The operation of the electronic device 101 described with reference to FIGS. 12A and/or 12B may be related to at least one of the operations of FIGS. 3, 7, and/or 9.

Referring to FIGS. 12A and 12B, states 1201 and 1202 of an electronic device 101 included in a sub-fold state are illustrated. In the states 1201 and 1202, an edge of a third housing 113 may be contacted on a first displaying area of the flexible display 150 positioned on a first housing 111. For example, the edge of the third housing 113 may be contacted on the first displaying area by rotation of the first housing 111 to the third housing 113. In a case that the edge of the third housing 113 is contacted on the first displaying area, the first displaying area may be distinguished into two portions by the edge of the third housing 113. For example, the first displaying area may include a first portion occluded by a second housing 112 and/or the third housing 113 and a second portion different from the first portion. Such as the states 1201 and 1202, the sub-fold state of the electronic device 101 in which the first displaying area is partially occluded by the edge of the third housing 113 may be referred to as a prism state (or a prism slide state).

According to an embodiment, the electronic device 101 may identify the prism state, such as the states 1201 and 1202 of FIGS. 12A and/or 12B, using one or more sensors (e.g., the sensor 250 of FIG. 2A). In the prism state, the electronic device 101 may display one or more screens on the cover display 152 positioned on the third housing 113 and the second portion of the flexible display 150 not occluded by the third housing 113. Referring to FIG. 12A, the state 1201 of the electronic device 101 displaying a screen A on the cover display 152 and a screen C on the second portion is illustrated. The screen A and/or the screen C may be provided from one or more software applications executed by the electronic device 101.

According to an embodiment, the electronic device 101 may detect a preset touch input based on an external object contacted on a portion of the first displaying area where the edge of the third housing 113 is contacted. In the state 1201 of FIG. 12A, a border area 1211 corresponding to the portion on the first displaying area where the edge of the third housing 113 is contacted is illustrated. The border area 1211 may be formed along a direction parallel to the edge of the third housing 113. The border area 1211 may be formed between the first portion of the first displaying area occluded by the third housing 113 and the second portion.

Referring to FIG. 12A, the preset touch input for capturing a screen (e.g., the screen A and/or the screen C) displayed on the flexible display 150 and/or the cover display 152 may include a drag gesture based on an external object moved along a direction of a border area within the border area formed on the flexible display 150 and/or the cover display 152. For example, the electronic device 101 may receive the drag gesture through the border area 1211 formed on the first displaying area and/or a border area 1212 including an edge adjacent to the first displaying area on the cover display 152. Referring to FIG. 12A, based on an external object moved from a location p1 within the border area 1211 formed on the first displaying area to a location p2 within the border area 1211 along a direction of the border area 1211, the electronic device 101 may store an image including at least one of the screen A and the screen C. The electronic device 101 may select at least one of the screen A and the screen C based on release of an external object performing the drag gesture and/or a position at which the external object is released.

In the state 1201 of FIG. 12A, the electronic device 101 detecting an external object separated from the location p2 within the border area 1211 may generate an image 1215 including all of the screen A and the screen C. The electronic device 101 detecting an external object moved from the location p2 to a location p3 on the first displaying area of the flexible display 150 may store an image 1216 corresponding to the screen C among the screen A and the screen C. The electronic device 101 identifying an external object moved from the location p2 to a location p4 on the cover display 152 may store an image 1217 corresponding to the screen A displayed on the cover display 152 in response to an external object moved from the location p4 to a location p5 on the cover display 152. Similar to the operation of the electronic device 101 described with reference to FIGS. 6B, 8D, and/or 8E, the electronic device 101 may determine whether to perform screen capture based on the external object moved from the location p4 to the location p5 based on a distance between the locations p2 and p4 and/or a time difference between a first timing when the external object is separated from the location p2 and a second timing when the external object is contacted on the location p4.

Referring to FIG. 12B, the state 1202 of displaying screens on the cover display 152 and the second portion of the first displaying area using a software application for playing a video is illustrated. In the state 1202, the electronic device 101 may display a first screen for playing a video on the cover display 152, and may display a second screen including one or more visual objects (e.g., a playback button, a fast-forward button, and/or a rewind button) for controlling playback of the video on the second portion of the first displaying area.

Referring to FIG. 12B, an electronic device 101 may receive a preset touch input through a border area 1221 of the first displaying area adjacent to the edge of the third housing 113 contacted on the first displaying area and a border area 1222 formed in the cover display 152 positioned on the third housing 113. For example, the preset touch input may include a drag gesture based on an external object moved from a location p1 within the border area 1222 to a location p2 within the border area 1222 along a direction in which the border area 1222 is extended. In response to release of the external object at the location p2, the electronic device 101 may store an image 1225 corresponding to the cover display 152 and the entire second portion of the first displaying area.

The preset touch input received in the state 1202 of FIG. 12B may include a drag gesture for selecting one of the cover display 152 or the second portion of the first displaying area. For example, in a case that an external object contacted on the location p2 within the border area 1222 is dragged to a location p3 on the cover display 152 distinct from the border area 1222, the electronic device 101 may obtain or store an image 1226 corresponding to the first screen displayed on the cover display 152. For example, the electronic device 101 may obtain the image 1226 in response to release of the external object dragged to the location p3. For example, in a case that the external object contacted on the location p2 is moved to a location p4 on the first displaying area within a preset period and then dragged from the location p4 to a location p5 exceeding a preset distance, the electronic device 101 may generate or store an image 1227 corresponding to the second screen displayed on the second portion of the first displaying area. The electronic device 101 may obtain the image 1227 in response to release of the external object dragged to the location p5.

As described above, the electronic device 101 including a multi-foldable housing may operate in the prism state that activates both the cover display 152 and the flexible display 150. In the prism state including the states 1201 and 1202 illustrated in FIGS. 12A and/or 12B, the electronic device 101 may receive the preset touch input through the border areas 1211, 1212, 1221, and 1222 formed on each of the flexible display 150 and the cover display 152. Based on the preset touch input, the electronic device 101 may perform screen capture on at least one of the flexible display 150 and/or the cover display 152. In an embodiment including a button on a side surface of the multi-foldable housing (e.g., a side surface of the third housing 113 contacted on the first displaying area in the states 1201 and 1202 of FIGS. 12A and/or 12B), receiving an input for screen capture through the button may be limited. According to an embodiment, the electronic device 101 may perform screen capture based on the preset touch input described with reference to FIGS. 12A and/or 12B, independently of the button.

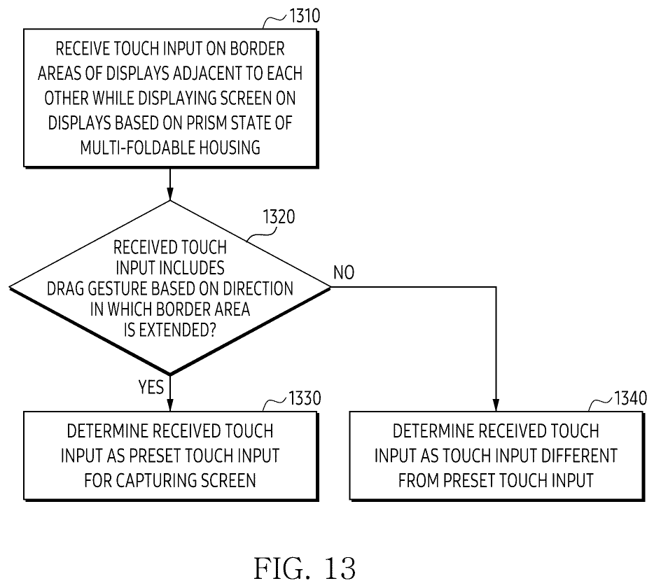

Hereinafter, a flowchart corresponding to the operation of the electronic device 101 described with reference to FIGS. 12A and/or 12B will be described with reference to FIG. 13.

FIG. 13 illustrates a flowchart of an electronic device according to an embodiment of the disclosure.

The electronic device 101 of FIGS. 1A, 1B, and/or 2A and/or 2B, and the processor 210 (e.g., the LPU 212 and/or the DPU 214) of FIG. 2A may perform at least one of operations described with reference to FIG. 13. At least one of the operations of FIG. 13 may be related to the operation (e.g., the operation 330) described with reference to FIGS. 3, 7, and/or 9.

Referring to FIG. 13, in operation 1310, a processor of the electronic device according to an embodiment may receive a touch input on border areas of displays adjacent to each other while displaying a screen on the displays based on a prism state of a multi-foldable housing. The prism state of the operation 1310 may include the states 1201 and 1202 described with reference to FIGS. 12A and 12B. The border areas of the operation 1310 may include the border areas 1211 and 1212 of FIG. 12A and/or the border areas 1221 and 1222 of FIG. 12B. The processor receiving or detecting the touch input on the border areas may perform operation 1320.

Referring to FIG. 13, in operation 1320, the processor of the electronic device according to an embodiment may determine or identify whether the received touch input includes a drag gesture based on a direction in which a border area is extended. In a case that a drag gesture performed along a direction parallel to or similar to a direction in which the border area is extended is identified (1320—YES), the processor may perform operation 1330. In a case that a drag gesture along a direction different from a direction in which the border area is extended is identified (1320—NO), the processor may perform operation 1340. The drag gesture described with reference to FIGS. 12A and 12B may correspond to the drag gesture of the operation 1320.

Referring to FIG. 13, in operation 1330, the processor of the electronic device according to an embodiment may determine the received touch input as a preset touch input for capturing a screen. The processor may perform the operation 1330 of FIG. 13 similar to the operation 730 of FIG. 7. For example, the processor may execute a first function for screen capture based on the operation 1330. The processor executing the first function for screen capture may obtain images corresponding to each of screens provided to a flexible display and a cover display using a DPU (e.g., the DPU 214 of FIGS. 2A and/or 2B). An operation in which the processor obtains the images may include an operation of storing the images in volatile memory (e.g., the volatile memory 222 of FIGS. 2A and/or 2B). The processor may generate an image corresponding to the touch input by coupling or selecting the images stored in the volatile memory. The generated image may be stored in non-volatile memory (e.g., the non-volatile memory 224 of FIGS. 2A and/or 2B).

Referring to FIG. 13, in operation 1340, the processor of the electronic device according to an embodiment may determine the received touch input as a touch input different from the preset touch input. The processor may perform the operation 1340 of FIG. 13 similar to the operation 740 of FIG. 7. For example, the processor may execute a second function different from the first function for screen capture based on the operation 1340. For example, the processor may not execute any function different from the first function.

An embodiment of the electronic device receiving the preset touch input including the drag gesture performed along a direction on an area on a display extended in the direction of a straight line (e.g., a folding axis and/or an edge on the display) has been described, but an embodiment is not limited thereto. Hereinafter, an embodiment of an electronic device receiving the preset touch input based on a gesture different from the drag gesture described above will be described with reference to FIGS. 14A to 14D.

FIGS. 14A, 14B, 14C, and 14D illustrate states of an electronic device receiving a preset touch input for capturing a screen according to various embodiments of the disclosure.

The electronic device 101 of FIGS. 1A, 1B, and/or 2A and/or 2B may include the electronic device 101 of FIGS. 14A and 14B. The electronic device 101 and/or the processor 210 of FIGS. 2A and/or 2B may perform an operation of the electronic device 101 described with reference to FIGS. 14A and/or 14B. The operation of the electronic device 101 described with reference to FIGS. 14A and/or 14B may be related to at least one of the operations of FIGS. 3, 7, 9, and/or 13.

Referring to FIGS. 14A and 14B, states 1401 and 1402 of an electronic device 101 included in a sub-fold state are illustrated. In the state 1401, the electronic device 101 may detect or identify a posture and/or a shape of a first housing 111 to a third housing 113 folded less than 180° based on sensor data of one or more sensors (e.g., the sensor 250 of FIG. 2A). Based on the sensor data, the electronic device 101 may calculate or obtain a first angle 141 and a second angle 142 included within the angle ranges 512 and 522 of FIG. 5.

Referring to FIG. 14A, the state 1401 of the electronic device 101 displaying a plurality of screens (e.g., a screen A, a screen B, and a screen C) on three flat portions of a flexible display 150 distinguished by a first folding axis 131 and a second folding axis 132 is illustrated. For example, the screen A may be displayed on a first displaying area of the flexible display 150 positioned on the first housing 111, the screen B may be displayed on a second displaying area of the flexible display 150 positioned on a second housing 112, and the screen C may be displayed on a third displaying area of the flexible display 150 positioned on the third housing 113. Although an embodiment of the electronic device 101 displaying the plurality of screens has been described, an embodiment is not limited thereto, and the electronic device 101 displaying a single screen on an entire displaying area of the flexible display 150 may also perform an operation described with reference to FIG. 14A.

In the state 1401 of FIG. 14A, the electronic device 101 may detect or identify a preset touch input based on an external object (e.g., a hand 1400) contacted on the flexible display 150 and for capturing at least a portion of a display (e.g., the flexible display 150) of the electronic device 101. For example, the preset touch input may include a gesture of sweeping (or swiping) (hereinafter, a sweep gesture and/or a hand blade gesture) on a display using a hand blade of the hand 1400 (or a side surface of the hand 1400).

Referring to FIG. 14A, while the hand blade of the hand 1400 is contacted on the flexible display 150, the electronic device 101 may obtain information related to a contact area 1411 of the hand 1400 contacted on the flexible display 150 using a touch panel (e.g., the first touch panel 234 of FIG. 2A). The information may include numeric values for describing a plurality of points included in the contact area 1411. The numeric values may include coordinate values, an identifier (id), an index, and/or a key value. In a case that a plurality of points exceeding a preset number (e.g., 4) are simultaneously detected based on sensor data of the touch panel, the electronic device 101 may obtain information including coordinate values of the plurality of points, and may detect a contact of the hand blade based on the contact area 1411. The information may include numeric values for describing a size, extent, a shape, and/or an outline of the contact area 1411. The information may include a numeric value indicating a pressure (or force) of the hand 1400 pressing the contact area 1411. Based on the information, the electronic device 101 may determine that the hand blade of the hand 1400 is in contact with the contact area 1411, based on detecting the contact area 1411 having a preset shape, exceeding preset threshold extent, or included within a preset extent range (e.g., an empirical extent range for the hand blade).

In the state 1401 of FIG. 14A, the electronic device 101 may obtain or store an image corresponding to at least one of displaying areas (e.g., the first displaying area to the third displaying area) of the flexible display 150 distinguished by the first folding axis 131 and the second folding axis 132, based on a path through which an external object contacted according to a preset shape (e.g., a shape of the hand blade) is moved on the flexible display 150. For example, the electronic device 101 may obtain or store an image corresponding to at least one displaying area including the path among the first displaying area, the second displaying area, and the third displaying area.

Referring to FIG. 14A, in the state 1401 of detecting the contact area 1411 based on the hand 1400 contacted on the first displaying area, the electronic device 101 may detect the contact area 1411 moved from the first displaying area, across the second displaying area, to a location p1 within the third displaying area along a preset direction (e.g., a horizontal direction of the flexible display 150. The electronic device 101 detecting the contact area 1411 moved from the first displaying area, across the second displaying area, to the location p1 within the third displaying area may store an image 1415 corresponding to all of displaying areas (e.g., the first displaying area, the second displaying area, and the third displaying area) overlapping a path of the contact area 1411. The image 1415 may match an image, which is uploaded to the volatile memory 222 based on the DPU 214 of FIGS. 2A and/or 2B, of an entire displaying area of the flexible display 150.

For example, in a case that the contact area 1411 moved from the first displaying area to a location p2 within the second displaying area along the preset direction is detected, the electronic device 101 may obtain or store an image 1416 corresponding to the first displaying area and the second displaying area among the displaying areas of the flexible display 150. The image 1416 may be obtained by cropping the image, which is uploaded to the volatile memory 222 based on the DPU 214 of FIGS. 2A and/or 2B, of the entire displaying area of the flexible display 150 based on widths, heights, and/or sizes of the first displaying area and the second displaying area.

For example, in a case that the contact area 1411 initially detected within the first displaying area and moved along the preset direction to a location p3 within the first displaying area is detected, the electronic device 101 may obtain an image 1417 corresponding to the first displaying area. The image 1417 may include only the screen A corresponding to the first displaying area. As described above, in a case that a path in which the contact area 1411 initially detected within the first displaying area is moved is substantially the same as or similar to the preset direction, the electronic device 101 may generate an image including the first displaying area and including at least one displaying area overlapping the path. An embodiment is not limited thereto, and the electronic device 101 detecting the hand blade contacted on another displaying area different from the first displaying area may also perform screen capture according to a path of a contact area of the hand blade.

Although an operation of the electronic device 101 based on the hand blade moved along the horizontal direction has been described, an embodiment is not limited thereto. For example, the electronic device 101 may detect or identify the preset touch input for screen capture based on the hand blade moved along a direction (e.g., a vertical direction) different from the horizontal direction.

Referring to FIG. 14B, the state 1402 of an electronic device 101 based on the vertically folded first folding axis 131 and the outspread second folding axis 132 is illustrated. In the state 1402, by using one or more sensors (e.g., the sensor 250 of FIG. 2A), the electronic device 101 may detect the first angle 141 that is substantially 90° and may detect the second angle 142 that is substantially 180°. In the state 1402 of FIG. 14B, the flexible display 150 may display screens provided from different software applications on two flat portions (e.g., a first portion 1421 and a second portion 1422). For example, the electronic device 101 may display a first screen provided by a first software application for video playback on the first portion 1421 corresponding to a first displaying area on a first housing 111, and may display a second screen provided from a second software application for memo on the second portion 1422 including a second displaying area on a second housing 112 and a third displaying area on a third housing 113.

In the state 1402 of FIG. 14B, the electronic device 101 may receive or identify a preset touch input based on the hand 1400 contacted based on a preset shape. The preset touch input may include a sweep gesture based on the hand blade of the hand 1400. For example, in response to a sweep gesture initiated in a contact area 1423 and moved to a location p1 on the first portion 1421, the electronic device 101 may obtain or store an image 1425 for the first screen displayed on the first portion 1421. For example, in response to a sweep gesture initiated in a contact area 1424 on the second portion 1422 and moved to a location p2 on the second portion 1422 along a preset direction (e.g., a direction of a y-axis), the electronic device 101 may generate an image 1426 for the second screen displayed on the second portion 1422. Although an embodiment of the electronic device 101 receiving a touch input based on the sweep gesture performed along a direction of the y-axis direction on different portions of the flexible display 150 is described, a direction of the sweep gesture received for screen capture is not limited to a direction of the y-axis of FIG. 14B.

Referring to FIG. 14C, a state 1403 of a first electronic device 101-1 corresponding to a half-fold state is illustrated. In the state 1403, the first electronic device 101-1 may activate a viewable displaying area (e.g., a third displaying area of the flexible display 150 positioned on a third housing 113), and display a screen A on the activated displaying area. In the state 1403, the first electronic device 101-1 may detect or receive a sweep gesture performed on a displaying area of the flexible display 150 exposed to the outside. For example, the first electronic device 101-1 detecting a contact area 1431 of the hand 1400 may detect the sweep gesture based on a path of the contact area 1431. Referring to FIG. 14C, the first electronic device 101-1 detecting the contact area 1431 moved along a direction parallel to a horizontal direction may obtain an image 1435 for the screen A displayed on the displaying area. For example, a width, a height, a size, and/or extent of the image 1435 may correspond to a width, a height, a size, and/or extent of the displaying area of the flexible display 150 on which the screen A is displayed.

Referring to FIG. 14D, a state 1404 of the first electronic device 101-1 corresponding to an inverted half-fold state is illustrated. In the state 1404, the first electronic device 101-1 may display one or more screens (e.g., a screen B and/or a screen C) by using both a first displaying area of the flexible display 150 positioned on a first housing 111 and the cover display 152. In the state 1404 of FIG. 14D, the first electronic device 101-1 may perform screen capture on at least one of the one or more screens displayed through the flexible display 150 and the cover display 152 in response to a preset touch input including a sweep gesture.

For example, the first electronic device 101-1 detecting a contact area 1441 based on an external object (e.g., the hand 1400) on the first displaying area where the screen B is displayed may detect or receive the preset touch input including the sweep gesture in response to movement of the contact area 1441 along a preset direction (e.g., a horizontal direction of the flexible display 150). For example, the first electronic device 101-1 detecting a sweep gesture ceased at a location p1 within the first displaying area may store an image 1445 corresponding to the screen B displayed through the first displaying area of the flexible display 150 among the flexible display 150 and the cover display 152.

For example, in a case that the contact area 1441 detected in the first displaying area is moved across the first displaying area to a location p4 within the cover display 152 along the preset direction, the first electronic device 101-1 may generate an image 1446 including all of the screen B and the screen C respectively displayed on the flexible display 150 and the cover display 152. Referring to FIG. 14D, in the image 1446, the screen B and the screen C may have a positional relationship corresponding to a positional relationship between the first displaying area and the cover display 152. According to an embodiment, the first electronic device 101-1 may synthesize the image 1446 including the screen B and the screen C connected to an edge of the screen B (a right edge of the screen B in an embodiment of FIG. 14D) based on whether an external object contacted on the first displaying area is moved on the cover display 152.

Referring to FIG. 14D, while an external object contacted through the contact area 1441 is moved from the first displaying area to the location p4 within the cover display 152, a processor (e.g., the processor 210 of FIG. 2A) of the first electronic device 101-1 may detect sweep gestures from different touch panels (e.g., a first touch panel of the flexible display 150 and a second touch panel of the cover display 152). For example, while an external object is contacted on the first displaying area, the first electronic device 101-1 may detect a first sweep gesture of the external object based on the first touch panel of the flexible display 150. In the example, in a case that an external object in contact with a location p2 in the first displaying area is moved to a location p3 within the cover display 152 by being separated from the location p2, the first electronic device 101-1 may determine a second sweep gesture detected on the cover display 152 and the first sweep gesture as one sweep gesture, based on a distance between the locations p2 and p3 and/or a time difference between timings when an external object is identified in each of the locations p2 and p3. For example, the first electronic device 101-1 detecting the first sweep gesture and the second sweep gesture detected based on an external object moved from the location p3 to the location p4 may determine that the preset touch input for generating the image 1446 corresponding to all of the screens displayed through the flexible display 150 and the cover display 152 is received.

As described above, according to an embodiment, the electronic device 101 may display a plurality of screens using all of a plurality of displays (e.g., the flexible display 150 and the cover display 152) based on a multi-foldable housing. The electronic device 101 may generate or store an image corresponding to at least one of the plurality of screens based on a sweep gesture detected through at least one of the plurality of displays. Based on the sweep gesture, the electronic device 101 including the flexible display 150 having a relatively wide size may improve a user experience related to screen capture.

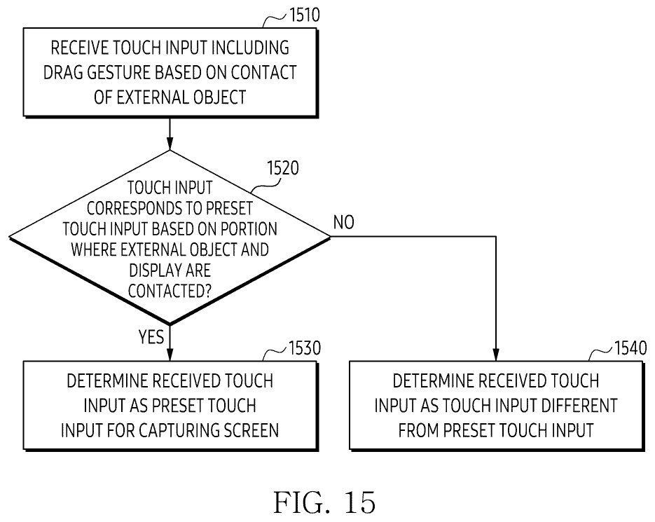

Hereinafter, with reference to FIG. 15, an operation of the electronic device 101 described with reference to FIGS. 14A to 14D will be described based on a flowchart.

FIG. 15 illustrates a flowchart of an electronic device according to an embodiment of the disclosure.

The electronic device 101 of FIGS. 1A, 1B, and/or 2A and/or 2B and the processor 210 (e.g., the LPU 212 and/or the DPU 214) of FIG. 2A may perform at least one of operations described with reference to FIG. 15. At least one of the operations of FIG. 15 may be related to the operation (e.g., the operation 330) described with reference to FIGS. 3, 7, 9, and/or 13.

Referring to FIG. 15, in operation 1510, a processor of the electronic device according to an embodiment may receive a touch input including a drag gesture based on a contact of an external object. The operation 1510 may be performed while displaying one or more screens on one or more displays (e.g., the flexible display 150 and/or the cover display 152 of FIGS. 1A and 1B and the first display 230 and/or the second display 240 of FIGS. 2A and/or 2B) included in the electronic device. The processor may perform the operation 1510 of FIG. 15 similar to the operation 320 of FIG. 3 and/or the operation 710 of FIG. 7. The drag gesture of the operation 1510 may be detected or identified based on sensor data of a touch panel included in a display.

Referring to FIG. 15, in operation 1520, the processor of the electronic device according to an embodiment may determine whether the touch input corresponds to a preset touch input based on a portion where an external object and a display are contacted. The portion of the operation 1520 where the external object and the display are contacted may include a portion of the display contacted based on a hand blade, such as the contact areas 1411, 1423, 1424, 1431, and 1441 of FIGS. 14A to 14D. Based on detecting the portion having a preset shape or having a size exceeding a preset size, the processor may detect the preset touch input of the operation 1520 based on a direction and/or a path in which the portion is moved. Based on detecting the preset touch input (1520—YES), the processor may perform operation 1530. In a case that a touch input different from the preset touch input is detected (1520—NO), the processor may perform operation 1540. In an embodiment, the preset touch input of the operation 1520 may include the sweep gesture described with reference to FIGS. 14A to 14D.

Referring to FIG. 15, in operation 1530, the processor of the electronic device according to an embodiment may determine the received touch input as the preset touch input for capturing a screen. The processor may perform the operation 1530 similar to the operation 730 of FIG. 7 and/or the operation 1330 of FIG. 13. The processor detecting and/or receiving the preset touch input based on the operation 1530 may perform screen capture on one or more displays corresponding to the path and/or the direction of the portion of the operation 1520 by executing a first function for capturing a screen.

Referring to FIG. 15, in operation 1540, the processor of the electronic device according to an embodiment may determine the received touch input as a touch input different from the preset touch input. The processor may perform the operation 1540 similar to the operation 740 of FIG. 7 and/or the operation 1340 of FIG. 13. For example, the processor may execute a second function different from the first function. For example, in a case that the processor may not identify any function mapped to the touch input, it may not execute any function.

As described above, according to an embodiment, the electronic device may receive a touch input for screen capture based on a shape of a foldable housing and/or display. The touch input may include a drag gesture performed on a foldable portion of a flexible display. The touch input may include a drag gesture performed on an area formed at a specified edge of the flexible display exposed to the outside. The touch input may include a drag gesture performed on an area formed at an edge of a cover display positioned on a housing rotated to occlude the flexible display. The touch input may further include an additional drag gesture continuously performed after the above-described drag gesture.

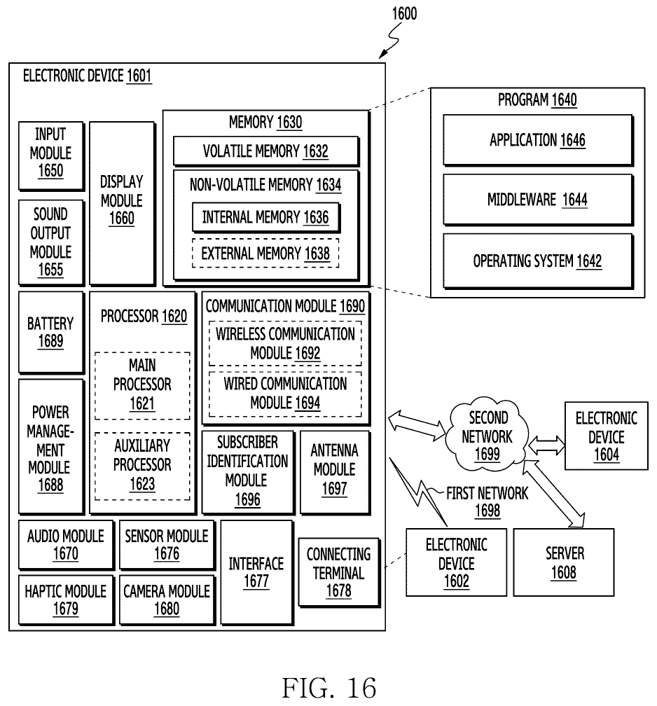

FIG. 16 is a block diagram illustrating an electronic device in a network environment according to an embodiment of the disclosure.

Referring to FIG. 16, an electronic device 1601 in a network environment 1600 may communicate with an electronic device 1602 via a first network 1698 (e.g., a short-range wireless communication network), or at least one of an electronic device 1604 or a server 1608 via a second network 1699 (e.g., a long-range wireless communication network). According to an embodiment, the electronic device 1601 may communicate with the electronic device 1604 via the server 1608. According to an embodiment, the electronic device 1601 may include a processor 1620, memory 1630, an input module 1650, a sound output module 1655, a display module 1660, an audio module 1670, a sensor module 1676, an interface 1677, a connecting terminal 1678, a haptic module 1679, a camera module 1680, a power management module 1688, a battery 1689, a communication module 1690, a subscriber identification module (SIM) 1696, or an antenna module 1697. In some embodiments, at least one of the components (e.g., the connecting terminal 1678) may be omitted from the electronic device 1601, or one or more other components may be added in the electronic device 1601. In some embodiments, some of the components (e.g., the sensor module 1676, the camera module 1680, or the antenna module 1697) may be implemented as a single component (e.g., the display module 1660).

The processor 1620 may execute, for example, software (e.g., a program 1640) to control at least one other component (e.g., a hardware or software component) of the electronic device 1601 coupled with the processor 1620, and may perform various data processing or computation. According to an embodiment, as at least part of the data processing or computation, the processor 1620 may store a command or data received from another component (e.g., the sensor module 1676 or the communication module 1690) in volatile memory 1632, process the command or the data stored in the volatile memory 1632, and store resulting data in non-volatile memory 1634. According to an embodiment, the processor 1620 may include a main processor 1621 (e.g., a central processing unit (CPU) or an application processor (AP)), or an auxiliary processor 1623 (e.g., a graphics processing unit (GPU), a neural processing unit (NPU), an image signal processor (ISP), a sensor hub processor, or a communication processor (CP)) that is operable independently from, or in conjunction with, the main processor 1621. For example, when the electronic device 1601 includes the main processor 1621 and the auxiliary processor 1623, the auxiliary processor 1623 may be adapted to consume less power than the main processor 1621, or to be specific to a specified function. The auxiliary processor 1623 may be implemented as separate from, or as part of the main processor 1621.

The auxiliary processor 1623 may control at least some of functions or states related to at least one component (e.g., the display module 1660, the sensor module 1676, or the communication module 1690) among the components of the electronic device 1601, instead of the main processor 1621 while the main processor 1621 is in an inactive (e.g., sleep) state, or together with the main processor 1621 while the main processor 1621 is in an active state (e.g., executing an application). According to an embodiment, the auxiliary processor 1623 (e.g., an image signal processor or a communication processor) may be implemented as part of another component (e.g., the camera module 1680 or the communication module 1690) functionally related to the auxiliary processor 1623. According to an embodiment, the auxiliary processor 1623 (e.g., the neural processing unit) may include a hardware structure specified for artificial intelligence model processing. An artificial intelligence model may be generated by machine learning. Such learning may be performed, e.g., by the electronic device 1601 where the artificial intelligence is performed or via a separate server (e.g., the server 1608). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1630 may store various data used by at least one component (e.g., the processor 1620 or the sensor module 1676) of the electronic device 1601. The various data may include, for example, software (e.g., the program 1640) and input data or output data for a command related thereto. The memory 1630 may include the volatile memory 1632 or the non-volatile memory 1634.

The program 1640 may be stored in the memory 1630 as software, and may include, for example, an operating system (OS) 1642, middleware 1644, or an application 1646.

The input module 1650 may receive a command or data to be used by another component (e.g., the processor 1620) of the electronic device 1601, from the outside (e.g., a user) of the electronic device 1601. The input module 1650 may include, for example, a microphone, a mouse, a keyboard, a key (e.g., a button), or a digital pen (e.g., a stylus pen).

The sound output module 1655 may output sound signals to the outside of the electronic device 1601. The sound output module 1655 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1660 may visually provide information to the outside (e.g., a user) of the electronic device 1601. The display module 1660 may include, for example, a display, a hologram device, or a projector and control circuitry to control a corresponding one of the display, hologram device, and projector. According to an embodiment, the display module 1660 may include a touch sensor adapted to detect a touch, or a pressure sensor adapted to measure the intensity of force incurred by the touch.

The audio module 1670 may convert a sound into an electrical signal and vice versa. According to an embodiment, the audio module 1670 may obtain the sound via the input module 1650, or output the sound via the sound output module 1655 or a headphone of an external electronic device (e.g., the electronic device 1602) directly (e.g., wiredly) or wirelessly coupled with the electronic device 1601.

The sensor module 1676 may detect an operational state (e.g., power or temperature) of the electronic device 1601 or an environmental state (e.g., a state of a user) external to the electronic device 1601, and then generate an electrical signal or data value corresponding to the detected state. According to an embodiment, the sensor module 1676 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1677 may support one or more specified protocols to be used for the electronic device 1601 to be coupled with the external electronic device (e.g., the electronic device 1602) directly (e.g., wiredly) or wirelessly. According to an embodiment, the interface 1677 may include, for example, a high definition multimedia interface (HDMI), a universal serial bus (USB) interface, a secure digital (SD) card interface, or an audio interface.

The connecting terminal 1678 may include a connector via which the electronic device 1601 may be physically connected with the external electronic device (e.g., the electronic device 1602). According to an embodiment, the connecting terminal 1678 may include, for example, an HDMI connector, a USB connector, an SD card connector, or an audio connector (e.g., a headphone connector).

The haptic module 1679 may convert an electrical signal into a mechanical stimulus (e.g., a vibration or a movement) or electrical stimulus which may be recognized by a user via his tactile sensation or kinesthetic sensation. According to an embodiment, the haptic module 1679 may include, for example, a motor, a piezoelectric element, or an electric stimulator.

The camera module 1680 may capture a still image or moving images. According to an embodiment, the camera module 1680 may include one or more lenses, image sensors, image signal processors, or flashes.

The power management module 1688 may manage power supplied to the electronic device 1601. According to an embodiment, the power management module 1688 may be implemented as at least part of, for example, a power management integrated circuit (PMIC).

The battery 1689 may supply power to at least one component of the electronic device 1601. According to an embodiment, the battery 1689 may include, for example, a primary cell which is not rechargeable, a secondary cell which is rechargeable, or a fuel cell.

The communication module 1690 may support establishing a direct (e.g., wired) communication channel or a wireless communication channel between the electronic device 1601 and the external electronic device (e.g., the electronic device 1602, the electronic device 1604, or the server 1608) and performing communication via the established communication channel. The communication module 1690 may include one or more communication processors that are operable independently from the processor 1620 (e.g., the application processor (AP)) and supports a direct (e.g., wired) communication or a wireless communication. According to an embodiment, the communication module 1690 may include a wireless communication module 1692 (e.g., a cellular communication module, a short-range wireless communication module, or a global navigation satellite system (GNSS) communication module) or a wired communication module 1694 (e.g., a local area network (LAN) communication module or a power line communication (PLC) module). A corresponding one of these communication modules may communicate with the external electronic device via the first network 1698 (e.g., a short-range communication network, such as Bluetooth™, wireless-fidelity (Wi-Fi) direct, or infrared data association (IrDA)) or the second network 1699 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1692 may identify and authenticate the electronic device 1601 in a communication network, such as the first network 1698 or the second network 1699, using subscriber information (e.g., international mobile subscriber identity (IMSI)) stored in the subscriber identification module 1696.

The wireless communication module 1692 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1692 may support a high-frequency band (e.g., the millimeter wave (mmWave) band) to achieve, e.g., a high data transmission rate. The wireless communication module 1692 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1692 may support various requirements specified in the electronic device 1601, an external electronic device (e.g., the electronic device 1604), or a network system (e.g., the second network 1699). According to an embodiment, the wireless communication module 1692 may support a peak data rate (e.g., 20 Gbps or more) for implementing eMBB, loss coverage (e.g., 1664 dB or less) for implementing mMTC, or user plane (U-plane) latency (e.g., 0.5 ms or less for each of downlink (DL) and uplink (UL), or a round trip of 16 ms or less) for implementing URLLC.

The antenna module 1697 may transmit or receive a signal or power to or from the outside (e.g., the external electronic device) of the electronic device 1601. According to an embodiment, the antenna module 1697 may include an antenna including a radiating element composed of a conductive material or a conductive pattern formed in or on a substrate (e.g., a printed circuit board (PCB)). According to an embodiment, the antenna module 1697 may include a plurality of antennas (e.g., array antennas). In such a case, at least one antenna appropriate for a communication scheme used in the communication network, such as the first network 1698 or the second network 1699, may be selected, for example, by the communication module 1690 (e.g., the wireless communication module 1692) from the plurality of antennas. The signal or the power may then be transmitted or received between the communication module 1690 and the external electronic device via the selected at least one antenna. According to an embodiment, another component (e.g., a radio frequency integrated circuit (RFIC)) other than the radiating element may be additionally formed as part of the antenna module 1697.

According to various embodiments, the antenna module 1697 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1601 and the external electronic device 1604 via the server 1608 coupled with the second network 1699. Each of the electronic devices 1602 or 1604 may be a device of a same type as, or a different type, from the electronic device 1601. According to an embodiment, all or some of operations to be executed at the electronic device 1601 may be executed at one or more of the external electronic devices (e.g., the electronic devices 1602 and 1604 and the server 1608). For example, if the electronic device 1601 should perform a function or a service automatically, or in response to a request from a user or another device, the electronic device 1601, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1601. The electronic device 1601 may provide the outcome, with or without further processing of the outcome, as at least part of a reply to the request. To that end, a cloud computing, distributed computing, mobile edge computing (MEC), or client-server computing technology may be used, for example. The electronic device 1601 may provide ultra low-latency services using, e.g., distributed computing or mobile edge computing. In another embodiment, the external electronic device 1604 may include an internet-of-things (IoT) device. The server 1608 may be an intelligent server using machine learning and/or a neural network. According to an embodiment, the external electronic device 1604 or the server 1608 may be included in the second network 1699. The electronic device 1601 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1640) including one or more instructions that are stored in a storage medium (e.g., internal memory 1636 or external memory 1638) that is readable by a machine (e.g., the electronic device 1601). For example, a processor (e.g., the processor 1620) of the machine (e.g., the electronic device 1601) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added. The electronic device 1601 of FIG. 16 may be an example of the electronic device described with reference to FIGS. 1A, 1B, 2A, 2B, 3, 4, 5, 6A to 6C, 7, 8A to 8G, 9, 10, 11A, 11B, 12A, 12B, 13, 14A to 14D, and 15.

In an embodiment, a method of capturing a screen based on a touch input suitable for a deformable housing and/or flexible display may be required. As described above, according to an embodiment, an electronic device (e.g., the electronic device 101 of FIGS. 1A and 1B and/or the electronic device 1601 of FIG. 16) may comprise a first housing (e.g., the first housing 111 of FIGS. 1A and 1B), a second housing (e.g., the second housing 112 of FIGS. 1A and 1B) rotatably coupled to the first housing, a third housing (e.g., the third housing 113 of FIGS. 1A and 1B) rotatably coupled to the second housing, a flexible display (e.g., the flexible display 150 of FIGS. 1A and 1B) including a first displaying area (e.g., the first displaying area 1011 of FIG. 10) positioned on the first housing, a second displaying area (e.g., the second displaying area 1012 of FIG. 10) positioned on the second housing, and a third displaying area (e.g., the third displaying area 1013 of FIG. 10) positioned on the third housing, a first sensor (e.g., the sensor 250 of FIG. 2A) for detecting an angle between the first housing and the second housing, a second sensor (e.g., the sensor 250 of FIG. 2A) for detecting an angle between the second housing and the third housing, memory (e.g., the memory 220 of FIGS. 2A and/or 2B) for storing instructions, and a processor (e.g., the processor 210 of FIG. 2A) executing the instructions by accessing the memory. The processor may be configured to detect, while displaying a screen on the flexible display, a touch input based on an external object contacted on a border area (e.g., the first border area 413 and/or the second border area 411 of FIG. 4) between two displaying areas among the first displaying area, the second displaying area, and the third displaying area. The processor may be configured to store, in response to the touch input based on the external object being moved along a direction where the border area is extended, an image corresponding to at least portion of the screen. The electronic device according to an embodiment may execute a function for capturing a screen in response to a touch input based on a border area. The electronic device may receive a user input for capturing a screen independently of a button that may be occluded according to rotation of a housing.

For example, the processor may be configured to, while displaying the screen based on an unfold state of the first housing, the second housing, and the third housing, detect a rotation of the first housing with respect to the second housing by using the first sensor. The processor may be configured to, in response to the touch input detected on a first border area between the first displaying area and the second displaying area that is bent based on the rotation, execute a first function for storing the image corresponding to at least portion of the screen.

For example, the processor may be configured to, in response to another touch input based on the external object that is positioned on a second border area between the second displaying area and the third displaying area different from the first border area that is bent based on the rotation and is moved along a direction that the second border area is extended, execute a second function different from the first function.

For example, the processor may be configured to, based on whether the external object moved along the direction is spaced apart from the border area, store the image corresponding to all of the first displaying area, the second displaying area, and the third displaying area.

For example, the processor may be configured to, based on whether the external object moved along the direction is contacted on a location within the border area for a preset duration, display a visual object for guiding selection of one of portions of the flexible display distinguished by the border area where the external object is contacted, on an end point among two end points of the border area that is adjacent to the location.

For example, the processor may be configured to store the image corresponding to a first portion, based on the external object that is moved from the location to the first portion among the portions while displaying the visual object.

For example, the electronic device may comprise a cover display (e.g., the cover display 152 of FIG. 1A) positioned on a second surface opposite to a first surface of the third housing where the third displaying area is positioned. The processor may be configured to, in a sub-fold state of the first housing, the second housing, and the third housing which is detected based on the first sensor and the second sensor, display a first screen on at least portion of the first displaying area of the flexible display and display a second screen on the cover display.

For example, the processor may be configured to, based on the external object spaced apart from the border area while displaying the first screen and the second screen, store the image in which the first screen is connected to an edge of the second screen.

For example, the processor may be configured to, in response to another touch input on the cover display based on the external object that is moved along the direction while displaying the first screen and the second screen, store the image corresponding to the second screen among the first screen and the second screen.

For example, the processor may be configured to, based on whether the external object that is moved along the direction is moved on the first displaying area from the border area while displaying the first screen and the second screen, store the image corresponding to the first screen among the first screen and the second screen.

For example, the processor may be configured to, in response to the touch input based on the external object moved longer than a preset distance along the direction, obtain the image corresponding to at least portion of the screen.

As described above, in an embodiment, a method of an electronic device comprising a first housing, a second housing rotatably coupled to the first housing, a third housing rotatably coupled to the second housing, and a flexible display including a first displaying area positioned on the first housing, a second displaying area positioned on the second housing, and a third displaying area positioned on the third housing is provided. The method may comprise detecting, while displaying a screen on the flexible display, a touch input based on an external object contacted on a border area between two displaying areas among the first displaying area, the second displaying area, and the third displaying area. The method may comprise storing, in response to the touch input based on the external object being moved along a direction where the border area is extended, an image corresponding to at least portion of the screen.

For example, the detecting may comprise, while displaying the screen based on an unfold state of the first housing, the second housing, and the third housing, detecting a rotation of the first housing with respect to the second housing by using a first sensor for detecting an angle between the first housing and the second housing. The storing may comprise, in response to the touch input detected on a first border area between the first displaying area and the second displaying area that is bent based on the rotation, executing a first function for storing the image corresponding to at least portion of the screen.

For example, the method may comprise, in response to another touch input based on the external object that is positioned on a second border area between the second displaying area and the third displaying area different from the first border area that is bent based on the rotation and is moved along a direction that the second border area is extended, executing a second function different from the first function.

For example, the storing may comprise, based on whether the external object moved along the direction is spaced apart from the border area, storing the image corresponding to all of the first displaying area, the second displaying area, and the third displaying area.

For example, the detecting may comprise, based on whether the external object moved along the direction is contacted on a location within the border area for a preset duration, displaying a visual object for guiding selection of one of portions of the flexible display distinguished by the border area where the external object is contacted, on an end point among two end points of the border area that is adjacent to the location.

For example, the storing may comprise, storing the image corresponding to a first portion, based on the external object that is moved from the location to the first portion among the portions while displaying the visual object.

For example, the method may comprise, in a sub-fold state of the first housing, the second housing, and the third housing, displaying the first screen on at least portion of the first displaying area of the flexible display and displaying a second screen on a cover display positioned on a second surface opposite to a first surface of the third housing where the third displaying area is positioned.

For example, the storing may comprise, based on the external object spaced apart from the border area while displaying the first screen and the second screen, storing the image in which the first screen is connected to an edge of the second screen.

For example, the storing may comprise, in response to another touch input on the cover display based on the external object that is moved along the direction while displaying the first screen and the second screen, storing the image corresponding to the second screen among the first screen and the second screen.

For example, the storing may comprise, based on whether the external object that is moved along the direction is moved on the first displaying area from the border area while displaying the first screen and the second screen, storing the image corresponding to the first screen among the first screen and the second screen.

For example, the storing may comprise, in response to the touch input based on the external object moved longer than a preset distance along the direction, obtaining the image corresponding to at least portion of the screen.

As described above, according to an embodiment, an electronic device may comprise a first housing, a second housing rotatably coupled to the first housing, a third housing rotatably coupled to the second housing, a flexible display including a first displaying area positioned on the first housing, a second displaying area positioned on the second housing, and a third displaying area positioned on the third housing, a first sensor for detecting an angle between the first housing and the second housing, a second sensor for detecting an angle between the second housing and the third housing, memory, for storing instructions, and a processor executing the instructions by accessing the memory. The processor may be configured to detect, while displaying a screen on the flexible display, a touch input based on an external object contacted on the flexible display. The processor may be configured to, based on a path of the external object contacted according to a preset form that is moved on the flexible display, store an image corresponding to at least one displaying area, among the first displaying area, the second displaying area, and the third displaying area, including the path.

For example, the electronic device may comprise a cover display positioned on a second surface opposite to a first surface of the third housing where the third displaying area is positioned. The processor may be configured to display, based on a sub-fold state of the first housing, the second housing, and the third housing, a first screen on the first displaying area and display a second screen on the cover display.

The processor may be configured to store, based on whether the external object contacted on the first displaying area is moved on the cover display along the path, the image in which the first screen is connected to an edge of the second screen.

As described above, in an embodiment, a method of an electronic device comprising a first housing, a second housing rotatably coupled to the first housing, a third housing rotatably coupled to the second housing, and a flexible display including a first displaying area positioned on the first housing, a second displaying area positioned on the second housing, and a third displaying area positioned on the third housing is provided. The method may comprise detecting, while displaying a screen on the flexible display, a touch input based on an external object contacted on the flexible display. The method may comprise, based on a path of the external object contacted according to a preset form that is moved on the flexible display, storing an image corresponding to at least one displaying area, among the first displaying area, the second displaying area, and the third displaying area, including the path.

For example, the method may comprise, based on a sub-fold state of the first housing, the second housing, and the third housing, displaying a first screen on the first displaying area and displaying a second screen on a cover display positioned on a second surface opposite to a first surface of the third housing where the third displaying area is positioned. The storing may comprise storing, based on whether the external object contacted on the first displaying area is moved on the cover display along the path, the image in which the first screen is connected to an edge of the second screen.

As described above, according to an embodiment, an electronic device may comprise a first housing, a second housing rotatably coupled to the first housing, a third housing rotatably coupled to the second housing, a flexible display including a first displaying area positioned on the first housing, a second displaying area positioned on the second housing, and a third displaying area positioned on the third housing, a cover display positioned on a second surface opposite to a first surface of the third housing where the third displaying area is positioned, a first sensor for detecting an angle between the first housing and the second housing, a second sensor for detecting an angle between the second housing and the third housing, memory, for storing instructions, and a processor executing the instructions by accessing the memory. The processor may be configured to, in a state that an edge of the third housing is contacted on the first displaying area, display a first screen on a portion different from another portion occluded by the third housing, among portions of the first displaying area distinguished by the edge, and display a second screen on the cover display. The processor may be configured to detect a touch input based on an external object contacted on a portion of the first displaying area where the edge is contacted. The processor may be configured to, in response to the touch input based on the external object moved along a direction of the edge, store an image including at least one of the first screen or the second screen.

For example, the processor may be configured to, based on whether the external object moved along the direction is moved to a location on the first displaying area different from the portion, store the image including the first screen among the first screen and the second screen.

For example, the processor may be configured to, based on whether the external object moved along the direction is moved on the cover display, store the image including the second screen among the first screen and the second screen.

As described above, in an embodiment, a method of an electronic device comprising a first housing, a second housing rotatably coupled to the first housing, a third housing rotatably coupled to the second housing, and a flexible display including a first displaying area positioned on the first housing, a second displaying area positioned on the second housing, and a third displaying area positioned on the third housing is provided. The method may comprise, in a state that an edge of the third housing is contacted on the first displaying area, displaying a first screen on a portion different from another portion occluded by the third housing, among portions of the first displaying area distinguished by the edge, and displaying a second screen on a cover display positioned on a second surface opposite to a first surface of the third housing where the third displaying area is positioned. The method may comprise detecting a touch input based on an external object contacted on a portion of the first displaying area where the edge is contacted. The method may comprise, in response to the touch input based on the external object moved along a direction of the edge, storing an image including at least one of the first screen or the second screen.

For example, the storing may comprise, based on whether the external object moved along the direction is moved to a location on the first displaying area different from the portion, storing the image including the first screen among the first screen and the second screen.

For example, the storing may comprise, based on whether the external object moved along the direction is moved on the cover display, storing the image including the second screen among the first screen and the second screen.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and digital versatile disc (DVD), magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

Although the embodiments have been described above with reference to limited examples and drawings, various modifications and variations may be made from the above description by those skilled in the art. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

No claim element is to be construed under the provisions of 35 U.S.C. § 112, sixth paragraph, unless the element is expressly recited using the phrase “means for” or “means.”

What is claimed is:

1. An electronic device comprising:
a first housing;
a second housing rotatably coupled to the first housing;
a third housing rotatably coupled to the second housing;
a flexible display including a first displaying area positioned on the first housing, a second displaying area positioned on the second housing, and a third displaying area positioned on the third housing;
a first sensor configured to detect an angle between the first housing and the second housing;
a second sensor configured to detect an angle between the second housing and the third housing;
memory, comprising one or more storage media, storing instructions; and
one or more processors comprising processing circuitry communicatively coupled to the flexible display, the first sensor, the second sensor, and the memory,
wherein the instructions, when executed by the one or more processors individually or collectively, cause the electronic device to:
while displaying a screen on the flexible display, detect a touch input based on an external object contacted on a border area between two displaying areas among the first displaying area, the second displaying area, and the third displaying area, and
in response to the touch input based on the external object being moved along a direction in which the border area extends, store, in the memory, an image corresponding to at least a portion of the screen.

2. The electronic device of claim 1, wherein the instructions, when executed by the one or more processors individually or collectively, further cause the electronic device to:
while displaying the screen based on an unfold state of the first housing, the second housing, and the third housing, detect a rotation of the first housing with respect to the second housing by using the first sensor; and
in response to the touch input being detected on a first border area between the first displaying area and the second displaying area that is bent based on the rotation, execute a first function for storing the image corresponding to at least the portion of the screen.

3. The electronic device of claim 2, wherein the instructions, when executed by the one or more processors individually or collectively, further cause the electronic device to:
in response to another touch input based on the external object that is positioned on a second border area between the second displaying area and the third displaying area different from the first border area that is bent based on the rotation and is moved along a direction in which the second border area extends, execute a second function different from the first function.

4. The electronic device of claim 1, wherein the instructions, when executed by the one or more processors individually or collectively, further cause the electronic device to:
based on whether the external object moved along the direction is spaced apart from the border area, store the image corresponding to all of the first displaying area, the second displaying area, and the third displaying area.

5. The electronic device of claim 1, wherein the instructions, when executed by the one or more processors individually or collectively, further cause the electronic device to:
based on whether the external object moved along the direction is contacted on a location within the border area for a preset duration, display a visual object for guiding selection of one of portions of the flexible display distinguished by the border area where the external object is contacted, the visual object being displayed on an end point among two end points of the border area that is adjacent to the location.

6. The electronic device of claim 5, wherein the instructions, when executed by the one or more processors individually or collectively, further cause the electronic device to:
store the image corresponding to a first portion, based on the external object that is moved from the location to the first portion among the portions while displaying the visual object.

7. The electronic device of claim 1, further comprising:
a cover display positioned on a second surface opposite to a first surface of the third housing where the third displaying area is positioned,
wherein the instructions, when executed by the one or more processors individually or collectively, further cause the electronic device to:
in a sub-fold state of the first housing, the second housing, and the third housing, which is detected based on the first sensor and the second sensor, display a first screen on at least a portion of the first displaying area of the flexible display and display a second screen on the cover display.

8. The electronic device of claim 7, wherein the instructions, when executed by the one or more processors individually or collectively, further cause the electronic device to:
based on the external object being spaced apart from the border area while displaying the first screen and the second screen, store the image in which the first screen is connected to an edge of the second screen.

9. The electronic device of claim 7, wherein the instructions, when executed by the one or more processors individually or collectively, further cause the electronic device to:
in response to another touch input on the cover display based on the external object that is moved along the direction while displaying the first screen and the second screen, store the image corresponding to the second screen among the first screen or the second screen.

10. The electronic device of claim 7, wherein the instructions, when executed by the one or more processors individually or collectively, further cause the electronic device to:
based on whether the external object that is moved along the direction is moved on the first displaying area from the border area while displaying the first screen and the second screen, store the image corresponding to the first screen among the first screen or the second screen.

11. The electronic device of claim 1, wherein the instructions, when executed by the one or more processors individually or collectively, further cause the electronic device to:
in response to the touch input based on the external object being moved longer than a preset distance along the direction, obtain the image corresponding to at least the portion of the screen.

12. A method performed by an electronic device including a first housing, a second housing rotatably coupled to the first housing, a third housing rotatably coupled to the second housing, and a flexible display including a first displaying area positioned on the first housing, a second displaying area positioned on the second housing, and a third displaying area positioned on the third housing, the method comprising:
while displaying a screen on the flexible display, detecting, by the electronic device, a touch input based on an external object contacted on a border area between two displaying areas among the first displaying area, the second displaying area, and the third displaying area; and
in response to the touch input based on the external object being moved along a direction in which the border area extends, storing, by the electronic device in memory of the electronic device, an image corresponding to at least a portion of the screen.

13. The method of claim 12,
wherein the detecting comprises:
while displaying the screen based on an unfold state of the first housing, the second housing, and the third housing, detecting, by the electronic device, a rotation of the first housing with respect to the second housing by using a first sensor configured to detect an angle between the first housing and the second housing, and
wherein the storing comprises:
in response to the touch input being detected on a first border area between the first displaying area and the second displaying area that is bent based on the rotation, executing a first function for storing the image corresponding to at least portion of the screen.

14. The method of claim 13, further comprising:
in response to another touch input based on the external object that is positioned on a second border area between the second displaying area and the third displaying area different from the first border area that is bent based on the rotation and is moved along a direction in which the second border area extends, executing, by the electronic device, a second function different from the first function.

15. The method of claim 12, wherein the storing comprises:
based on whether the external object moved along the direction is spaced apart from the border area, storing, by the electronic device, the image corresponding to all of the first displaying area, the second displaying area, and the third displaying area.

16. The method of claim 12, wherein the detecting comprises:
based on whether the external object moved along the direction is contacted on a location within the border area for a preset duration, displaying, by the electronic device, a visual object for guiding selection of one of portions of the flexible display distinguished by the border area where the external object is contacted, the visual object being displayed on an end point among two end points of the border area that is adjacent to the location.

17. The method of claim 16, wherein the storing comprises:
storing, by the electronic device, the image corresponding to a first portion, based on the external object that is moved from the location to the first portion among the portions while displaying the visual object.

18. The method of claim 12, further comprising:
in a sub-fold state of the first housing, the second housing, and the third housing, displaying, by the electronic device, a first screen on at least a portion of the first displaying area of the flexible display and displaying a second screen on a cover display positioned on a second surface opposite to a first surface of the third housing where the third displaying area is positioned.

19. The method of claim 18, wherein the storing comprises:
based on the external object being spaced apart from the border area while displaying the first screen and the second screen, storing, by the electronic device, the image in which the first screen is connected to an edge of the second screen.

20. The method of claim 18, wherein the storing comprises:
in response to another touch input on the cover display based on the external object that is moved along the direction while displaying the first screen and the second screen, storing, by the electronic device, the image corresponding to the second screen among the first screen or the second screen.
